(19) United States
(12) Patent Application Publication
(10) Pub. No.: US 2013/0262203 A1
(43) Pub. Date: Oct. 3, 2013

(54) LOCATION-BASED TASK AND GAME FUNCTIONALITY

(71) Applicant: SIRQUL, INC, SEATTLE, WA (US)

(72) Inventors: ROBERT FREDERICK, SEATTLE, WA (US); MICHAEL SANGEUN WOO, KIRKLAND, WA (US); JUSTIN JAEWOOK YU, BELLEVUE, WA (US); JUSTIN ARRUDA, WYOMING, RI (US); RYAN AZUCENA, BELLEVUE, WA (US); JOHN THOMAS HURR, SEATTLE, WA (US); MATTHEW AARON KLECZKA, SEATTLE, WA (US)

(73) Assignee: SIRQUL, INC., SEATTLE, WA (US)

(21) Appl. No.: 13/843,804

(22) Filed: Mar. 15, 2013

Related U.S. Application Data
(60) Provisional application No. 61/616,340, filed on Mar. 27, 2012.

(51) Int. Cl. G06Q 30/02

(52) U.S. Cl. CPC G06Q 30/0209
USPC 705/14.12; 705/14.49; 705/14.58

(57) ABSTRACT

Techniques are described for providing functionality and information to users, including providing promotional information and opportunities to users of mobile devices in manners that are based at least in part on activities and locations of the users (e.g., based on games played by the users on their mobile devices and/or based on user satisfaction of system-directed tasks associated with offers or other activities). At least some of the promotional information and opportunities may be made available by various companies or entities that provide products and/or services (e.g., retailers, merchants, wholesalers, distributors, etc.) and/or by various companies or entities that provide advertising for available products and/or services. Various types of activities may be defined and used to provide promotional information and opportunities to users of mobile devices in particular embodiments and situations.

### CROSS-REFERENCE TO RELATED APPLICATIONS

This application claims the benefit of U.S. Provisional Patent Application No. 61/616,340, filed Mar. 27, 2012 and entitled “Location-Based Task And Game Functionality,” which is hereby incorporated by reference in its entirety.

### TECHNICAL FIELD

The following disclosure relates generally to techniques for providing functionality and information to users of mobile devices, such as to provide promotional information and opportunities in manners that are based at least in part on activities and locations of the users.

### BACKGROUND

The use of mobile devices has become increasingly common, with many different types of mobile devices that have differing types of connectivity options and other differing types of capabilities. However, difficulties exist with techniques for engaging users of mobile devices and providing relevant information at appropriate times.

### BRIEF DESCRIPTION OF THE DRAWINGS

FIG. 1 is a network diagram illustrating an example embodiment of interactions that involve providing functionality and information to users of mobile devices.

FIG. 2 is a block diagram illustrating example computing systems suitable for executing an embodiment of a system for providing promotional information and opportunities to users of multiple mobile devices.

FIG. 3 is a flow diagram of an example embodiment of a Location-based Task-Game Server routine.

FIG. 4A is a flow diagram of an example embodiment of a Location routine.

FIGS. 4B1 and 4B2 are a flow diagram of an example embodiment of a Dynamic Notification routine.

FIG. 4C is a flow diagram of an example embodiment of a Task routine.

FIG. 4D is a flow diagram of an example embodiment of a Game routine.

FIG. 4E is a flow diagram of an example embodiment of a User-Initiated Generation routine.

FIGS. 5A and 5B illustrate examples of using multiple interconnected mobile devices together in particular distributed manners.

FIGS. 6-47 illustrate example user interface screens of a system for providing promotional information and opportunities to users of mobile devices.

FIGS. 48A-48D are a flow diagram of an example embodiment of a Location-based Task-Game Server routine.

### DETAILED DESCRIPTION

Techniques are described for providing functionality and information to users of computing devices. In at least some embodiments, the described techniques include providing promotional information and opportunities to users of mobile devices in manners that are based at least in part on activities and locations of the users, including in some situations based on games played by the users on their mobile devices and/or based on user satisfaction of system-directed activities. At least some of the promotional information and opportunities may be made available in at least some embodiments by various companies or entities that provide products and/or services (e.g., retailers, merchants, wholesalers, distributors, etc.) and/or by various companies or entities that provide advertising for available products and/or services, with such companies or entities that make promotional information and opportunities available being referred to generally as “vendors” herein. Various types of activities may be defined and used to provide promotional information and opportunities to users of mobile devices in particular embodiments and situations. Additional details related to the providing of functionality and information to users of mobile devices are included below, and in at least some embodiments are performed by automated operations of a computer-implemented Location-based Task-Game (“LTG”) server system.

As noted above, promotional information and opportunities may be provided to users of mobile devices by the LTG server system in manners that are based at least in part on activities and locations of the users. Such promotional information and opportunities (also referred to as “offers”) may have various forms in various embodiments, including to have one or more associated eligibility criteria for a matching user to be eligible to receive a reward associated with the offer, such as for rewards that may include vouchers, coupons, discounts of various types (e.g., a specified percentage discount, a specified monetary amount discount, a buy-N-and-get-M-free offer (where N and M are numbers of items or monetary quantities, whether the same or different), etc.), give-away items, a gift card or other monetary amount, etc. that are issued by or otherwise correspond to particular retailers and/or to particular products or services, such as may be specified by vendors who are clients of the LTG server system. In other embodiments and situations, promotional information and opportunities that are available to users may have associated rewards with other forms, such as points or virtual currency offered by the LTG server system. Furthermore, a promotional offer for a vendor may correspond to one or more items (e.g., products and/or services) available from the vendor—while the term “product” is used in some places of the following discussion, it will be understood that the term “product” also means service items in addition to physical items unless the context precludes a service in a particular circumstance (e.g., discussion of current inventory of a vendor for a product, storage or transportation of a product, etc.). In addition, the term “user” refers to one or more people, unless otherwise indicated by the context.

In addition, various types of activities may be defined and used to provide promotional information and opportunities to users of mobile devices in particular embodiments and situations, with such activities optionally being defined by vendors, other users of the LTG server system (e.g., consumer users of mobile devices who are potential customers of the vendors), and/or by the LTG server system itself (e.g., to provide benefits to users, to fulfill requests by vendors, etc.). A non-exclusive list of types of activities that may be used include the following: a defined event, in which one or more users satisfy defined criteria for the event, optionally based on one or more of location of the user(s), quantity of the user(s), characteristics of the user(s), timing-related aspects, etc.; a defined end user task (also referred to herein as a “mission” or a competitive “challenge”), in which one or more users perform one or more defined actions, optionally in competition with other users for a limited number of promotional opportunities; a defined game, in which one or more users participate in a game, optionally in a coordinated distributed manner (whether by competing against each other in the same game or by interacting cooperatively for the game), and optionally concurrently, with the games in at least some situations being “mini-games” that may be completed quickly (e.g., in seconds or minutes); etc.

The LTG server system may further provide various functionality as part of the described techniques. Such functionality may include tracking locations of users, such as to determine when a user's location may satisfy aspects of an event, task or game. Such functionality may further include providing notifications to particular users, such as notifications that are defined by vendors and provided in accordance with particular events, tasks or games (e.g., to notify selected or all users of current or future availability of a particular event, task or game; to notify particular users of completion of a particular event, task or game; etc.). Such functionality may further include enabling vendors to define information about promotional campaigns of interest (e.g., to provide coupons, vouchers or other promotional opportunities for one or more specified products or services), which may then be implemented by the LTG server system by using one or more selected events, tasks or games (whether specified by the vendor or automatically selected by the LTG server system), such as from system-provided groups of predefined games, predefined types of events, and/or predefined types of tasks. When selected by the LTG server system for a vendor to implement a campaign, the selection may be performed in various manners, such as based on information input by the vendor, information about past interactions with the vendor, information about past tasks, games and/or events used for similar campaigns and/or promotional opportunities, etc. Additional details are included below regarding the described techniques.

For illustrative purposes, some embodiments are described in which particular types of functionality are provided to groups of mobile devices in particular manners. These examples are provided for illustrative purposes and are simplified for the sake of brevity, and the inventive techniques can be used in a wide variety of other situations, some of which are discussed below, including in some embodiments in which some or all of the members of a group are not mobile devices or otherwise differ from the example in one or more manners.

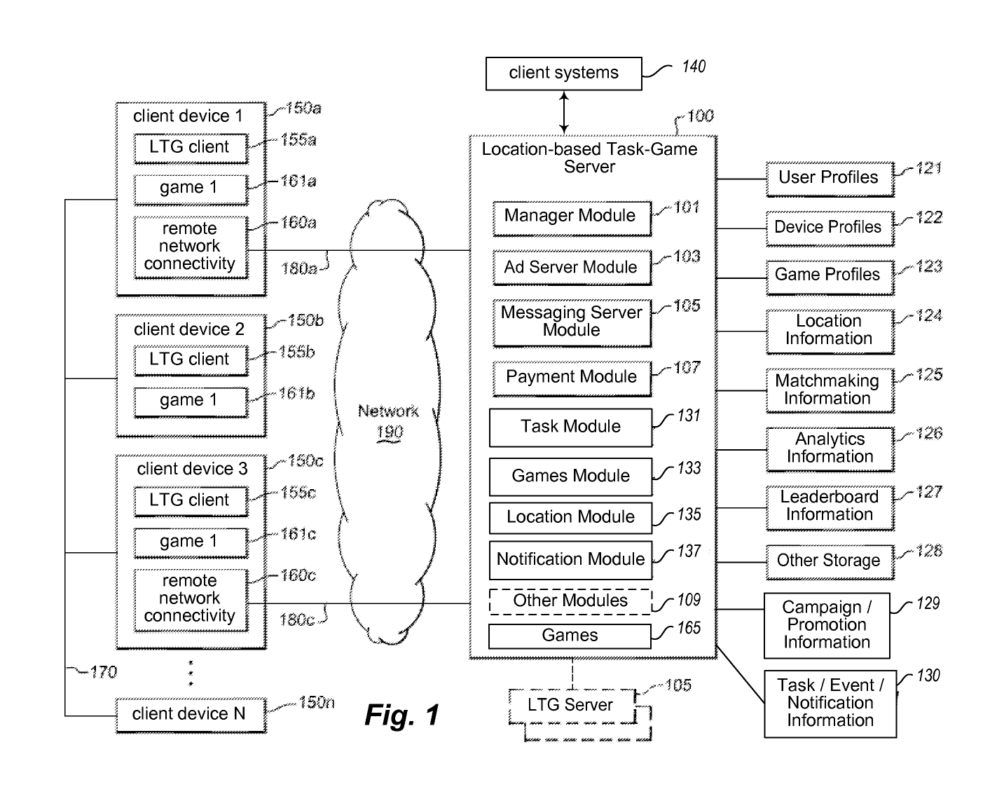

FIG. 1 is a network diagram illustrating an example embodiment of interactions that involve providing functionality and information to users of mobile devices. In particular, in the example of FIG. 1, a Location-based Task-Game (“LTG”) server program 100 is executing on one or more configured computing systems (not shown), in order to provide functionality to users (not shown) of various mobile devices 150. The illustrated example of the LTG server 100 includes various software modules 101-109 and 131-137 and uses various information 121-130, as discussed in further detail below. The LTG server 100 may also optionally interact with one or more other LTG server programs 105, such as over one or more networks (not shown), and with such optional other LTG server programs 105 providing similar types of functionality to other mobile devices (not shown). In addition, in some embodiments the LTG server 100 may optionally provide one or more games or other application programs 165 that are available for use by mobile devices 150, although in other embodiments some or all such games or other applications may instead be provided by other distinct application server computing devices (not shown). As discussed below, in some embodiments and situations, some or all of the functionality of the LTG Server 100 is instead provided locally to a group of mobile devices by one or some or all of those mobile devices, such as by using LTG client software 155 and corresponding locally stored information (not shown) on those mobile devices.

In the example of FIG. 1, various vendors and other clients of the LTG Server 100 may use client computing systems 140 to interact with the LTG Server 100 (e.g., over one or more networks, not shown) to specify various types of functionality to be provided by the LTG Server 100 to other users (e.g., users of mobile client devices 150). For example, the clients using the client computing systems 140 and/or the users of the mobile devices 150 may interact with executing Task module 131 to specify various types of tasks, events and/or notifications to occur, with corresponding task-related information 130 being stored and used by the LTG Server 100—such tasks may include tasks for others to perform (e.g., a task specified by a vendor client for mobile device users), tasks in which a specifying user may participate (e.g., a head-to-head challenge between the specifying user and one or more other users), etc. In addition, vendor clients using the client computing systems 140 may interact with one or more modules of the LTG Server 100 (e.g., the Manager module 101; one of the other modules 109, such as to correspond to obtaining user-initiated generation of information; etc.) to specify promotional campaigns to occur, with information 129 about such campaigns and corresponding promotional opportunities being stored and used by the LTG Server 100. The LTG Server 100 may subsequently monitor particular users (e.g., by the Location module 135, which tracks user locations) and provide notifications and functionality corresponding to defined tasks and campaigns, as discussed further herein.

In the example of FIG. 1, the LTG server 100 is further providing functionality to an example group of multiple client mobile devices 150, such as with respect to distributed execution of an example application (in this example, game 1 165a)—an embodiment of such a LTG server 100 may further be supporting other groups of mobile devices with respect to the same or other applications, although such other groups are not illustrated with respect to FIG. 1. As one example, the playing of the distributed game may be part of a task that is specified by the LTG server 100, such as for selected users, including to correspond to a defined campaign of a vendor client—if so, some or all participating users (e.g., all participating users, all users who finish the game or reach a specified level, a subset of one or more users who win the game or otherwise satisfy a specified criteria, etc.) may receive one or more promotional opportunities corresponding to the task (e.g., promotional opportunities specified by the vendor client for the defined campaign, opportunities automatically provided by the LTG server, etc.).

In this example of FIG. 1, each mobile device 150 includes a copy 161 of at least some of the game 1 application, although in other embodiments may access functionality of an application using only software on the mobile device that is not specific to the application (e.g., a Web browser, not shown)—for example, mobile device 1 150a includes a copy 161a of game 1 (the copy of game 1 for client device N 150n is not shown). In addition, each mobile device 150 includes a copy 155 of client software for the LTG server 100, as discussed in greater detail below—for example, mobile device 1 includes a copy 155a of the LTG client software (the copy of the LTG client for client device N 150n is not shown). As discussed below, in some embodiments and situations, some or all of the functionality of the LTG Server 100 is instead provided locally to a group of mobile devices by one or some or all of those mobile devices, such as by using the LTG client software 155 and corresponding locally stored information (not shown) on those mobile devices. In addition, some or all of the mobile devices 150 may further include and/or execute copies of other applications, although such other applications are not illustrated on the mobile devices 150.

In this example, the mobile devices 150 are inter-connected as a group to perform the coordinated and distributed execution of the game 1 application, via one or more inter-connections 170 between the various mobile devices 150. In particular, as discussed in greater detail elsewhere, each mobile device 150 may be currently connected to at least one other mobile device 150 via one or more connections, with some mobile devices being connected to multiple other mobile devices (e.g., mobile device 3 150c may be connected in a 1-to-1 manner to mobile device N 150n via a first connection, and may separately be connected to both mobile device 1 and mobile device 2 150b via a distinct second connection). Thus, each of the mobile devices 150 includes one or more types of connection capabilities, although local connection capability types (e.g., Bluetooth, Wi-Fi, infrared, wired Ethernet, etc.) are not separately shown in this example. In addition, mobile devices 1 and 3 each includes capabilities 160 to remotely connect to the LTG server 100 (e.g., 3G wireless, 4G wireless, etc.) via remote connections 180 over one or more networks 190, such as the Internet, one or more cellular networks, etc. While not illustrated in this example, in some situations, some or all mobile devices 150 of the group may be connected to one or more other mobile devices 150 of the group via only remote connections 180 (e.g., if mobile device 1 was not connected directly to any other mobile device 150, and instead was only indirectly connected to client device 3 via remote connections 180a and 180c via the LTG server 100), including to optionally have one or more other mobile devices (not shown) that are part of the group but are separated from the illustrated mobile devices 150 via one or more networks 190. Alternatively, in embodiments and situations in which some or all of the functionality of the LTG Server 100 is instead provided locally to a group of mobile devices by one or some or all of those mobile devices, the network 190 and any remote connections 180 may not be present or used. Additionally, in some embodiments, one or more of the client devices 150 may not be mobile (e.g., may be a desktop computer) and/or may be connected to one or more other client devices 150 via a wired connection.

In at least some embodiments, the client mobile devices may include, for example, a smart phone or other cellular phone, a tablet computer, a slate computer, a PDA (“personal digital assistant”), a laptop or netbook, etc. A non-exclusive list of example types of mobile devices includes the following: an iPhone, an iPad, an iPod Touch, an Android OS (“operating system”) device, a Windows Phone OS device, a Kindle Fire device, a Nook Tablet device, a Blackberry device, a Nintendo DS device, a portable Sony PlayStation device, etc. In certain embodiments, the client devices may be GPS-enabled devices containing GPS receivers, and/or may include other location-aware technology such as Wi-Fi location services. Moreover, in at least some embodiments, a particular client device may store various information (whether in a volatile or non-volatile manner), such as relating to the location of the device, including the current location of the device, the location history of the device over a certain period of time, a record of particular Wi-Fi networks with which the device has communicated or which have been available for communication, etc. In addition, various information may be stored relating to the prior activities of the user associated with the device, such as a record of locations that the user has visited. In addition, in some situations, a user may use multiple computing devices at various times, whether serially or simultaneously.

In the example embodiment, the LTG client software 155 on the mobile devices 150 may include at least a subset of the LTG server 100 functionality (e.g., may include local copies of some or all of the modules 101-109 and 131-137), although in other embodiments the LTG client software 155 may instead lack some or all such modules and instead enable interactions between a mobile device 150 and the LTG server 100 so that the modules 101-109 and 131-137 that are part of the LTG server 100 may provide functionality to the mobile device 150 as appropriate. In addition, a particular mobile device may store some or all of the information 121-130 locally to the mobile device, including information specific to the device and its one or more users and its one or more applications.

Automated matchmaking operations may be performed to select a host mobile device 150 to provide a connection to the LTG server 100 in some embodiments and situations, whether operations that are performed in whole or in part by a LTG Server 100 that is remote from the mobile devices 150 and/or operations that are performed in whole or in part by one or more of the mobile devices 150 that are providing functionality of the LTG Server 100 using LTG client software 155. For example, the LTG client software 155a on mobile device 1 may have previously established remote connection 180a with the LTG server 100, and/or the LTG client software 155c on mobile device 3 may have previously established remote connection 180c with the LTG server 100, and if so the manager module 101 of the LTG server 100 may perform the automated matchmaking operations. In particular, in this example the mobile device 1 and mobile device 3 may be candidates to serve as a current host for the group based on their respective remote network connectivity capabilities 160, optionally along with one or more other mobile devices 4 through N−1 (not shown), and thus the matchmaking operations may select one of those candidate mobile devices. After the selection is made, the LTG server may notify the LTG client software 155 on one or more of the mobile devices of the group (e.g., the LTG client software 155 on the selected host), and the LTG client software 155 on the selected host may perform further operations to convey information between the LTG server 100 and/or an application server (not shown) and the mobile devices of the group. Such application-specific information may in some situations include information from other storage 128, such as application-specific content to be provided to users, application-specific data generated by users, other application-specific state for particular applications and groups, etc. Other storage 128 may further store other types of information, including information specific to particular users (e.g., photos, social networking posts, social networking profile messages, etc.), available types of content (e.g., audio clips or files, video files, images, etc.); etc. In addition, in at least some embodiments, the manager module 101 of the LTG server 100 (or similar functionality of the LTG client software 155) may provide functionality to coordinate or provide a distributed canvas display among the mobile devices of the group, although in other embodiments the game 1 application may perform some or all such activities.

In other embodiments, if no remote connections 180 between the mobile devices of the group and the LTG server 100 exist at a time of performing automated matchmaking operations, or based on other configuration of the LTG client software 155 on one or more of the mobile devices of the group, the LTG client software 155 on one or more of the mobile devices of the group may instead perform such automated matchmaking operations, such as temporarily until the LTG server 100 is available to make a regular host selection, or instead in place of the LTG server 100. Such client-side automated matchmaking operations may include, for example, using locally stored information (not shown) on one or some or all of the mobile devices 150 of the group, such as to correspond to some or all of the information 121-130—since such locally stored information may be less complete in at least some respects than information available to the LTG server 100, a host selection made locally by the LTG client software 155 may be temporary until the LTG server 100 is available to make a selection based on other such information 121-130. Such client-side automated matchmaking operations may further include, for example, one of the LTG client software copies performing the operations (e.g., after being elected by other LTG client software copies as a current leader, or otherwise being selected or configured to act as a current leader), or by multiple of the LTG client software copies performing the operations in a distributed manner. During times when no remote connections 180 between the mobile devices of the group and the LTG server 100 exist, the LTG client software 155 and/or local application copies 161 may nonetheless continue to provide at least some functionality of the application to the group, and may further locally store information on one or more of the mobile devices 150 about output generated, activities performed and other current status information—if so, when a host (or optionally all member of the group) is later able to establish a remote connection 180 to the LTG server 100, some or all such locally stored information may be sent to the LTG server 100 to enable update of the information 121-130. As one example, information about performance of particular users within the application may be stored as part of leader board information 127, such as for a game application. In other embodiments, no remote LTG Server 100 may be provided, and all functionality of the LTG Server 100 may instead be provided by the mobile devices of the group using the LTG client software 155.

As previously noted, functionality of the LTG server 100 (whether provided via one or more remote computing systems and/or by the mobile devices of the group) may use various types of information when performing automated matchmaking operations. For example, the LTG server 100 may have stored various information 121-130 regarding the mobile devices 150, their users, their locations and the application in use, such as based on previous registration activities and/or interactions with the LTG server 100, and may use such information as part of performing the automated matchmaking operations. Such information may be stored in, for example, one or more of the following: device profile information 122 (e.g., device hardware type; device OS type; device software, such as application programs, libraries, utilities, etc.; device capabilities, such as connection type(s), processing power, memory amount and type, storage amount and type, etc.; device status, such as current battery level and connection strength; etc.); user profile information 121 (e.g., account information; activity patterns, such as how long a user has played a particular application or applications generally on average in the past; user preferences, such as whether the user is will to allow his or her device to serve as a host; social network information, such as information about friends and followers; prior activities of the user, such as whether he or she has acted as a watcher or spectator to an application, by receiving access to at least some of a distributed canvas display functionality for the application without being able to modify or affect the performance of the application; etc.); application profile information 123 (e.g., information about levels, a textual description, types of data usage patterns during application execution, etc.); location information 124 (e.g., current location, such as expressed in latitude and longitude and optionally bearing or heading and optionally altitude; a history of past locations, such as to reflect a previously traveled path; etc.); etc. In addition, in at least some embodiments, the LTG server 100 may gather some or all such information to be used in automated matchmaking operations and include it as part of separate matchmaking information 125, such as to facilitate rapid access to particular information of use, to track current hosts that have been selected, to track previous hosts that have been selected, to track current alternative candidates for hosts for particular groups, etc.)—the matchmaking information 125 may further include additional information specific to the automated matchmaking operations, such as information about particular factors that are configured to be used (e.g., for all groups and applications, for particular applications, for particular groups, etc.), information about how to combine particular factors (e.g., ways to weight or otherwise combine information may multiple factors), information about when to perform automated matchmaking operations (e.g., upon request, upon a change in a currently selected host that prevents that mobile device from continuing to act as a host, upon other defined criteria, etc.), etc., and with particular such information being specified for an application by the application provider and/or by a distinct operator of the LTG Server 100 functionality, or being specified for multiple applications (e.g., all applications) by a distinct operator of the LTG Server 100 functionality. As one specific example in which a group of multiple mobile devices selects a host device without using a remote LTG Server 100, the selection may be made without consideration of any remote connections by the mobile devices to remote server computing systems and/or without consideration of remote network connectivity capabilities—instead, the selection may be made by one or more of the mobile devices based on one or more of the following types of factors: capabilities of the selected host mobile device (e.g., processing speed, network transmission speed to other mobile devices of the group via local inter-connections, etc.); information about the selected host mobile device relative to other mobile devices of the group (e.g., relative location, such as to select a centrally located device based on distance to other of the mobile devices; orientation, such as to select a location of the host device so that some or all of the other mobile device users face that host device, possibly to allow those users to see each others' displays as part of a distributed canvas display functionality; etc.); information about the user of the selected host mobile device (e.g., willingness of the user to use the mobile device to act as the host; past behavior of the user in remaining as a host until an application is completed or otherwise remaining in groups for long or short periods of time; a preferred status of the user, such as to enable users who have reached a preferred status or level within an application or with respect to the LTG Server to have the first opportunity to act as a host and receive corresponding benefits that are provided; etc.); etc. In other situations, some or all of these types of factors may instead be considered in situations in which a remote LTG Server 100 is used and/or the host selection is made based in part on consideration of remote connections by the mobile devices to remote server computing systems and/or of corresponding remote network connectivity capabilities.

In some embodiments and situations, the automated matchmaking operations may further use analytics information, which includes information of various types corresponding to different types of events of interest that occur—at least some of the information may correspond to or reference, for example, user profiles 121, device profiles 122, application profiles 123 and location information 124. For example, an application may provide information about a variety of types of events (e.g., application start, application end, application phase or stage start or end, particular user action, particular group achievement, etc.), with the information being of various types. The automated matchmaking operations may further include matching particular users to defined tasks, events, notifications, and campaigns in particular manners, as discussed in greater detail elsewhere. In addition, the various modules 101-109 and 131-137 may perform various analyses of the analytics information, such as to perform data mining or otherwise determine patterns from or other aggregations of multiple events, and resulting information that is generated may be stored in various manners (e.g., in other storage 128, as other analytics information 126 events, etc.). A non-exclusive list of types of information that may be stored for an event includes the following: a particular activity; one or more users (e.g., via a unique user ID), such to enable corresponding information to be accessed from the user profiles 121; one or more devices (e.g., via a unique device ID), such to enable corresponding information to be accessed from the device profiles 122; a particular application (e.g., via a unique application ID), such to enable corresponding information to be accessed from the application profiles 123; a location (e.g., via a set of location coordinates or other information that uniquely identifies a location), such to optionally enable corresponding information to be accessed from the location information 124; a state of the application (e.g., a current stage, level, group score, etc.); one or more application-specific tags (e.g., text or other information that is meaningful to the application); etc.

In the illustrated example, the initial host selection for the group may include, for example, selecting mobile device 3 to act as the host, such as to use remote connection 180c to provide application-related capabilities to other mobile devices of the group from one or more remote computing systems. The initial host selection may be made, for example, based on one or more of the following factors: remote connection 180c being preferred to remote connection 180a, such as based on it having higher bandwidth, lower latency, lower monetary cost of use, greater reliability or stability (e.g., less likely to have lost packets or dropped connections), etc.; mobile device 3 being preferred to mobile device 1, such as based on it having faster computing capabilities and/or greater computing-related resources, greater reliability or stability (e.g., less likely to fail; more likely to operate longer, such as based on battery life remaining; etc.), etc.; the user of mobile device 3 being preferred to the user of mobile device 1, such as based on being expected to remain as part of the group for longer; etc. If mobile device 3 is selected as the initial host, but later it is determined to change hosts (e.g., based on mobile device 3 shutting down or leaving the group), mobile device 1 may be selected at that time to replace mobile device 3 as the current host, such as based on mobile device 1 being the only remaining group device with a remote connection 180 to the LTG server 100 and/or other remote computing systems, or based on performing the same type of selection process as for the initial selection between multiple candidate hosts.

In addition, in some embodiments a particular mobile device and a particular group may be matched (e.g., if multiple alternative groups are available for that mobile device) based on consideration of one or more factors that may include some or all of the same factors as discussed above with respect to host selection. Furthermore, in some embodiments, such matching may be performed to increase or decrease diversity of particular types of mobile devices and/or device capabilities within a group, such as to combine multiple devices of the same or similar types (e.g., devices that have the same or similar capabilities) to enable different users to receive the same or similar user experience, and/or to provide a group with a device having preferred capabilities (e.g., to add a device having remote network capabilities to a group that lacks such capabilities in some or all of its current members). In other embodiments, such matching may be based in part or in whole based on one or more defined tasks, events, notifications or campaigns, such as if a group of mobile devices are interacting with respect to a particular defined task, event, notification or campaign (e.g., were selected for such participation), or are otherwise each participating (e.g., without inter-device interaction) in a particular defined task, event, notification or campaign.

As one specific example of interactions that may occur, mobile device 1 may be an iPhone device that has 3G wireless remote connectivity capabilities 160a and also Wi-Fi wireless local connectivity capabilities, and mobile device 2 may be an iPod Touch device that has only Wi-Fi wireless local connectivity capabilities. The user of mobile device 1 (referred to as “User A” in this specific example) may invite the user of mobile device 2 (referred to as “User B” in this specific example) to participate in chat activities using an application with corresponding capabilities (e.g., APNS, or “Apple Push Notification Service”, capabilities), and User B accepts and joins a corresponding chat room with User A. Subsequently, User A launches game 1 on mobile device 1, and then navigates to a friends list provided by game 1 and locates User B. User A then toggles a button provided by game 1 that looks like a chat bubble, to indicate to send an invitation to chat with User B. Game 1 then sends a notification to User B indicating that User A has requested to chat with User B. Using the Wi-Fi connection on mobile device 2, User B accepts User A's request, and taps a button that launches game 1 and that performs automated matchmaking operations for User A and User B based on User A's request to chat. The result of the matchmaking operations is to select mobile device 1 as the current host, such as because User A initiated the request, and mobile device 2 acts as a client of mobile device 1. Both devices are communicating with each other across different types of networks (3G and Wi-Fi), while leveraging User A's mobile device 1 as a centralized server to engage with each other. As a second specific example of interactions that may occur, a user of one of the mobile devices could have the mobile device with him or her without currently using it (e.g., it is in a pocket or holster), but the mobile device could nonetheless be part of a group, including to act as a host for the group (e.g., without the user's current knowledge, such as based on previous approval given by the user for the mobile device to be used in such a manner)—if so, the user may receive benefits (e.g., monetary fees, “points” within an application or for the LTG Server, etc.) for providing a hosting server that others can use. Such functionality enables the providing of computing connectivity and services for a fee, leveraging payments and transacting based upon digital goods/currency, while the owner is not even paying attention and/or is using other applications on their mobile device.

In addition to the operations of module 101, the LTG Server 100 may further in some embodiments include one or more additional modules 103-109 and 131-137. In the illustrated embodiment, the additional modules include an advertisement server module 103 that may provide advertisements for display or other presentation on particular mobile devices 150 at particular times, including in conjunction with particular applications (e.g., at particular locations within an application; at particular times within an application, such as upon request by the application for display at a particular part of the application functionality; etc.)—such advertisements may, for example, be stored as part of the other storage 128 or instead on other remote storage (not shown), and may be selected in various manners (e.g., using some or all of the information 121-128 to personalize or otherwise direct particular advertisements to particular recipients and situations). While different users and mobile devices within a group may receive different advertisements in a particular embodiment and situation, in other embodiments and situations a single advertisement may be sent to some or all mobile devices within a group. In some embodiments, the advertisement server module 103 may further provide information about promotional opportunities in accordance with defined tasks, events, notifications and campaigns, including to use promotional opportunity information from information 129.

In the illustrated embodiment, the additional modules also include a messaging server module 105 that may be used to send messages to particular mobile devices and/or all mobile devices within a group, such as from the LTG Server 100 and/or from a particular application. As one example, a third-party application owner or provider distinct from an operator of the LTG server may request that a specified message be sent to all current and/or prior users of the application, such as to provide promotional content related to that application or to other products or services (e.g., another application from that application owner or provider). In some embodiments, the messaging server module 103 may further provide information about notifications in accordance with defined tasks, events, and campaigns, including to use notification-related information 130 and/or campaign information 129.

In the illustrated embodiment, the additional modules also include a payment module 107 that may be used to exchange payments with users and/or with application owners or other providers. For example, users may be charged various fees by application providers and/or may be charged various fees by the LTG Server 100 for particular functionality that it provides, and if so the payment module 107 may be used to obtain those fees (e.g., one-time fees, on-going subscriptions, usage-based fees, etc.). In some embodiments, the payment module 107 or other module 109 may further perform activities related to tracking the redemption of particular coupons, vouchers, discounts or other promotional opportunities provided to particular users, such as based at least in part on tracking activities of those users and/or their mobile devices.

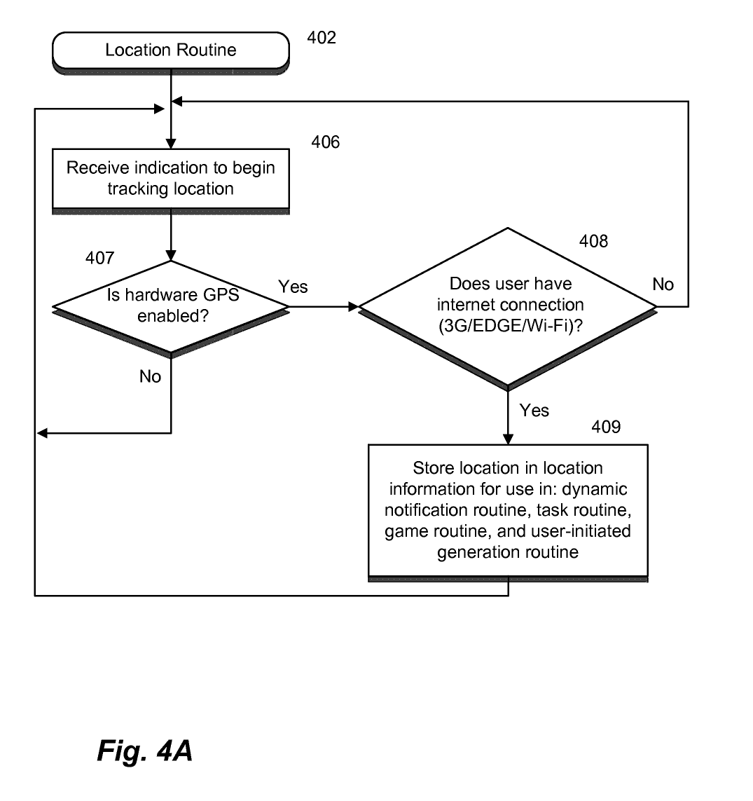

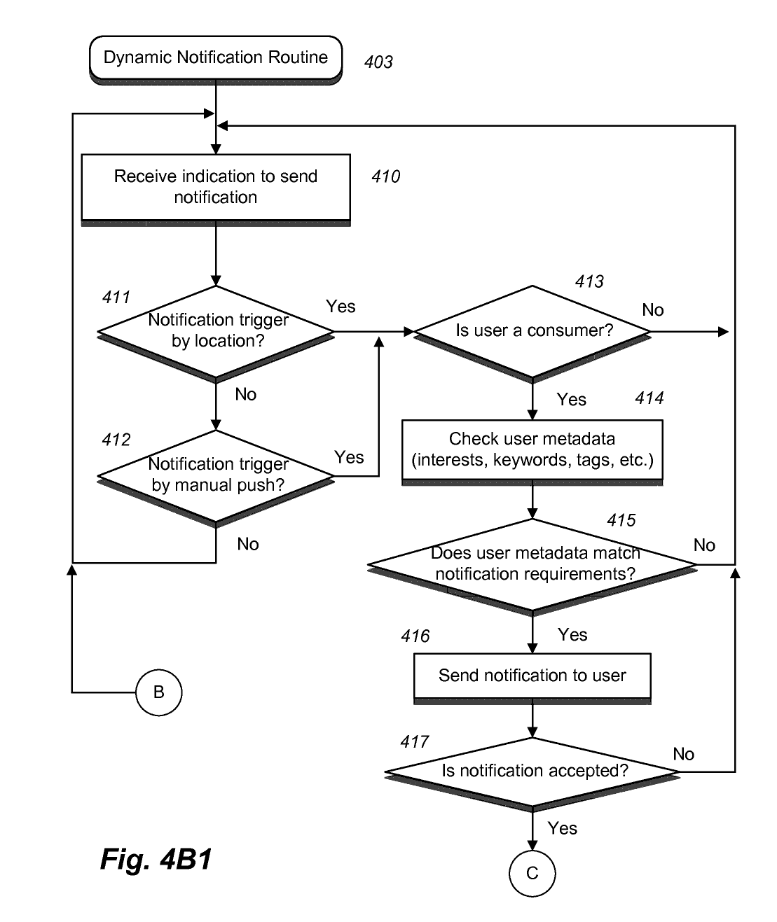

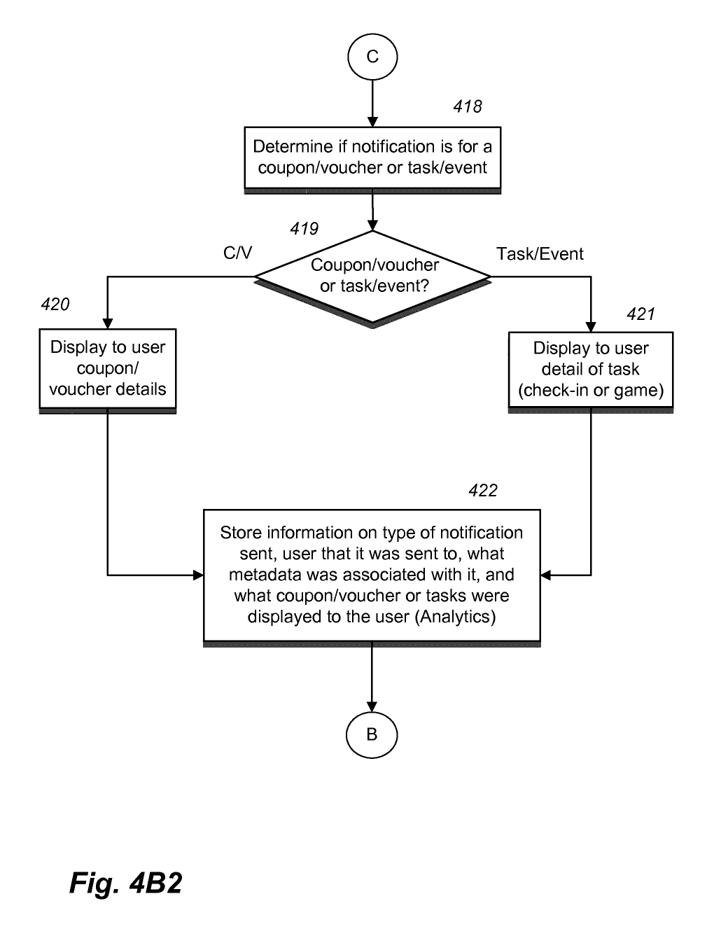

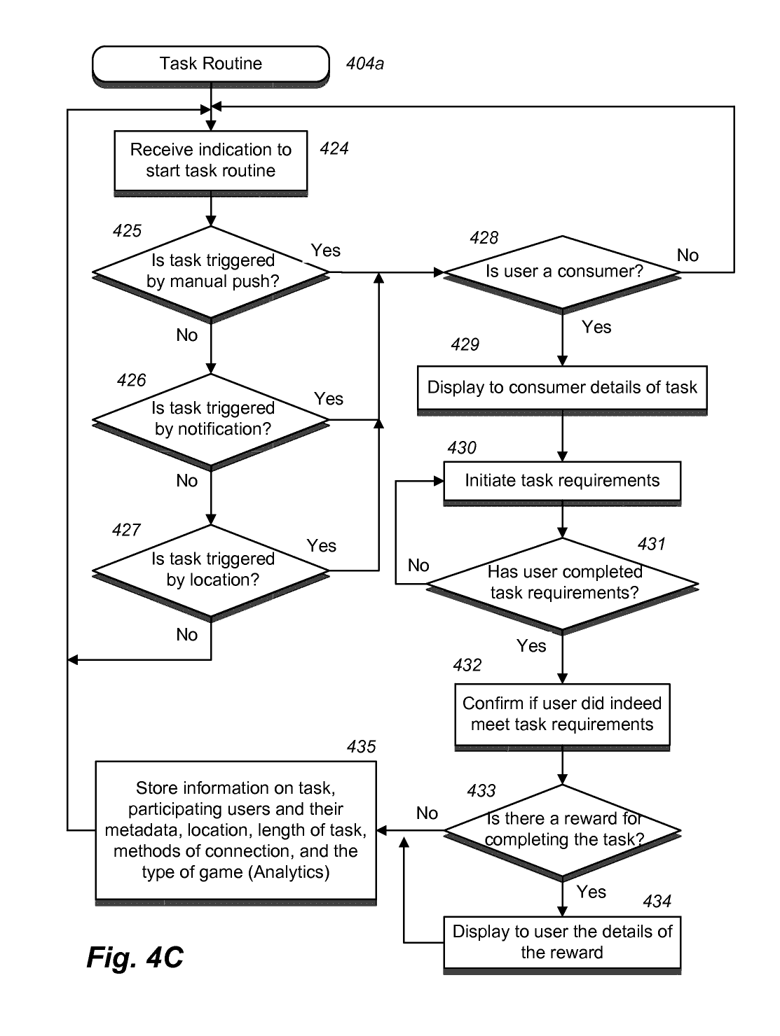

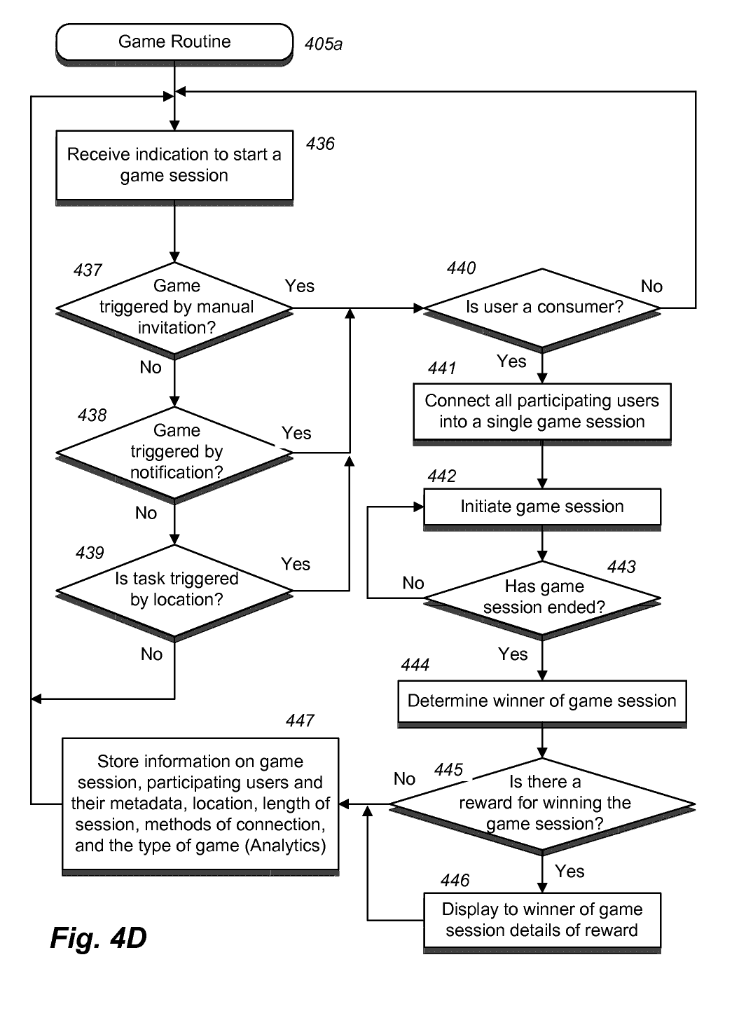

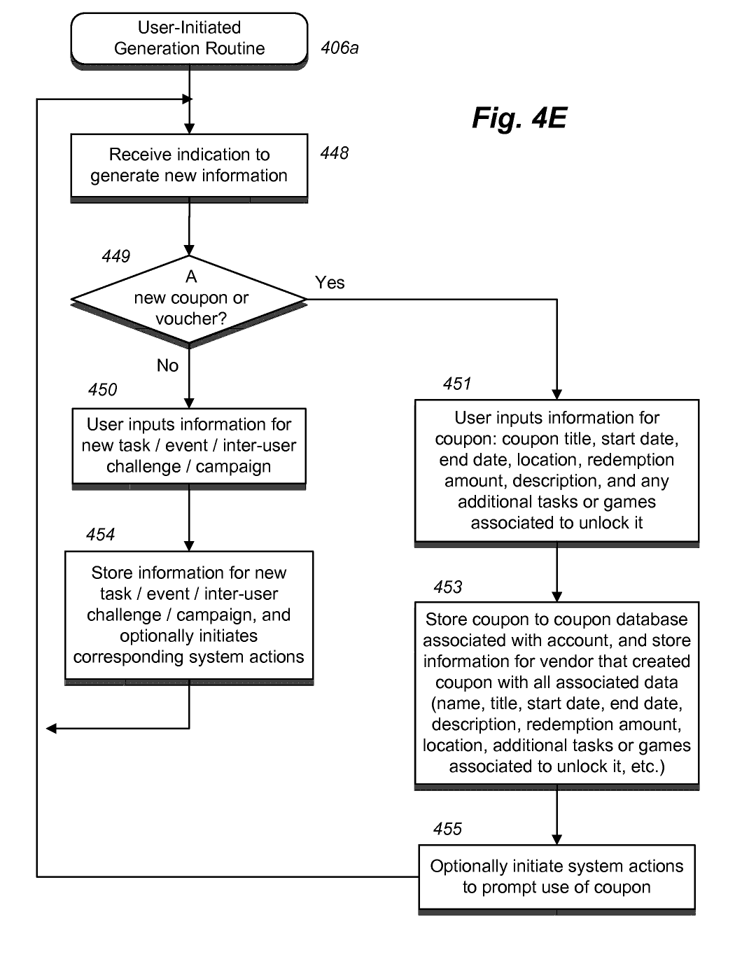

In the illustrated embodiment, the additional modules may also optionally one or more other modules 109 that may be used to provide other types of functionality of interest. As one example, a third-party application owner or provider distinct from an operator of the LTG server may request that a specified message be sent to all current and/or prior users of the application, such as to provide promotional content related to that application or to other products or services (e.g., another application from that application owner or provider). As one example, in some embodiments, the manager module 101 may be separated into multiple modules, such as one module that provides functionality related to host selection for a group, and another module that provides functionality related to dynamic canvas display functionality for a group. In addition, the other modules 109 may optionally include a user-initiated generation module that provides functionality to enable clients and other users to initiate the generation of various types of information to be used by the LTG server 100, including related to tasks, events, notifications and campaigns. Additional details related to modules 131-137 and a user-initiated generation module are included elsewhere herein, including with respect to FIGS. 4A-4E.

It will be appreciated that various of the details provided in FIG. 1 are illustrative, and that other types of functionality may be provided in other manners in other embodiments.

For illustrative purposes, some examples of particular types of functionality that may be provided by the LTG server system are included below. These examples are provided for illustrative purposes and are simplified for the sake of brevity, and the inventive techniques can be used in a wide variety of other situations, some of which are discussed below, including in some embodiments in which some or all of the members of a group are not mobile devices or otherwise differ from the example in one or more manners.

Thus, the LTG server system may perform various operations and provide various benefits in various embodiments. In at least some embodiments, the LTG server system acts as a location-based service (LBS) that combines a coupon generation framework with a game engine. End users may be provided with tasks (e.g., daily) to complete in order to trigger and redeem dynamically generated coupons and vouchers; to earn badges and achievements; to climb LTG server system leader boards versus various other users; etc. The LTG server system may thus be used to enhance user interaction at physical locations, and increase brand awareness for business clients.

As a location-based service, the LTG server system may act as an information and entertainment service, accessible from mobile devices via a mobile connection to the Internet and utilizing the ability to leverage the geographical positioning enabled on such mobile devices. The LTG server system may enable a user to “check-in” at local restaurants and favorite spots, and earn achievements and points that are displayed to your friends and other users—checking-in means to physically be at a location, making note that you were there at a specific point in time. Users may also leave notes and reviews of the place that was visited. The points and achievements that are earned drive a competitive aspect to these applications. Points and achievements mark and display your accomplishments to others; it's a “proven track record,” if you will, allowing the community to respect other users and celebrate the individual expertise and opinions. In addition, users may be prompted to travel to many different physical locations to be rewarded with real, dynamically generated coupons and vouchers as well as virtual rewards such as achievement points and badges. As one example, Starbucks may create a task for a user that requires them to “check-in” at five different physical locations. By doing so, the LTG server system will dynamically generate a coupon that appears on the user's mobile device for a 15% off coupon for any participating Starbucks.

As a game engine, the LTG server system may act as a software system designed for the creation, development and deployment of video games. For example, with respect to a particular game, users may be able to complete in-game jobs in order to receive experience points, money and job mastery, but at the same time may decrease energy and/or health points (e.g., by fighting other game players). Various types of inter-user interactions may occur during particular games. The game engine for the LTG server system will enable users to earn points, badges, and achievements for completing challenges and missions. When coupons, vouchers, achievements, badges are earned, users, may, for example, see a splash takeover with a corresponding image, the title of the item with a brief description, and a corresponding sound to stimulate the users' response, as well as encourage users to accomplish more challenges and missions as they use the system more.

Tasks, including challenges and missions, are things that can be created by the LTG server system, by users, and by vendors. Typically, tasks created by users will be for achievements, badges, and overall LTG server system points, while tasks created by the LTG server system and/or vendors will be for some sort of monetary value (e.g., coupons, vouchers, and/or LTG server system bucks). User-created tasks are a type of user-generated content (UGC), and may enable users to delegate challenges or missions to other users to spur system usage and engagement. Challenges and missions may be differentiated by their attributes, with a challenge being a type of task that has a limit in terms of redeemability (e.g., the first 20 people to complete x, y, z), and with a mission being available to everyone who wishes to participate until it ends (e.g., if it expires, if a user/client who created it decides to end it, etc.).

Users have the ability to seek out challenges and/or missions that have been created by other users and vendors. For example, vendors such as Starbucks could have a free drink voucher available for users who accept and complete the “Starbucks Daily Challenge.” By taking on a challenge, the user may be presented with the title of the challenge, what the criteria are to complete the challenge, and what the rewards are for completing the challenge. The vendor may specify when the voucher becomes available, as well as when the voucher ends, or if the voucher reaches a certain limit. Associating real monetary value with a reward that is obtainable by a user from completing a challenge or mission may spur users into desiring more rewards. However, challenges and missions without associated monetary value for users are also of use for various reasons.

Dynamic coupon/voucher generation is the act of creating a coupon or voucher based on certain actions, events and user metadata. For example, for an LTG server system user that travels to a particular neighborhood 4-5 times a week and has interests for “burgers”, the LTG server system may parse this information while also tracking the user's location, enabling it to dynamically generate coupons and vouchers about “burgers” associated with locations in that neighborhood (or along a route to or from that neighborhood).

Vendors may also be allowed to create multiple coupons and vouchers that are set to start and end at specific dates, as well as be triggered based on certain criteria. For example, if Starbucks in the Belltown neighborhood sets Voucher A to be activated when at least 50 people check-in at this location, and the moment that the 50th user checks-in, a notification will be sent out to all users within the area that Voucher A has been unlocked by the 50th user. In addition, particular users (here the 50^{th} user) may be featured as the voucher “unlocker.” By allowing vendors to specify multiple pre-generated coupons, they are able to create a list of coupons and vouchers that match a particular marketing schedule. If changes are desired, the vendors may use a graphical user interface (e.g., a Web-based GUI, a mobile device GUI, etc.) where they will be able to manage their coupons and vouchers.

Predictive analysis leverages dynamic coupon and voucher generation by data-mining different information corresponding to coupons or vouchers. For example, a voucher that is set off to activate 50 people check-in at Starbucks may take the information of each user that checked-in, the time of day, and the day of the month, and store that information for further analysis by the LTG server system and/or the vendor that provides the voucher (here Starbucks). Such information may also be used by the LTG server system in providing appropriate promotional information and opportunities to user, including to enable advertisers to purchase advertising space via the LTG server system.

Predictive analysis components (PACs) include, but are not limited to, the following:

Volume Limits (e.g., 50 vouchers per day)

User Characteristics/Metadata (e.g., age, interests, sex, etc.)

Location (whether approximate or exact)

Altitude (whether approximate or exact)

Direction/Heading (whether approximate or exact)

Previous and subsequent “check-ins”

The LTG server system may provide a GUI to enable vendors to generate coupons and vouchers and/or to manage existing ones. If a vendor makes a change related to a coupon, for example, the GUI page displaying the coupon will change as well. In addition to providing a game engine, the LTG server system enables local and/or non-local vendors to offer dynamically generated coupons for users trying to earn achievements and badges. Such vendors may, for example, manage an account that has the ability to dynamically generate coupons for users to redeem, which may stimulate physical user interactions with the vendors and increase business, and may further be able to manage their “location” to indicate where the vendor is currently located. If the vendor is a multi-location business (e.g., a chain of stores), that vendor can manage more than one location within the LTG server system. Vendors may also be able to send mobile notifications to all users in a specified vicinity. For example, a coffee store vendor may initiate mobile notifications to all users satisfying specified criteria (e.g., in a specified geographic area) that says, “Come in and show this coupon to receive 10% off of any size coffee!”, with a recipient user having the option to “view” or “cancel” for the notification. View causes a new GUI page to open to enable presentation of the coupon to the coffee store vendor, while Cancel causes the mobile notification to be closed (e.g., so that the user continues with other prior interactions with the LTG server system), although the coupon may still be available later for selection by the user.

An example of completing a challenge or mission corresponding to the coffee store vendor may cause a mobile notification indicating, “Please check in at three different participating <vendor> locations to unlock this mystery coupon!”. A recipient user would have the option to “activate challenge (or mission)” or “cancel.” If the user activates the challenge (or mission), the LTG server system receives a signal from the user's mobile device (e.g., from the LTG client software 155 of FIG. 1) indicating that the user is participating in an “ongoing challenge (or mission).” Subsequently, the LGT server system and/or LTG client software on the mobile device monitor the user's locations (e.g., when the user does a “check-in”) to determine if the user has visited a defined vendor location in order to complete one piece of the challenge or mission (which in this example has three pieces corresponding to three different participating vendor location visits). When all pieces have been completed, a mobile notification saying “You have completed three check-ins!” may be sent to the user with the options of “View” and “Cancel,” with View causing the resulting coupon to be viewed and Cancel enabling the coupon to later be retrieved. Such functionality provides benefits to vendors, users and the LTG server system—for example, vendors get more customers, users get discounts on desired items, and the LTG server system receives increased use of the system by users and vendors. Vendors may also be enabled to manage a Web page that is specifically designed for the vendor by the LTG server system, which displays the detail of the coupon or other offer, and which may be dynamically changed by the vendor.

The LTG server system may thus provide a system for vendors to manage their coupons, deals and mobile notifications, optionally while charging corresponding fees (e.g., a monthly fee) based on different offerings. For example, there could be monthly subscription plans, flat rate plans, partial package plans, usage based plans, etc. Such plans would be managed by LTG server system and may be adjustable at any point in time, including to meet usage demands on the LTG server system. The LTG server system may offer promotional tiers and different options for future vendors. Furthermore, content provided by the LTG server system may be offered for purchase in a marketplace managed by the LTG server system.

As previously noted, one type of vendor may be advertisers who advertise products and services, and they may optionally pay the LTG server system a fee to be displayed to all or a concentrated area of the users. An advertiser may have the option to pay an additional amount to advertise at any area or region they choose. Other vendors may be retailers or other companies that want to drive traffic to physical storefronts. The vendors may initiate user-generated content (UGC) by means of offering coupons and deals for users to redeem. Coupons and deals may be as simple as displaying their information to a user on a mobile device, optionally along with information about challenges or missions that are associated with the vendor.

Users may create an LTG server system profile, such as with a username and password, a personal biography (e.g., date of birth, location, phone number, gender, status, etc.) which the system may use to determine eligibility of the user for particular tasks, events, notifications and campaigns. Users may generate new content on a day-to-day basis by uploading pictures, issuing inter-user challenges (e.g., to compete in a particular game), completing challenges and tasks, etc.

As one example, a vendor client system may access the LTG server system and define a piece of content (e.g., a coupon or voucher that can be redeemed at some point in time). The content may have vendor-specified criteria regarding which users can redeem it, such as, for example, one or more of the following: current user location (e.g., longitude, latitude); user gender; user age; user interests; user hobbies; prior user check-in's, user purchase history, time of day, etc. For a matching user, a push notification may be sent to the user's device (e.g., a message with multiple options).

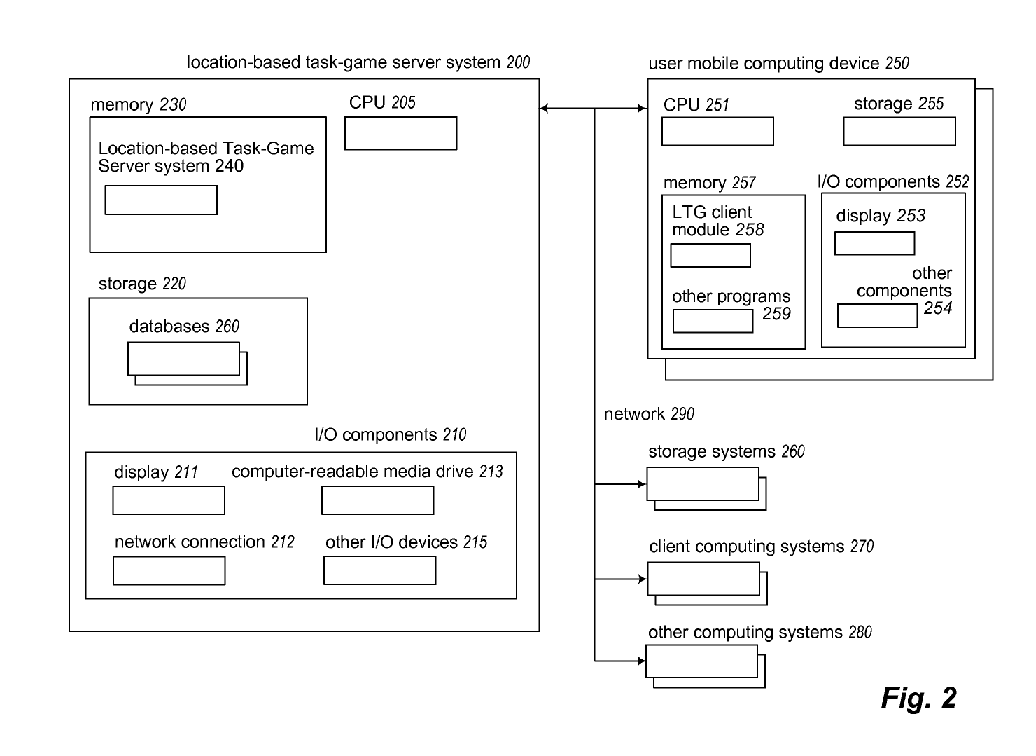

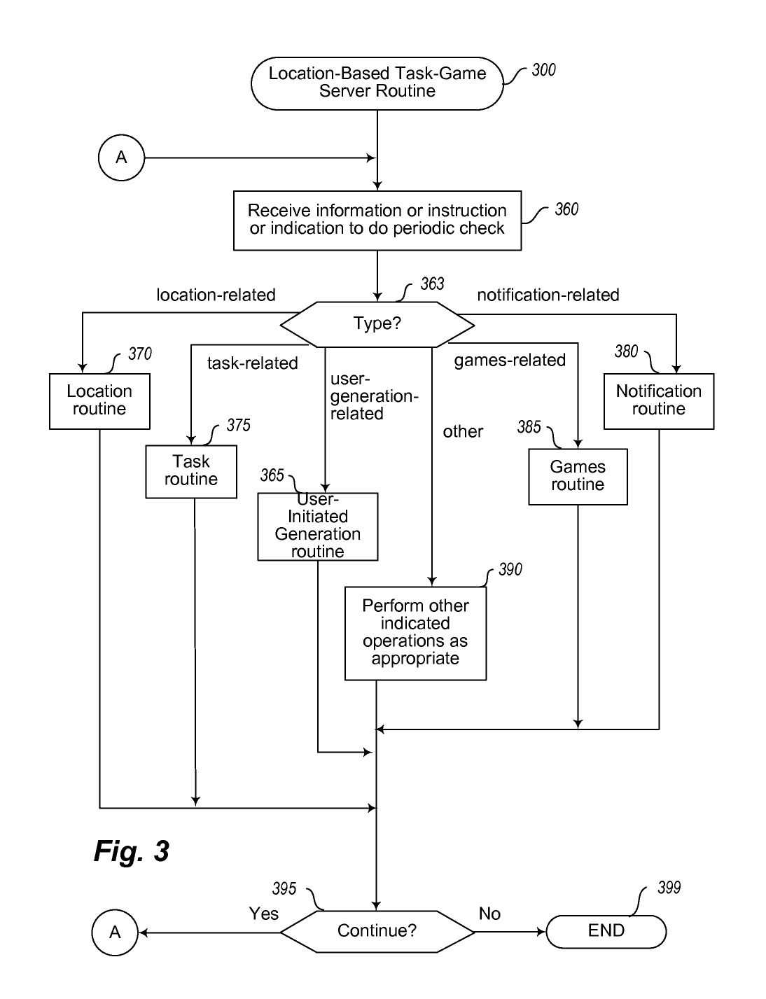

FIG. 3 is a flow diagram of an example embodiment of a Location-based Task-Game Server routine, and FIGS. 4A-4E are flow diagrams illustrating example embodiments of various modules of such an LTG server system. For example, with respect to routine 300 of FIG. 3, the routine may be provided by, for example, execution of the LTG server system 100 of FIG. 1 and/or the LTG server system 240 of FIG. 2, such as to provide promotional information and opportunities to users of computing devices in manners that are based at least in part on activities and locations of the users. The routines of FIGS. 4A-4E may similarly be provided by, for example, execution of modules 135, 137, 131, 133, and user-initiated generation module 109 of FIG. 1, respectively.

With respect to FIG. 3, the routine 300 may receive information or an instruction (e.g., a request from a user, an instruction from a client, an indication from a subroutine, etc.) or an indication of expiration of a timer in block 360, and proceed to block 363 to determine the type of corresponding action to perform. If the received information, instruction or other indication corresponds to user location, user notification, a task, a game, or user-initiated generation of content, the routine proceeds to blocks 370, 380, 375, 385, or 365, respectively, which in this example are implemented in FIGS. 4A-4E, respectively. If the received information is of another type not described with respect to FIGS. 4A-4E, it may instead be handled in block 390 as appropriate. After blocks 365, 370, 375, 380, 385 or 390, the routine continues to 395 to determine whether to continue, such as until an explicit indication to terminate is received. If it is determined to continue, the routine returns to block 360, and otherwise continues to block 399 and ends.

Thus, the described techniques include performing tasks that are based on the current location of the mobile device. As described in FIG. 4a, and corresponding to block 370 of FIG. 3, the LTG server system may detect the location of a user's mobile device, such as based on latitude and longitude. Such location information may further initiate activities of other of the routines illustrated in FIGS. 4B-4E. For example, FIG. 4B (including FIGS. 4B1 and 4B2, and corresponding to block 380 of FIG. 3) describes a routine in which a user may receive a dynamic notification, whether triggered manually (FIG. 4b, 412) or based on the user's location (FIG. 4b, 411), such as to complete a task (e.g., a prompt to go to the nearest grocery shop), to receive a benefit based on task completion or event satisfaction, an inter-user challenge, etc. A task may, for example, be to check-in at a particular location (e.g., a user goes to a location, which has an associated latitude and longitude, and presses a button that sends the current coordinates to the LTG server system), may be to play a game as described in FIG. 4d, etc. At step 433 of FIG. 4C, the routine checks to see if there is any other information associated with that task (e.g., was there a coupon associated with this check-in?). If there is, a push notification may be sent to that particular mobile device from the LTG server system that was previously defined as described in FIG. 4b steps 414 and 415 (e.g., if user of the mobile device fits the criteria of completing a task, reward the user with a coupon). If there wasn't any additional information associated in block 433, the LTG server system may not do anything other than store associated information, until another unique event occurs where a mobile device has completed a task, elsewhere.

In addition to the above-described technique of a task, a game may be performed, as described in FIG. 4d (corresponding to block 385 of FIG. 3). For example, multiple users may complete a game with other users of mobile devices (e.g., four users in a two mile radius may be playing a game with each other based on their active Internet connection). One example would be a tapping game on a mobile device, where the person with the most taps in a period of time wins. The LTG server system will check to see if the game had a location and/or any additional information associated with it, as described in FIG. 4d, steps 441, 442, 443, 444, 445, 446, and 447. If there is a reward that is associated with it, a push notification may be sent to that particular mobile device from the LTG server system (e.g., if the user of the mobile device wins the game, reward the user with a coupon). If there wasn't any additional information associated the LTG server system may not do anything other than store information in block 447, until another unique event occurs where a mobile device has completed a task, elsewhere.

In addition to each of the described operations that have been described thus far, analytics activities may track and analyze various information based on users of mobile devices engagement patterns (e.g., number of times a certain button was pressed, number of people within an approximate locations radius, number of users who have completed a certain task, etc.). This is seen in part in blocks 409, 422, 435, 447, and 453. In addition, in some embodiments, when tasks and/or game routines are triggered, users of mobile devices may be rewarded with points or badges (e.g., 10 points for completing a task and an associated image with a title that signifies a sense of accomplishment, or otherwise known as an achievement). This is described in FIG. 4c, step 434 and FIG. 4d, step 446.

The described techniques include user-initiated actions to generate content or other information of some sort that can be accessed by mobile devices that access the LTG server system, as described in FIG. 4e (corresponding to block 365 of FIG. 3). Such content may include coupons and other promotional information, tasks, events, campaigns, inter-user challenges, etc. User-specified information may be saved to the LTG server system in blocks 453 and 454, and later used when a relevant mobile device and/or user meets specified criteria (e.g., to send a push notification to a mobile device because it is in a particular location based on its latitude and longitude).

Additional techniques are described herein, but are not illustrated in the flow charts of FIGS. 3 and 4A-4E for the sake of brevity.

FIG. 2 is a block diagram illustrating example computing systems suitable for executing an embodiment of a system for coordinating interconnection and use of multiple mobile devices together in a distributed manner. In particular, FIG. 2 illustrates a Location-based Task-Game server system 200 suitable for executing an embodiment of a LTG Server system 240 that facilitates interactions between various mobile computing devices 250 over a network 290, such as by providing functionality of the LTG server 100 of FIG. 1. The network 290 may include publicly-accessible networks such as the Internet and/or the World Wide Web, and may also include one or more private networks, such as private cellular telephone networks or private local-area networks (“LANs”). While not illustrated here, in some embodiments the Location-based Task-Game server system 200 may include multiple computing systems, some or all of which may be co-located or otherwise associated, while others of which may be located remotely from other computing systems within the Location-based Task-Game server system. In addition, while not illustrated here, various modules of the LTG Server system 240 may be present and used in at least some embodiments, as discussed with respect to FIG. 1 and elsewhere.

In the illustrated embodiment, the Location-based Task-Game server system 200 has components that include one or more CPU processors 205, various I/O components 210, storage 220, and memory 230. The illustrated I/O components include a display 211, a network connection 212, a computer-readable media drive 213, and other I/O devices 215 (e.g., a keyboard, a mouse, speakers, etc.). In addition, the mobile computing devices 250, client computing systems 270, storage systems 260 and/or other computing systems 280 may also each include similar components to some or all of the components illustrated with respect to Location-based Task-Game server system 200, but at least some such components are not illustrated in this example for the sake of brevity. For example, the illustrated mobile computing devices 250 may each have one or more CPU processors 251, I/O components 252 such as a display device 253 and other components 254, storage 255, and memory 257. In the illustrated embodiment, a client LTG software module 258 is executing in memory 257, along with one or more optional other programs 259 (e.g., corresponding to one or more applications).

An embodiment of a LTG Server system 240 is executing in memory 230, and it interacts with client mobile computing devices 250 and client computing systems 370, and optionally other computing systems 280 and/or storage systems 260 over one or more of the networks 290. The other computing systems 280 may, for example, provide applications, application functionality and/or content to mobile computing devices, such as in a manner coordinated by the system 240. The system 240 may create and/or use various information during operation, such as information 121-130 of FIG. 1, which may be stored in one or more database data structures 260 on storage 220 and/or on one or more remote storage systems 260. The system 240 may include various software instructions that are executed by the system 200, such as to program or otherwise configure the CPU processor(s) 205 to perform particular functionality of the described techniques. Similarly, the module 258 may include various software instructions that are executed by each of the devices 250, such as to program or otherwise configure the CPU processor(s) 251 to perform particular functionality of the described techniques. In some embodiments, client computing systems 270 may similarly each execute software (e.g., a client-side component of the LTG Server system 240) that program or otherwise configure the CPU processor(s) of those client computing systems to perform particular functionality of the described techniques.

It will be appreciated that computing systems 200, 270 and 280, devices 250 and storage systems 260 are merely illustrative and are not intended to limit the scope of the present invention. The systems and/or devices may instead each include multiple interacting computing systems or devices, and may be connected to other devices that are not illustrated, including through one or more networks such as the Internet, via the Web, or via private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, digital music player devices, handheld gaming devices, PDAs, wireless phones, pagers, electronic organizers, Internet appliances, television-based systems (e.g., using set-top boxes and/or personal/digital video recorders), and various other consumer products that include appropriate communication capabilities. In addition, the functionality provided by the illustrated LTG Server system 240 may in some embodiments be distributed in various modules. Similarly, in some embodiments, some of the functionality of the LTG Server system 240 may not be provided and/or other additional functionality may be available.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., the LTG Server system and/or LTG client software) and/or data structures, such as by execution of software instructions of the one or more software programs and/or by storage of such software instructions and/or data structures. Furthermore, in some embodiments, some or all of the systems and/or modules may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

In some embodiments, the described techniques further include coordinating the inter-connection of multiple mobile devices in particular manners, such as for multiple mobile devices of multiple distinct types, and optionally using multiple different types of inter-connections. As one illustrative example, first and second mobile devices of different first and second types may be inter-connected using a first local wireless networking protocol (e.g., Bluetooth), the second device may be interconnected with a distinct third mobile device of a third type using a distinct second local wireless networking protocol (e.g., Wi-Fi), and the third mobile device may be inter-connected with one or more fourth remote server computing systems using a distinct third remote networking protocol (e.g., 3G wireless or 4G wireless using one of various underlying implementation technologies; WiMAX; etc.). To continue the illustrative example, functionality that is available from the fourth remote server computing systems may be provided to a group of some or all of the first, second and third mobile devices via the connection between the third mobile device and the fourth remote server computing systems, and the other inter-connections between the mobile devices of the group. Accordingly, to support this illustrative example, the described techniques may in some embodiments include coordinating the inter-connections between the mobile devices of the group and/or the fourth remote server computing systems in various manners, such as by selecting a particular type of inter-connection to use between two devices or systems when multiple alternatives are available, selecting one or more particular mobile devices to perform a particular type of operation on behalf of the group and/or provide a particular type of functionality to the group, etc. Additional details related to coordinating inter-connections between mobile devices of a group and/or other remote computing systems are included herein, and examples of such inter-connections are further described in provisional U.S. Patent Application No. 61/580,615, filed Dec. 27, 2011 and entitled “Distributed Functionality On Mobile Devices,” which is hereby incorporated by reference in its entirety.

The described techniques include performing matchmaking operations in at least some embodiments to determine whether and/or how a group of multiple inter-connected mobile devices will provide functionality to each other and/or will access functionality from one or more remote server computing systems, including to select a host mobile device for the group, such as from multiple candidate mobile devices within the group. The host mobile device may in some embodiments and situations host various functionality that is made available to other mobile devices of the group, such as with respect to an application that is being executed and/or used in a distributed and coordinated manner by the mobile devices of the group—such situations may include those in which a connection to remote server computing systems is not currently available or in use, and the host mobile device may be selected from multiple candidate mobile devices within the group that are options for hosting the functionality for the group. In addition, the host mobile device may in some embodiments and situations provide a connection to one or more particular remote server computing systems, such as to enable functionality to be provided to the mobile devices of the group corresponding to an application that is being executed and/or used in a distributed and coordinated manner by the mobile devices of the group—in such situations, the host mobile device may be selected from multiple candidate mobile devices within the group that are options for providing such a connection. As a first illustrative example, a particular remote server computing system may be a game server that provides, sponsors or otherwise supports one or more game applications that are playable in a coordinated manner on each of multiple inter-connected mobile devices of a group, and the matchmaking operations may include selecting at least one mobile device of the group to be a host that provides a connection to the game server, to enable the game functionality to be provided to the group of mobile devices in a coordinated and distributed manner by the game server. As a second illustrative example, a particular remote server computing system may be an application server that provides, sponsors or otherwise supports one or more groupware applications that are usable in a distributed collaborative manner on a group of multiple inter-connected mobile devices (e.g., a distributed document creation application; an application that allows inter-communications between multiple users, such as video conferencing; etc.), and the matchmaking operations may include selecting at least one mobile device of the group to be a host that provides a connection to the application server, to enable functionality of the groupware application to be provided to the group of mobile devices in a coordinated and distributed manner. In either of the first and second illustrative examples, if a connection to the remote server computing system is not currently available or in use, the host mobile device may attempt to provide some or all of the functionality that would otherwise have been provided by the remote server computing system with respect to providing distributed functionality for a application to the mobile devices of the group, such as by using information that is stored locally to the host mobile device or that is otherwise accessible to the host mobile device (e.g., is stored on one or more other mobile devices of the group). The matchmaking operations may include considering one or more of a variety of factors when selecting a particular host, such as factors corresponding to the mobile devices that are part of the group, to the users associated with those mobile devices, and/or to the application being accessed. In addition, in some embodiments and situations, multiple host mobile devices may be selected for a particular group to provide distributed functionality for an application to the mobile devices of the group, such as to operate together in a distributed manner, or instead at different times or in different roles.

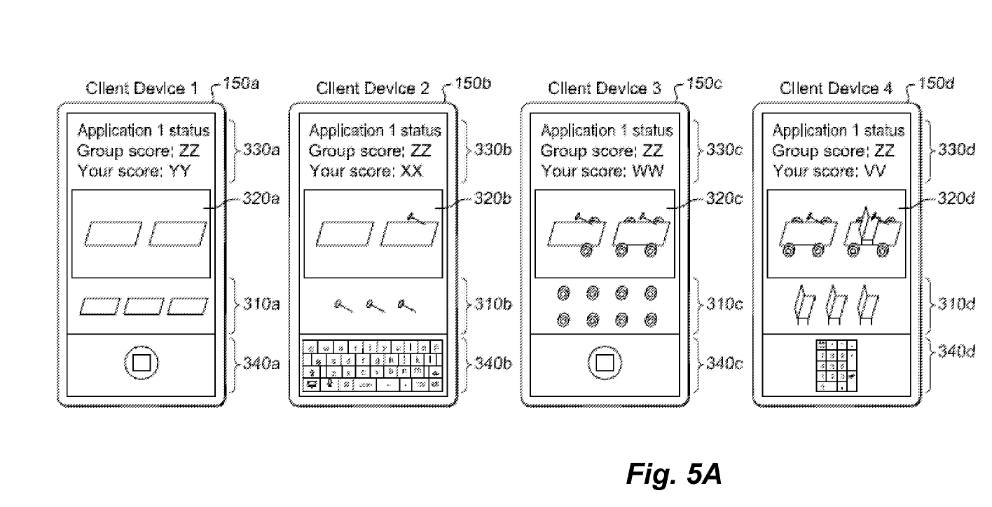

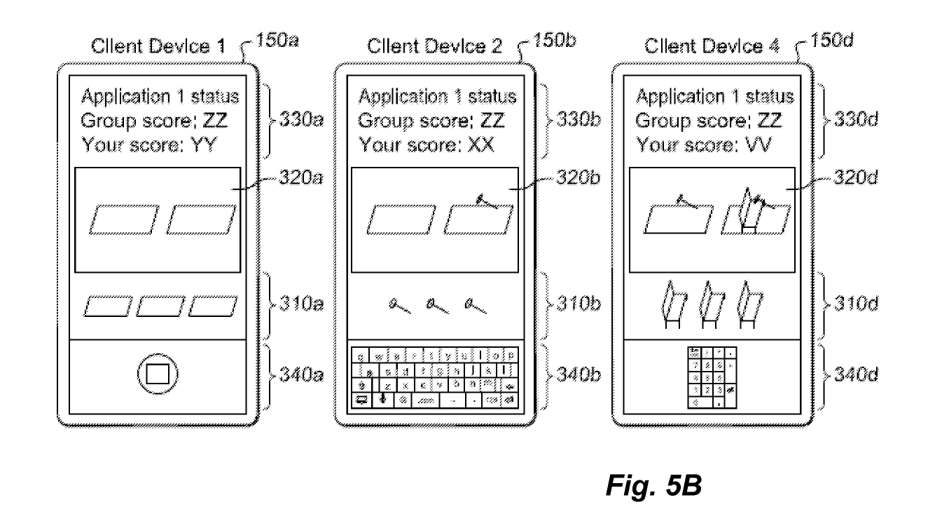

The described techniques further include providing a distributed display canvas functionality in at least some embodiments, by using the displays of multiple inter-connected mobile devices of a group to display some or all of the graphical user interface of an application, such as by displaying on each mobile device a distinct portion of the graphical user interface that is specific to a user of that mobile device. As discussed in greater detail with respect to FIGS. 5A and 5B, the distributed display canvas functionality may in some embodiments include displaying different vertical or horizontal slices of the graphical user interface of an application, such that if the multiple mobile devices of the group were lined up side-by-side and/or top-to-bottom in the correct order, a larger section of some or all of the graphical user interface would be visible across the various displays—such functionality may be provided in situations in which the mobile devices of the group are proximate to each other (e.g., within a specified number of feet, within a room, etc.) or are remote from each other (e.g., separated by one or more networks and/or by at least a minimum geographical distance). As a first illustrative example, a particular remote server computing system may be a game server as discussed above, with a graphical user interface of a game application allowing different users to interact with different portions of the game via the distributed display canvas (e.g., in ways that their actions affect other users in other portions of the game), or instead multiple users may simultaneously interact with some or all of the same portion of the game but on different displays via the distributed display canvas. As a second illustrative example, a particular remote server computing system may be an application server as discussed above, with a graphical user interface of an application allowing different users to interact with different functionality provided by the application via the distributed display canvas (e.g., different portions of a document being created in a distributive manner), or instead multiple users may simultaneously interact with some or all of the same functionality of the application but on different displays via the distributed display canvas (e.g., the same set of slides being displayed as part of a discussion). In either of the first and second illustrative examples, if a connection to the remote server computing system is not currently available or in use, the host mobile device may attempt to provide some or all of the functionality that would otherwise have been provided by the remote server computing system with respect to providing the distributed display canvas functionality, such as by using information that is stored locally to the host mobile device or that is otherwise accessible to the host mobile device (e.g., is stored on one or more other mobile devices of the group). The automated operations that are performed to provide distributed display canvas functionality may include considering one or more of a variety of factors with respect to how the graphical user interface of an application is displayed across multiple mobile devices of a group, including in at least some embodiments to be controlled in whole or in part by the application. In addition, in some embodiments and situations, multiple host mobile devices may be selected for a particular group to provide the distributed display canvas functionality for a application to the mobile devices of the group, such as to operate together in a distributed manner, or instead at different times or in different roles.

The described techniques further include providing capabilities to accommodate changes to a group of mobile devices, including with respect to a current host of the group and/or to distributed dynamic canvas functionality being provided for the group. With respect to a current host, the described techniques may include providing host migration capabilities in at least some embodiments that enable changing a host for a group of multiple mobile devices when one or more criteria are satisfied, including in some situations when a current host for the group leaves the group or otherwise becomes unavailable to serve as the host for the group (e.g., loses connection capabilities to one or more remote server computing systems, leaves a geographic location or area of the group of mobile devices, requests to no longer be the host, etc.). Such host migration capabilities may include performing additional matchmaking operations to select a new host for the group of mobile devices, whether in the same manner or a different manner from prior matchmaking operations that were previously performed to select the current host that is being replaced. In addition, when the mobile devices of the group are being used to provide a distributed display canvas, the described techniques may further include dynamically modifying the displays on one or some or all of the mobile devices of the group to reflect a modified distributed display canvas, such as to distribute the display canvas across a different group of mobile devices when the group membership changes (e.g., a mobile device leaves the group, a mobile device joins the group, etc.). In at least some embodiments and situations, the host change operations and/or distributed display canvas modification operations may be performed dynamically while a game or other application continues to be in use by the mobile devices of the group, including to make any changes in a manner that is transparent to some or all of the mobile devices and/or their users. The host change operations and/or distributed display canvas modification operations may be performed or coordinated in some situations by one or more mobile devices of the group (e.g., by a current host device, by all of the mobile devices of the group in a distributed manner, etc.), including in situations in which a remote connection to a remote server computing system is not available or is otherwise not in use, and may also be performed or coordinated in some situations by a remote server computing system (e.g., the server 100 of FIG. 1).

In addition, in at least some embodiments, a group of multiple mobile devices may be formed with respect to a particular application, such as based on those mobile devices participating in that application in a distributed manner. In such embodiments, the group membership may change as users join or leave the distributed use of the application, even if a particular mobile device that joins or leaves has not changed its location or current use of mobile device capabilities. Thus, if a number of mobile devices are in a given geographic location or area (e.g., in a room or building), different subsets of the mobile devices may be joined together into different groups, and the group memberships may change not only based on the locations of the mobile devices (e.g., based on mobile devices joining or leaving the geographic location or area), but also based on changes in activities of users of the mobile devices. In some embodiments and situations, a mobile device may simultaneously be part of multiple groups, including in situations in which the mobile device is executing multiple different applications corresponding to the different groups (e.g., playing a distributed game as part of a first group of mobile devices, and participating in a distributed communication application as part of a second group of mobile devices), whether the multiple groups are distinct other than for that mobile device being in both groups, or instead have other overlapping member devices. In addition, in some embodiments and situations, particular users and/or mobile devices may be invited to join a particular group and/or may be provided with information that enable the user and/or mobile device to perform actions to initiate joining a group. For example, a particular user may be provided with information about one or more other users that are geographically nearby, such as to enable the particular user to join those other users and participate in a group with them if so desired, or the particular user may be provided with information about one or more other users that are geographically remote but participating in particular activities of interest (e.g., using a particular application), such as to enable the particular user to logically join those other users over one or more computer networks and participate in a group with them if so desired. The information provided to the particular user may in some embodiments and situations be only partial information about the other users and/or mobile devices, such as to protect private information of the other users (e.g., as specified by those other users, such as in previously specified preferences or access controls) or for other reasons (e.g., to limit an amount of bandwidth used, to provide only information that is currently most relevant, etc.)—as one example, the provided information may indicate a general location and activities of other users, without providing information about identities of the other users.

FIGS. 5A and 5B illustrate examples of using multiple interconnected mobile devices together in particular distributed manners. For example, as a continuation of the examples discussed with respect to FIG. 1, four mobile devices 150 are included as part of a group that is participating in a coordinated execution of a particular application (here referred to as “game 1”) in a distributed manner. In this example, the four mobile devices may be of different types, such as to have different sizes and capabilities (e.g., different hardware interaction controls 340), but each device includes a display area 315.

In the example of FIG. 5A, the four mobile devices 150 are using distributed canvas display capabilities being coordinated by the LTG Server, with each device showing a distinct portion of a graphical user interface (“GUI”) of game 1. While the four mobile devices 150 are illustrated in a side-by-side manner, the user of each device may be able to view only the GUI shown on his or her device, with some or all of the mobile devices 150 optionally being located remotely from each other. In the example of FIG. 5A, game 1 is a game that allows different users to cooperatively build different portions of toy vehicles that are traveling along a conveyor belt 320 displayed in the GUI that moves from left to right across the GUIs of mobile devices 150a, 150b, 150c and 150d in order, and with the group receiving points for how accurately and quickly they build copies of the vehicles, and with each user separately receiving points or a score corresponding to that user's performance within the game. Current example game and user status information 330a is shown in each mobile device's portion of the GUI, in a manner that is at least partially specific to the user of that mobile device, and with such status information enabling leader board information to be tracked for the game.

Thus, in this example, the user of mobile device 1 may repeatedly select a vehicle chassis (shown in this example as a rectangle) from a storage bin section 310a of the GUI, and place the selected vehicle chassis on the portion 320a of the conveyor belt displayed on the GUI portion on mobile device 1, such as by using a drag-and-drop action on a touch-sensitive screen of mobile device 1. In this example, the user of mobile device 1 has currently placed two vehicle chassis on the portion 320a of the conveyor belt, and has previously placed other vehicle chassis on the conveyor belt that have since moved to the right and are now displayed on one of the other portions 320b, 320c and 320d of the conveyor belt. In this example, the user of mobile device 2 similarly adds a steering wheel to each vehicle chassis on the conveyor belt portion 320b from a storage bin section 310b of the GUI, the user of mobile device 3 similarly adds four wheels to each vehicle chassis on the conveyor belt portion 320c from a storage bin section 310c of the GUI, and the user of mobile device 4 similarly adds a front seat to each vehicle chassis on the conveyor belt portion 320d from a storage bin section 310d of the GUI. It will be appreciated that other variations and types of games may be used in other embodiments—as one example, if the placement of wheels takes longer than other tasks, two different users and mobile devices may receive the same or substantially similar portions of the GUI, such that they both see the conveyor belt portion 320c and a storage bin section 310c of the GUI, and can perform the same types of tasks on the same or different vehicle chassis. In addition, other users may be performing other tasks at other earlier or later portions of the conveyor belt that are not displayed in this example.

As previously noted with respect to FIG. 1, mobile device 3 was initially selected to be the host for the group of mobile devices 150, although its status as host in FIG. 5A may be unknown to some or all of the users of the mobile devices 150. As part of that role, it may have been receiving information from a remote game server system (e.g., content to display on the GUI portions 320a-320d), receiving information from a remote embodiment of the server 100 (e.g., instructions to coordinate the distributed execution of the application), providing information to the remote game server system (e.g., information about a current status of the game, actions of the users, etc.), and/or providing information to the server 100 (e.g., application state information, device state information, etc.).

FIG. 5B continues the example of FIG. 5A, but illustrates the dynamic modification functionality of the distributed canvas display capabilities. In particular, in the example of FIG. 5B, mobile device 3 has left the group, and the distributed canvas display for the game is dynamically modified to accommodate the current 3 devices that are part of the group. In addition, mobile device 1 dynamically takes over the host functionality for the group, and may begin to perform any of the activities previously performed by mobile device 3, including interactions with the remote game server system and/or remote LTG Server 100, although the switch to use of mobile device 1 may be transparent to some or all of the users of the mobile devices 150, such that the current host continues to be unknown to those users. With respect to the dynamic modification to the distributed canvas display for the game, in this example the user of each mobile device continues to perform the same type of actions as before, but with the activity of adding wheels to the vehicle that was previously performed by mobile device 3 being currently removed from the group activities for the game. As an alternative, the users of mobile devices 1 and 2 could instead have continued to perform the same types of activities, but the user of mobile device 4 could have had his or her activities changed to perform the activity of adding wheels to the vehicle that was previously performed by mobile device 3, with the display of mobile device 4 being updated to reflect that previously displayed to mobile device 3, and with the activity of adding seats being removed from the game. As another alternative, all of the users could have had their activities changed in one or more manners.

Accordingly, in the example of FIGS. 5A and 5B, the server 100 supports the dynamic modification of distributed activities of the group in executing the current application, including to dynamically perform new matchmaking activities to select a new host for the group, and to dynamically coordinate modifications to the distributed canvas display capabilities being provided. As previously noted, the dynamic modification of distributed activities of the group in executing the current application may be performed in whole or in part by a server 100 that is remote from the mobile devices 150 and/or may be are performed in whole or in part by one or more of the mobile devices 150 that are providing functionality of the server 100 using LTG client software 155.

It will be appreciated that various of the details provided in FIGS. 5A and 5B are illustrative, and that other types of functionality may be provided in other manners in other embodiments.

As previously noted, various entities may participate in interactions with or otherwise receive functionality provided by a LTG server system, including vendors that provide promotional information and opportunities via the LTG server system, other advertisers that may use information gathered via the LTG server system to provide functionality of interest (e.g., uses metadata about users of the LTG server system to advertise products and/or services via push notifications, branding opportunities within a user interface of the LTG server system, advertising spaces within the user interface of the LTG server system, etc.), end users that interact with the LTG server system via their mobile devices or other computing devices, and an operator of the LTG server system. In some embodiments and situations, other entities may also participate in activities and functionality provided by the LTG server system, optionally for a fee, such as for researcher users who use metadata about users of the LTG server system for purposes of evaluation and study, for redeemer users who work at point-of-sale locations for a vendor and may perform actions with the LTG server system related to redeeming a coupon or voucher provided via the LTG server system, etc. In addition, in some embodiments, non-user entities such as vendors and other advertisers and the operator of the LTG server system may each define and use one or more administrative accounts within the LTG server system that may each have different access privileges. As one example, each vendor entity may have one or more administrative accounts, including an overall account for the vendor, and optionally sub-accounts for particular administrative users that perform actions on behalf of the vendor (e.g., for a particular type of functionality provided by the vendor, for a particular brand and/or set of physical stores for a vendor, etc.). As another example, when the operator of the LTG server system is an organization, the operator may have different accounts or levels of access for different users within the organization, such as, for example, a sales department, an executive who is in charge of some or all of the organization, etc. These various entities that participate in interactions with or otherwise receive functionality provided by the LTG server system may each be thought of as playing different roles within the LTG server system, such as an end user role, a vendor role, an administrative user of a vendor role, a non-vendor advertiser role, a researcher role, a redeemer user role, one or more roles associated with the operator of the LTG server system, etc.

In addition, promotional information and opportunities (e.g., coupons, vouchers, etc.) that are provided to a user of the LTG server system may in some embodiments be shared by that user with others in various manners, including in some situations with others who are not yet users of the LTG server system. Such promotional information and opportunities may be shared, for example, via social networking sites and systems, via person-to-person interactions, etc. Depending on the eligibility criteria associated with a particular promotional opportunity, that promotional opportunity may be available for use by only a single user (e.g., the user of the LTG server system to whom the promotional opportunity was provided, the first user to use the particular promotional opportunity, etc.), may be available for use by all users that redeem that promotional opportunity, or may be available for circumstances between those first two types (e.g., for a specified quantity of users, for a specified period of time, etc.). Furthermore, in at least some embodiments and situations, information about particular offers may be provided to particular users based at least in part on prior requests from those users to be notified of offers in specified conditions (e.g., when I am in a specified location or in a location other than my typical location, and the offer is associated with a quiz-type game).

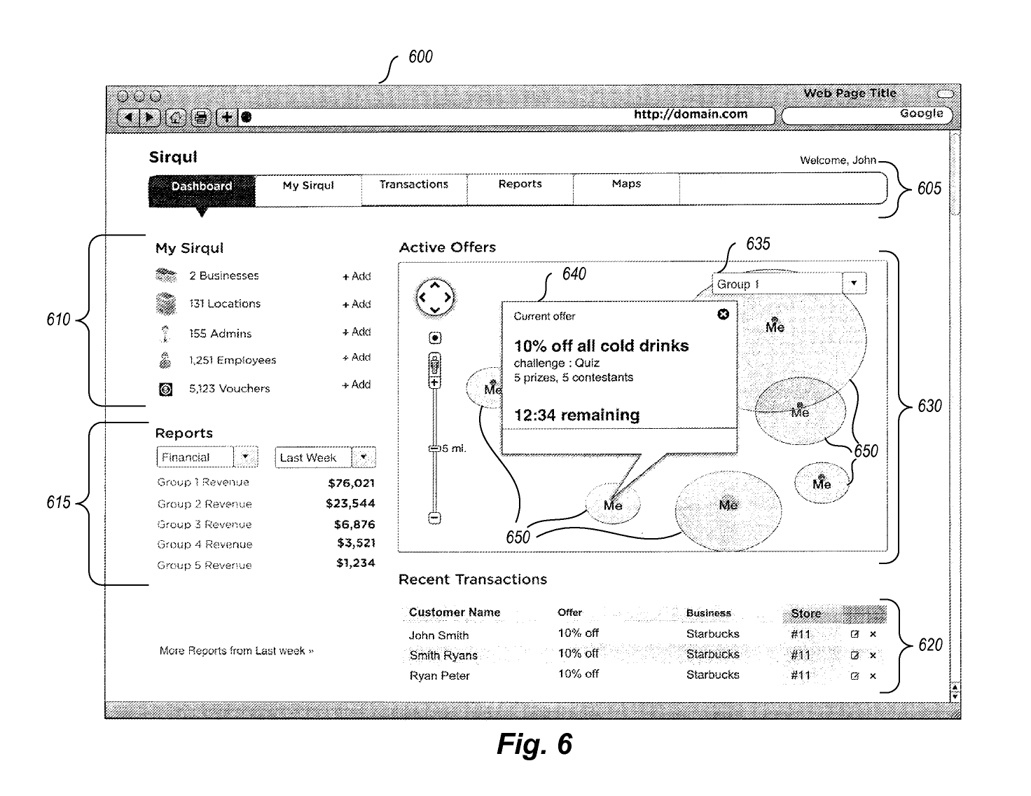

FIGS. 6-47 illustrate example user interface screens of a system for providing promotional information and opportunities to users of multiple mobile devices. In the example embodiments described with respect to these figures, a particular embodiment of the LTG server system (referred to as “Sirqul” in this example) is described, but it will be appreciated that other embodiments may have other functionality (whether in addition to or instead of the functionality illustrated in these examples).

FIG. 6 illustrates an example user interface screen 600 that may be displayed to one or more types of entities by the LTG server system. In this example, the user interface screen 600 is displayed to a user representative of a particular vendor (also referred to as a “merchant” in this example), such as a high-level executive of the vendor's business organization who has access privileges within the LTG server system to all information and functionality for the vendor. The example user interface screens of FIGS. 6-47 enable the vendor to define information about businesses of the vendor, to specify activities within the LTG server system corresponding to the vendor, to monitor vendor-related activity within the LTG server system, etc., as discussed in greater detail below.

In particular, the illustrated example user interface screen 600 includes various tabs 605 that enable the user to access different types of information and functionality, with a “Dashboard” tab being currently selected (e.g., by default). The user interface screen 600 also includes information and user-selectable controls 610 related to the vendor, which in this example indicates that the vendor has two distinct businesses that are separately tracked within the LTG server system, has 131 physical point-of-sale locations between the two businesses, has 155 defined administrative users with varying levels of access privileges, has 1,251 employees, and has 5,123 vouchers that have been sold to end users of the LTG server system for later redemption by those end users (e.g., via mobile devices of those end users). It will be appreciated that the illustrated details may not correspond to any actual business that may be discussed as part of these examples, such as the Starbucks Coffee Company. The information on the user interface screen 600 also includes various financial report information and controls 615, information and controls about recent transactions 620, and information and controls 630 about current active offers for this vendor. The active offer information in this example includes a selection box 635 via which the vendor may select a particular one of multiple groups of business locations (e.g., by geographic territory, or as otherwise grouped by the vendor), and shows a map corresponding to a geographic area in which various offers are currently active. The various offers 650 that are illustrated each have a shape corresponding to a geographic subarea of the map to which the offer applies, which in some cases may be overlapping. Additional information 640 is shown for a particular one of the offers 650, such as based on the vendor performing a mouse-over or other selection of that offer, including information about terms of the offer, an activity within the LTG server system which users may engage in to receive the offer (which in this example is a quiz), information about time remaining for the offer, and information about a total number of promotional opportunities or benefits (here referred to as prizes) and user contestants for the offer.

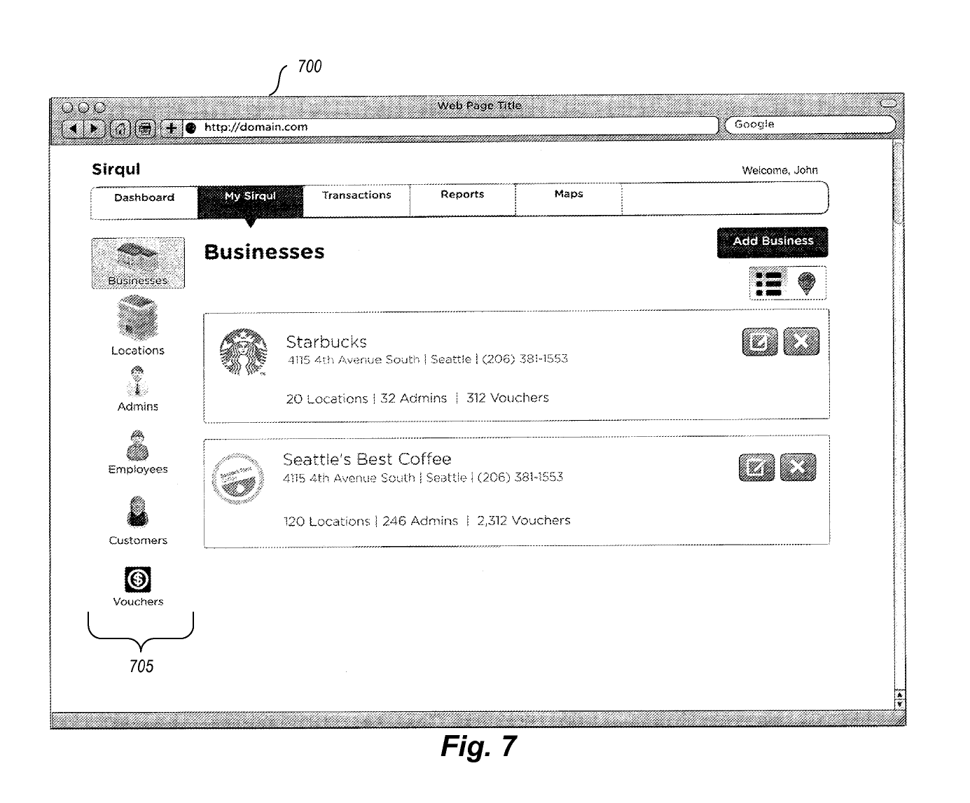

FIGS. 7-29 illustrate example user interface screens that correspond to selection of the “My Sirqul” tab 605, to enable the vendor to specify and monitor various information for the businesses of the vendor.

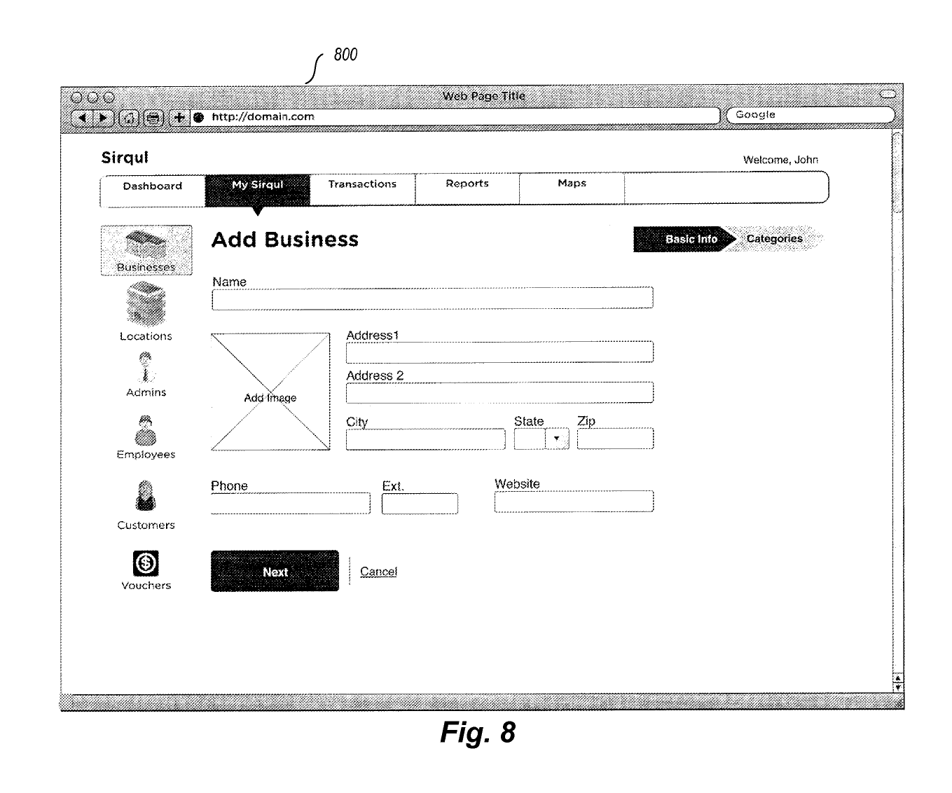

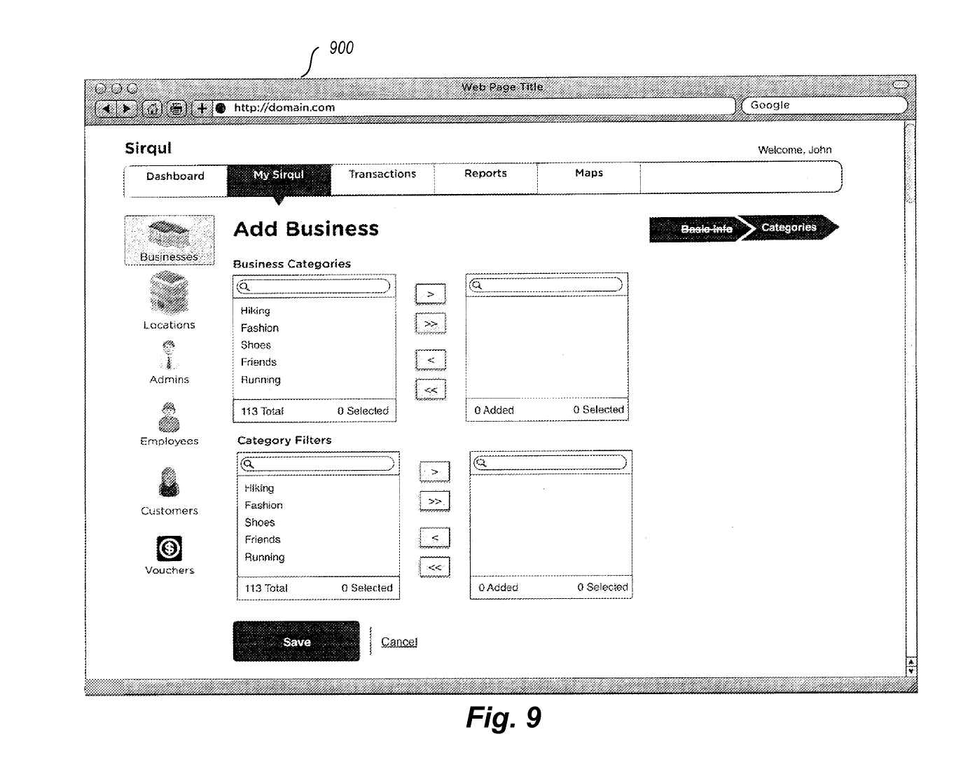

In particular, with respect to FIG. 7, various side tabs 705 are illustrated, with a “Businesses” side tab being currently selected. The remainder of the user interface screen 700 shows information about two example businesses that may be controlled by the current vendor, which in this example includes the Starbucks and Seattle's Best Coffee businesses of an example vendor Starbucks Coffee Company. Various summary information is shown for the businesses, and user-selectable controls are included to enable the vendor to add a new business or modify information about the existing businesses. FIG. 8 includes a user interface screen 800 via which the vendor may add information about a new business, with various information that the vendor may specify. FIG. 9 continues the activity of adding the business for the vendor, and in particular enables the vendor to specify one or more categories for the business, such as to enable users of the LTG server system to search for this business via the LTG server system using those categories, or to otherwise classify categories corresponding to this business (and its promotional opportunities).

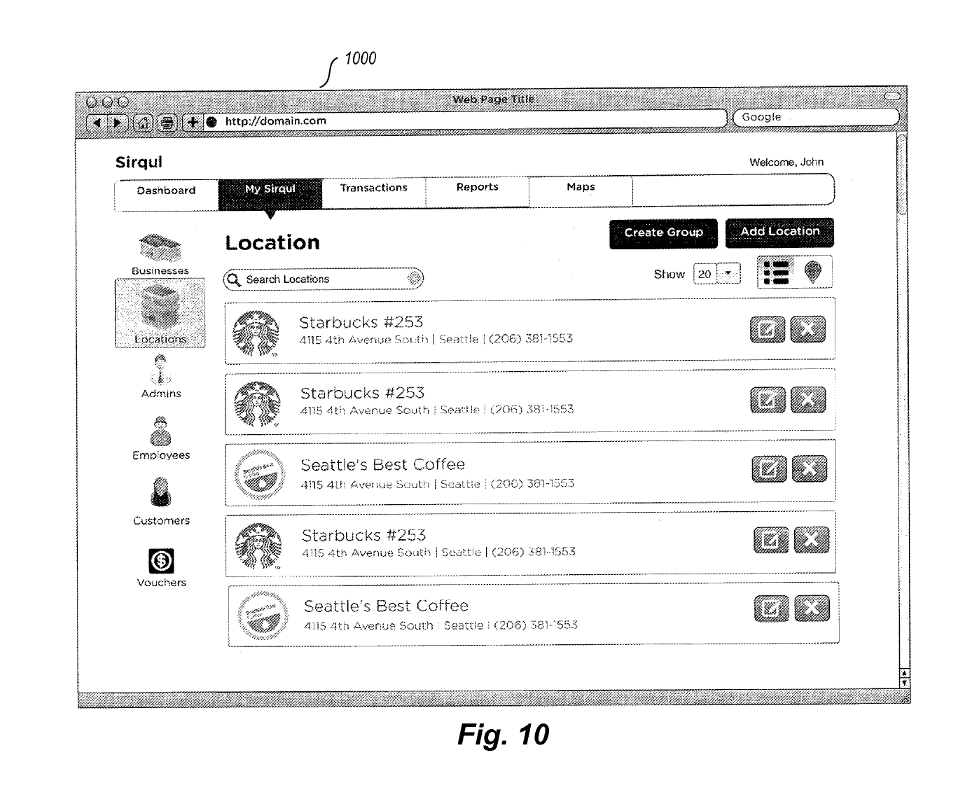

FIG. 10 illustrates an example user interface screen 1000 that corresponds to selection of the Locations side tab 705, and displays information about various business locations of this vendor, including user-selectable controls to add or modify location information, as well as to initiate creation of a vendor-specific business group of multiple business locations that will be managed together (e.g., based on geographical region or other criteria of interest to the vendor).

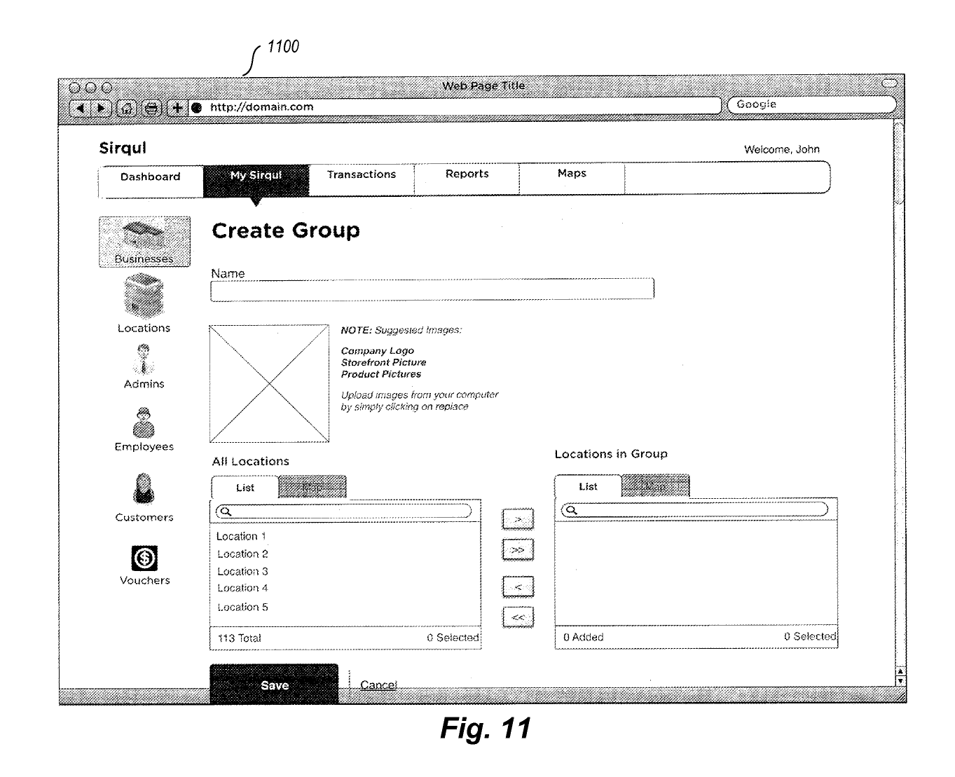

FIG. 11 illustrates an example user interface screen 1100 that corresponds to selection by the vendor of the “Create Group” user-selectable control of FIG. 10 (or other selection of by the vendor of corresponding functionality), and allows the vendor to provide various information for the business group being created, and to specify information about the business locations in the business group.

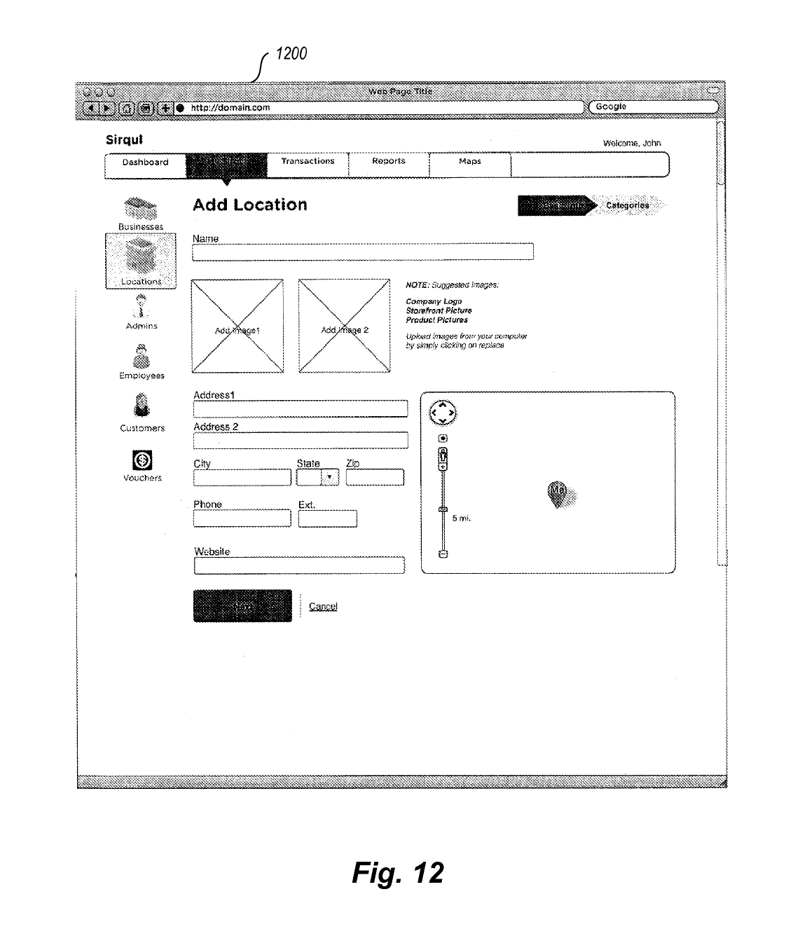

FIG. 12 illustrates an example user interface screen 1200 via which the vendor may add a business location by specifying various information about that location, including a map-related display to show the indicated geographic location for the business location.

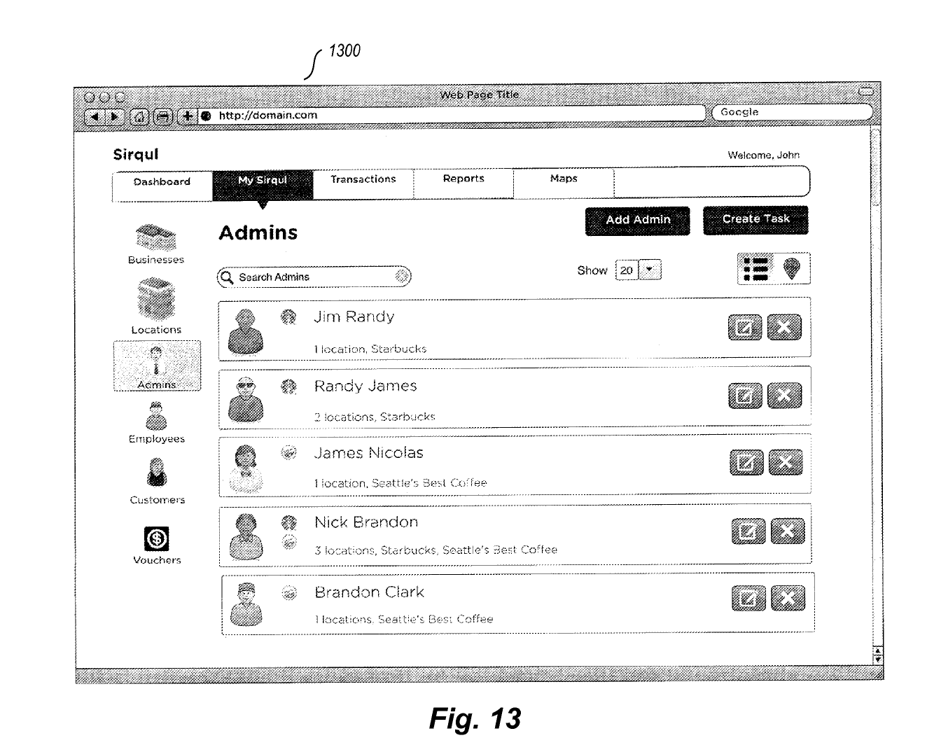

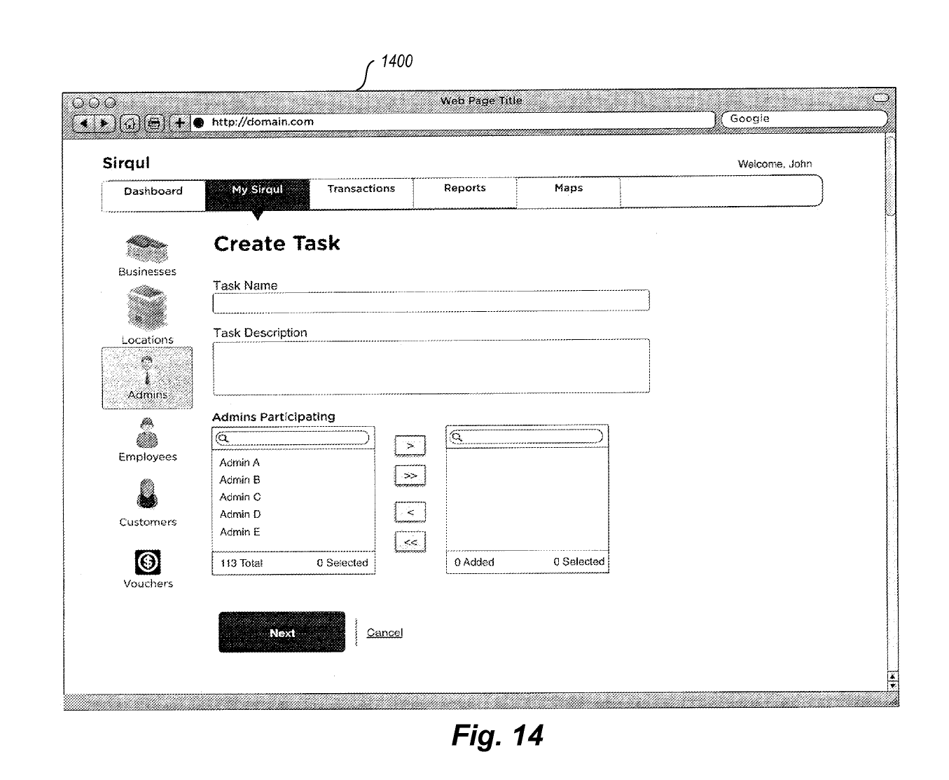

FIGS. 13 and 14 correspond to selection of the Admins side tab 705, and allows the vendor to view and specify various information for administrative users associated with the vendor. In this example, the user interface screen 1300 of FIG. 13 illustrates information about various defined administrative users and includes user-selectable controls to enable the vendor to add or modify information about administrative users, as well as to create jobs (also referred to as “tasks” in this example) that particular administrative users are to perform. Such jobs may be of various types, including activities within the LTG server system—a non-exclusive list of example jobs may include creating an offer, managing an advertising campaign that includes one or more offers, etc. FIG. 14 illustrates an example user interface screen 1400 via which the vendor may specify a particular job to be performed by one or more particular administrative users. While not illustrated here, the LTG server system may further provide various functionality to assist those administrative users in performing their assigned jobs, including to display information to an administrative user about his/her job(s), to notify an administrative user of jobs that they are to perform, etc., including in a manner analogous to a workflow system.

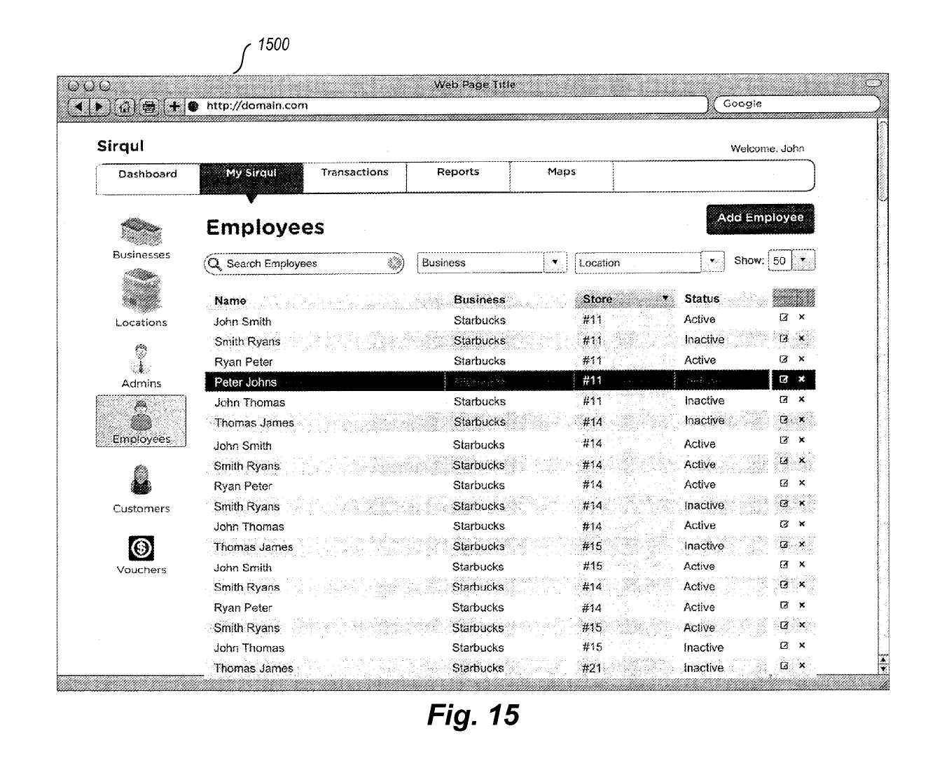

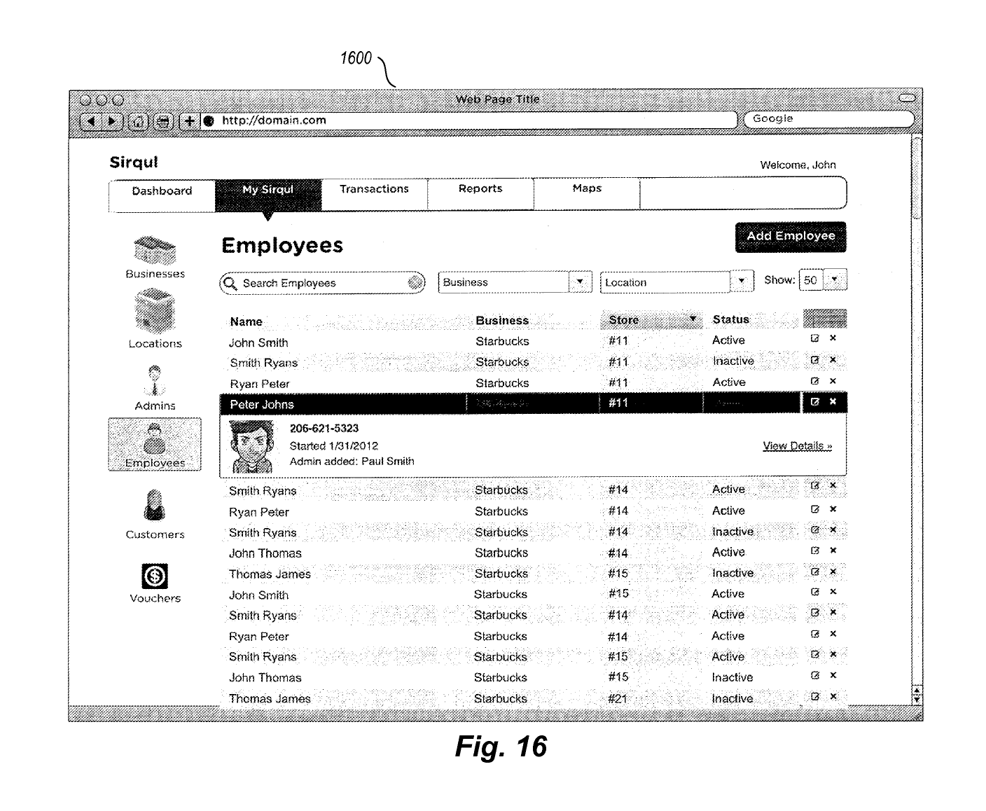

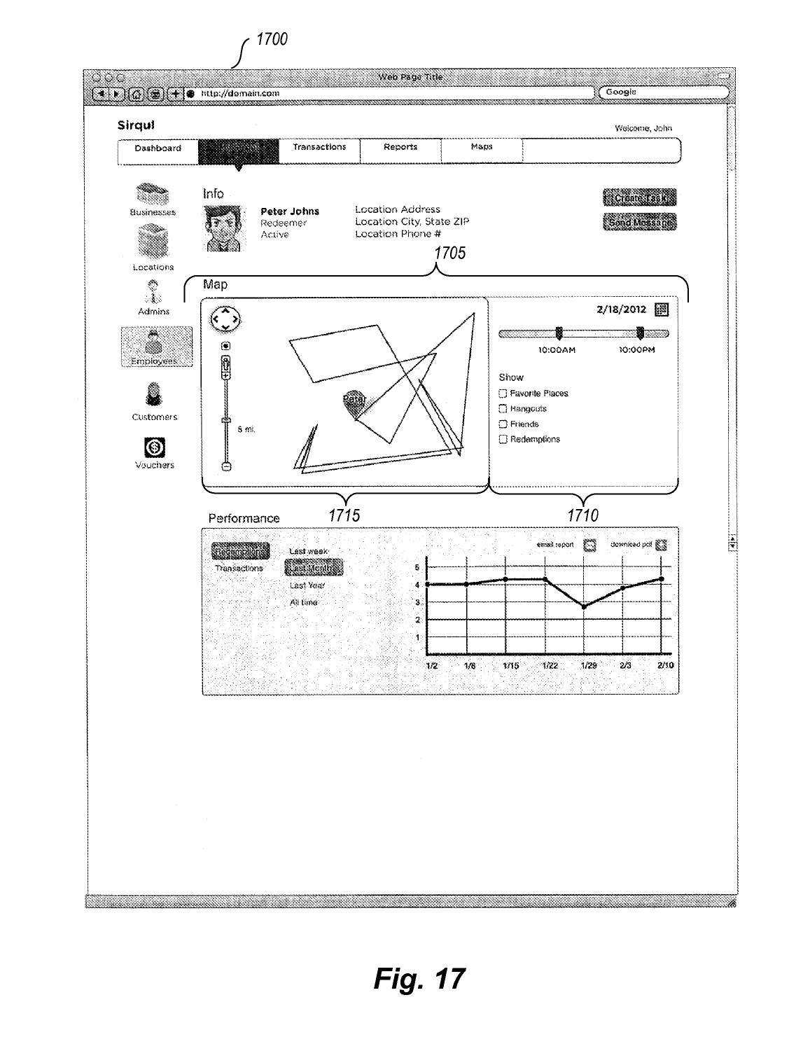

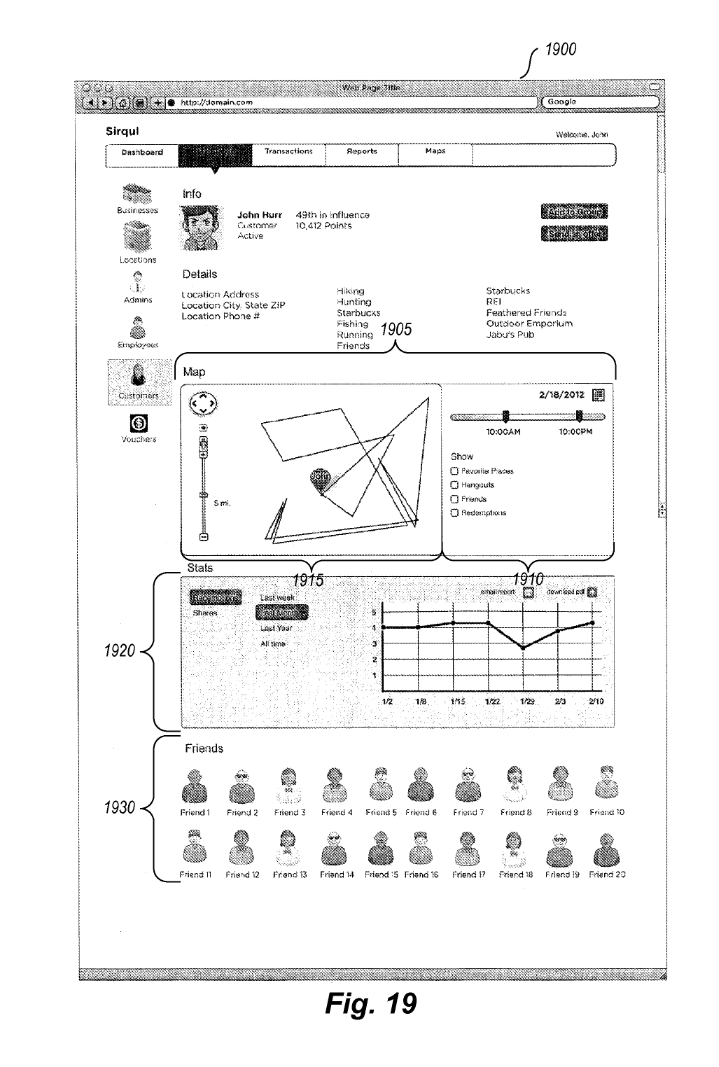

FIGS. 15-17 illustrate user interface screens that correspond to selection of the Employees side tab 705, and enable the vendor to specify and review various information about employees of the vendor. It will be appreciated that a particular human may in some situations play multiple roles, such as to be an employee of the vendor who is also a designated administrative user with specified access privileges to use at least some of the functionality of the LTG server system, and to optionally also be an end user of the LTG server system who is a customer of the vendor. The illustrated user interface screen 1500 of FIG. 15 provides information about various employees, and further includes user-selectable controls to enable the vendor to add or modify employee information. FIG. 16 illustrates an example user interface screen 1600 that corresponds to selection by the vendor of a particular employee, with additional details illustrated about that employee in response to the selection. FIG. 17 illustrates an example user interface screen 1700 via which further detailed information is displayed for the selected employee, which in this example includes a map area 1705, as well as various types of information about past performance of the employee within the business organization of the vendor. Additional details regarding the map area 1705 are included below with respect to similar information in FIG. 19 for customers of the vendor.

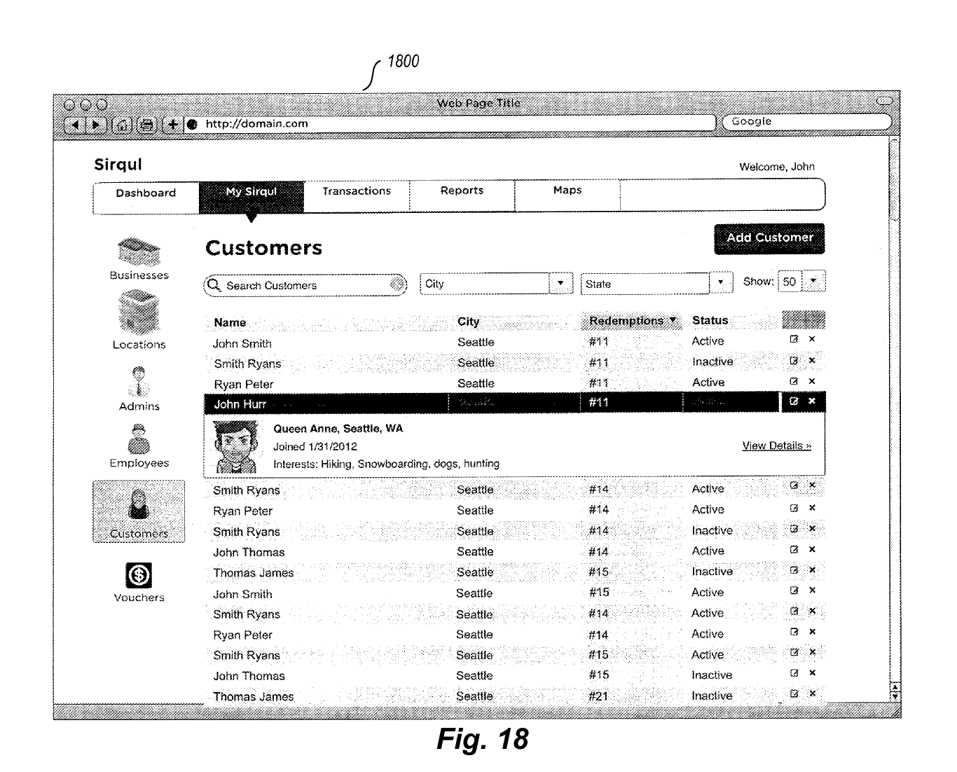

FIGS. 18 and 19 correspond to selection of the Customers side tab 705, to enable the vendor to review and specify various information for end users of the LTG server system who are customers of the vendor. In particular, the example user interface screen 1800 of FIG. 18 includes a list of customer users similar to that previously displayed for employees, with user-selectable controls to enable the vendor to add customer users or otherwise specify information. In addition, a particular customer has been selected in this example, with additional information shown for the selected customer. FIG. 19 illustrates an example user interface screen 1900 that provides additional details about the selected customer user, including map-related information 1905, 1910, and 1915 that is similar to the corresponding information 1705, 1710, and 1715 of FIG. 17 for employees. The illustrated information in screen 1900 further includes information 1920 related to activities of the customer user that reflect prior interactions with the vendor, and information 1930 about specified friends of the customer user (e.g., friends specified via one or more social networking sites separate from the LTG server system, friends specified by the customer user within the LTG server system, etc.). It will be appreciated that in at least some embodiments and situations, various information about customers and/or employees may be available to vendors and other entities in restricted manners of one or more types, such as based on privacy controls specified by the customers, employees, vendors and/or the LTG server system (e.g., optionally based on opt-in and/or opt-out selections for particular types of information to be private or not by particular users).

The map-related information 1905 includes user-selectable controls to enable the vendor to specify particular times and other filter or attribute information, and to see corresponding information 1915 as part of a map. In particular, in this example, the map information 1915 includes a path or trace of activity of this selected customer user during the specified time period, and that further corresponds to any other vendor-specified criteria. In this example, other vendor-specified criteria enables vendor selections to also illustrate information about the customer user's favorite places (e.g., based on a quantity of visits and/or frequency of visits, based on the customer user performing check-ins while at or near the location, based on the customer user indicating that he/she likes the location, etc.), hangouts (e.g., based on an amount of time spent there, such as on average and/or cumulatively), friends (e.g., to show when and where the customer user was interacting with particular friends during the illustrated path or trace, to show locations and activities of particular friends of the customer user during the selected time period even if the friends are not interacting with the customer user, etc.), and redemptions (e.g., of offers from the current vendor via the LTG server system, of offers from any vendor or advertiser via the LTG server system, etc.). It will be appreciated that in other embodiments, other types of controls may be provided to enable selection of other types of information (including any type of information available to the LTG server system), whether instead of or in addition to the illustrated types of information. In addition, similar information may be tracked and displayed for other types of entities, such as employees of the vendor, as illustrated in FIG. 17.

Such types of map-related information may provide a variety of types of benefits to the vendor and to the customer user. For example, the vendor may observe that the customer user (and possibly one or more friends of the customer user) pass by one or more business locations of the vendor on a regular basis (e.g., once a day, multiple times a day, at least once a week, etc.), or alternatively are currently near a particular business location of the vendor—if so, the vendor may determine to dynamically generate and provide an offer to the customer user (and possibly one or more friends of the customer user) for one or more particular business locations of the vendor.

In addition, while the information illustrated in FIG. 19 is for a single customer user, in other embodiments, the vendor may be able to specify a user group having multiple users, and display aggregated information at the group level for those multiple users. For example, for a defined user group of users who like hiking and coffee, the map display may be configured to illustrate multiple sub-areas within the map where the users of the defined user group congregate together or commonly pass by (whether together or alone, as may be configurable)—if those sub-areas include or correspond to one or more particular business locations of the vendor, the vendor may opt to target an offer to the users of the defined user group for at least one of those business locations. In addition, or alternatively, the map display may be configured to display path or trace information in a manner analogous to FIG. 19, but to similarly reflect aggregate information to show where multiple users of the group travel (whether together or alone, as may be configurable). It will be appreciated that a variety of other types of aggregate information for a user group may similarly be displayed on a map and/or via other types of visual presentations.

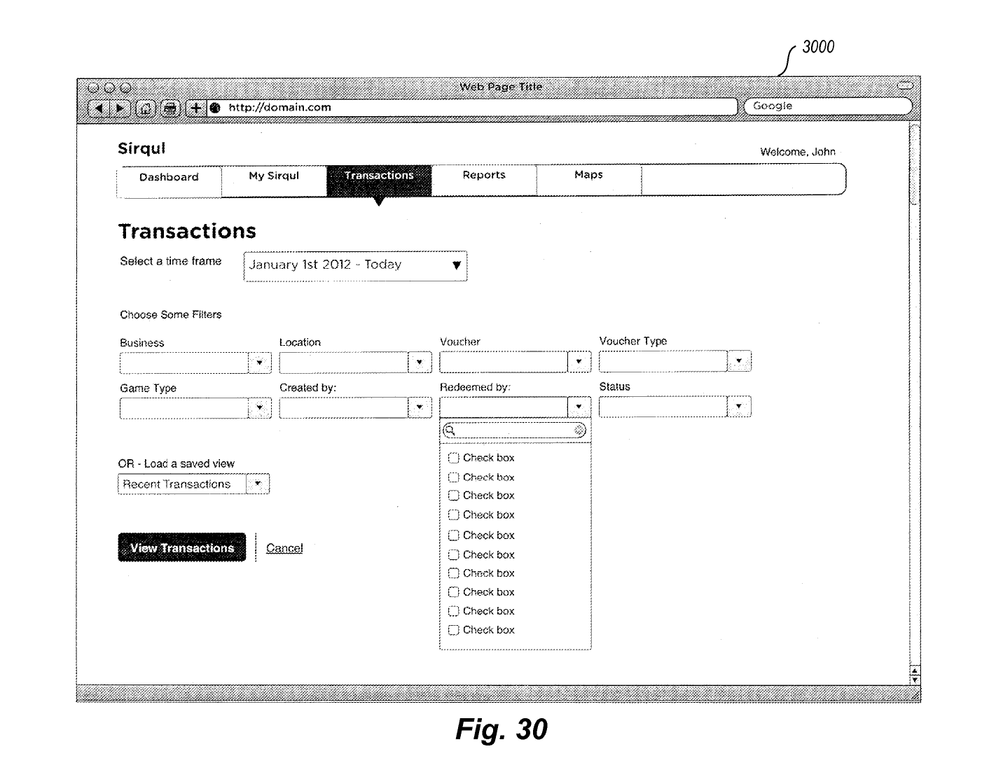

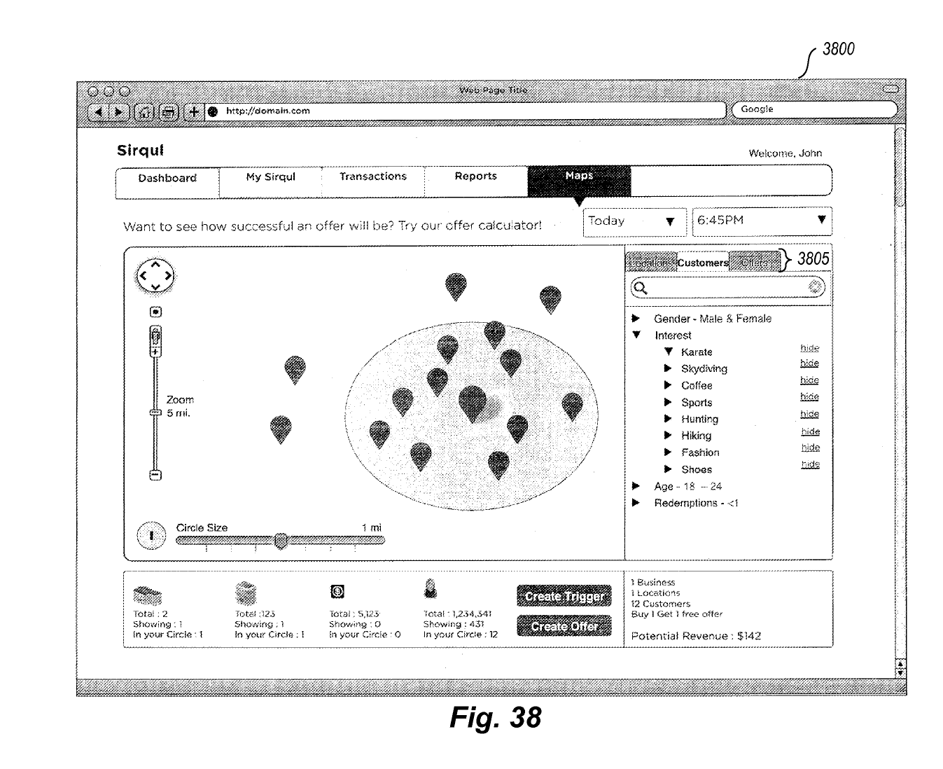

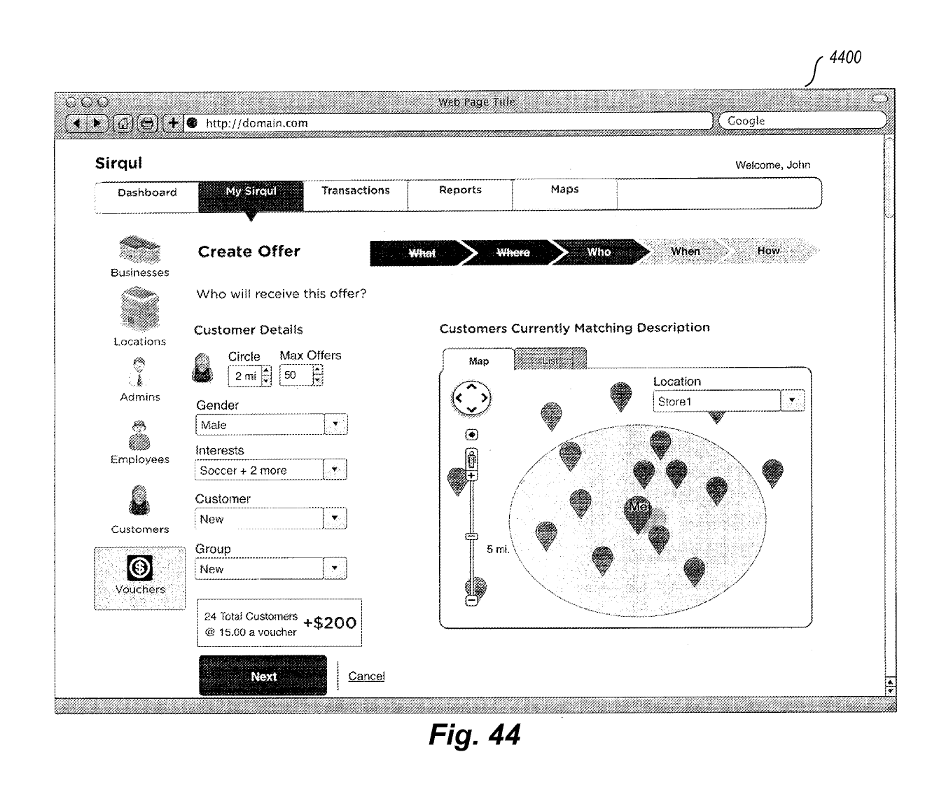

Such groups of users may be specified by the vendor in various manners, including to dynamically specify a user group at the time of information display, or to predefine one or more user groups and to then select a particular predefined user group for which to display aggregated group-level information. As one example, the vendor may specify a user group by interactively selecting users to add to the user group, in a manner analogous to adding business locations to a business group as illustrated with respect to FIG. 11, or to specifying administrative users who are assigned to a specified job as illustrated with respect to FIG. 14. As another example, the vendor may specify a user group by specifying one or more attributes (e.g., in a manner similar to that described with respect to FIG. 38 as part of specifying a candidate offer, in a manner similar to that described with respect to FIG. 44 for specifying a target group for a particular user, using an interface similar to that of FIG. 30 for specifying criteria for use in generating a report, etc.), with the user group including those users that match some or all of the specified attributes (as configured by the vendor). User groups may similarly be specified in other manners in other embodiments. In particular, in some embodiments and situations, the vendor and/or the LTG server system may use behavior-based information (e.g., past activities of users) and attribute-based information (e.g., based on user-specified attributes and/or system-assigned attributes), optionally that is tied to other related factors (e.g., one or more computing/communication devices of the user, specified friends of the user, specified interests of the user, etc.

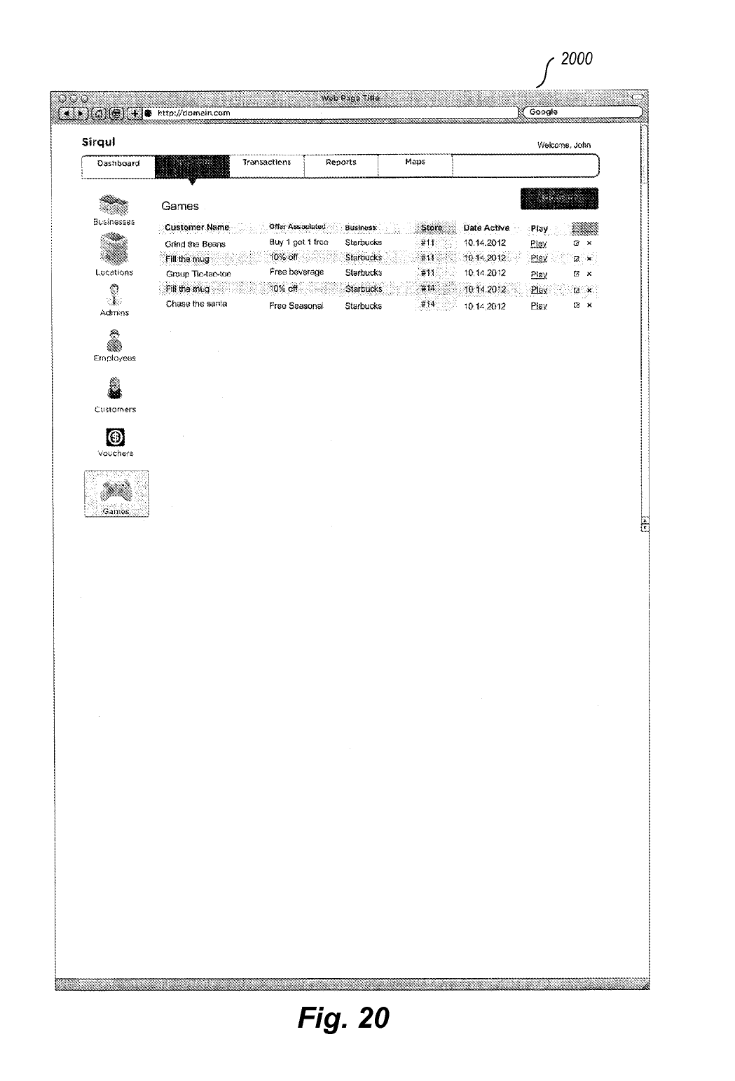

FIGS. 20-26 correspond to selection of the Games side tab 705 by the vendor, and enable the vendor to review and specify various information about game-related activity within the LTG server system that corresponds to the vendor (e.g., games specified by the vendor to enable promotional opportunities of the vendor to be provided to users as prizes for game play).

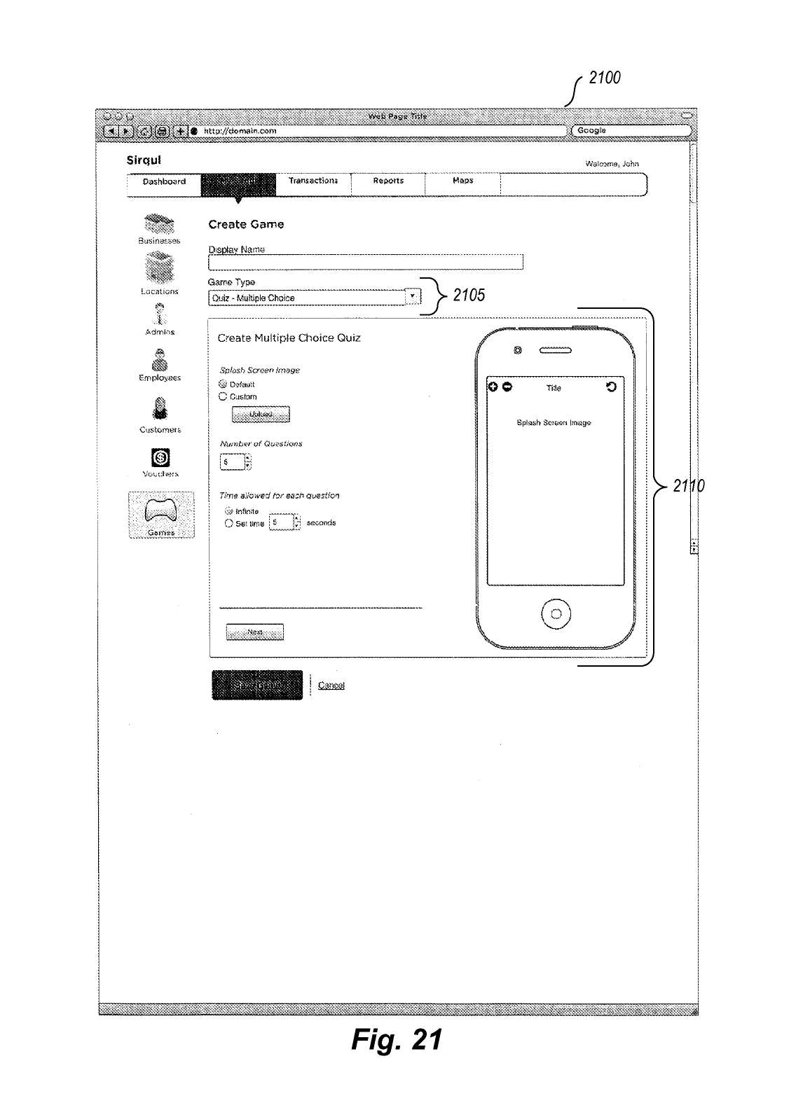

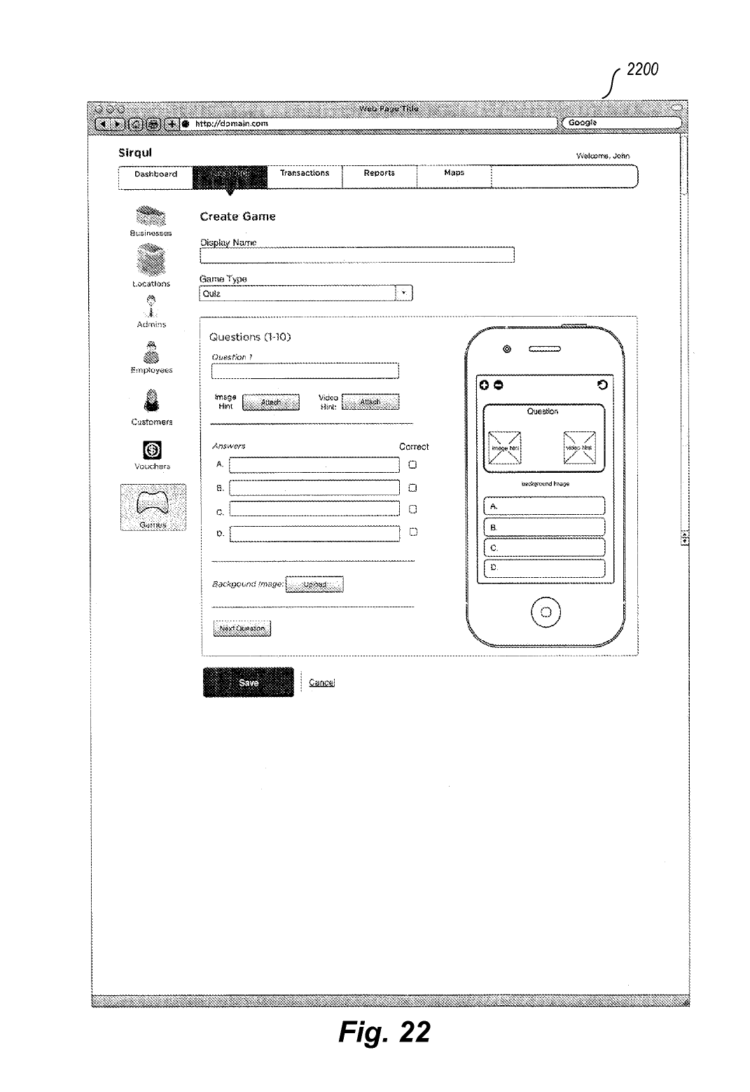

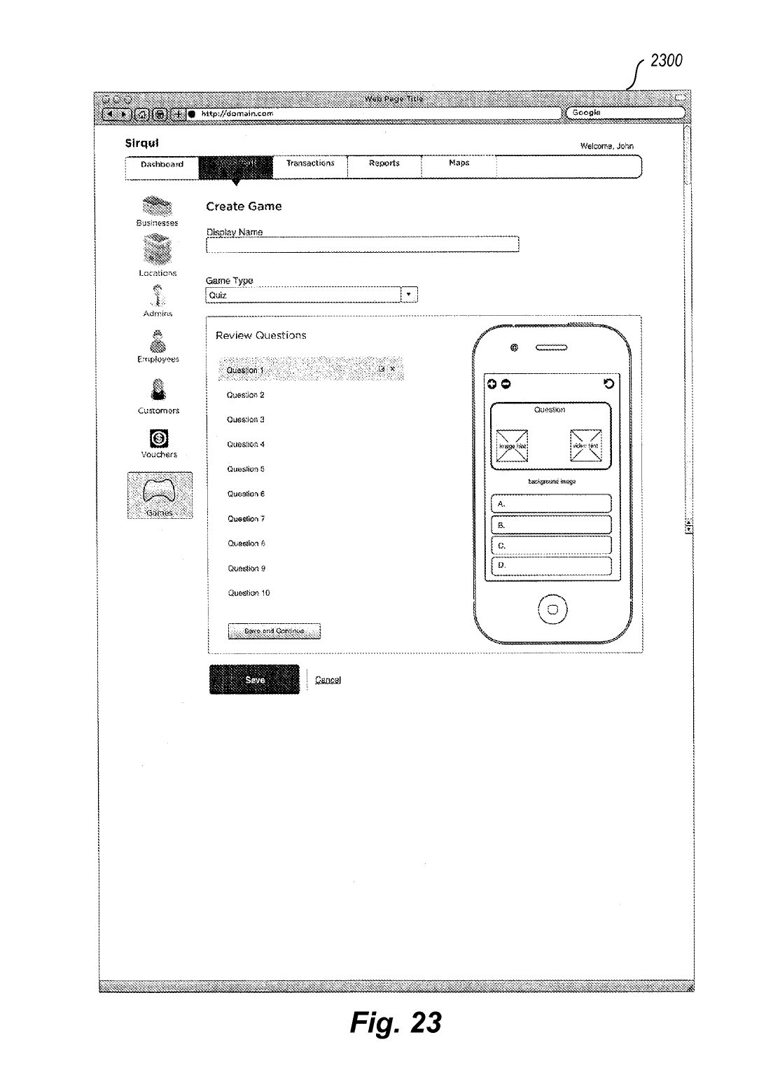

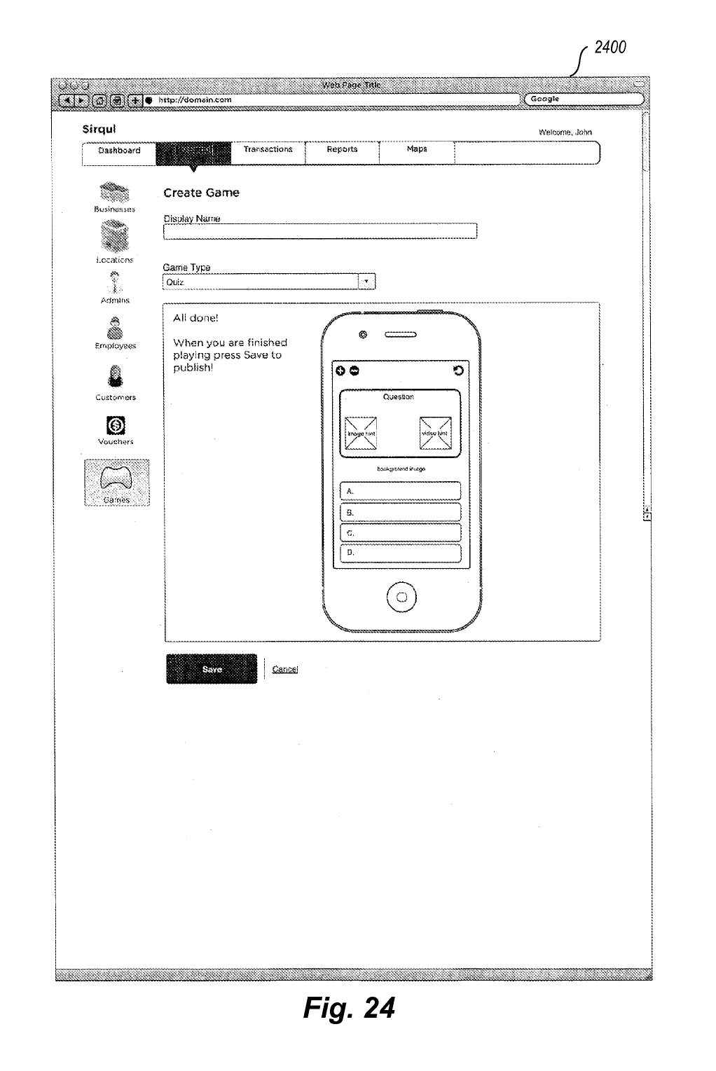

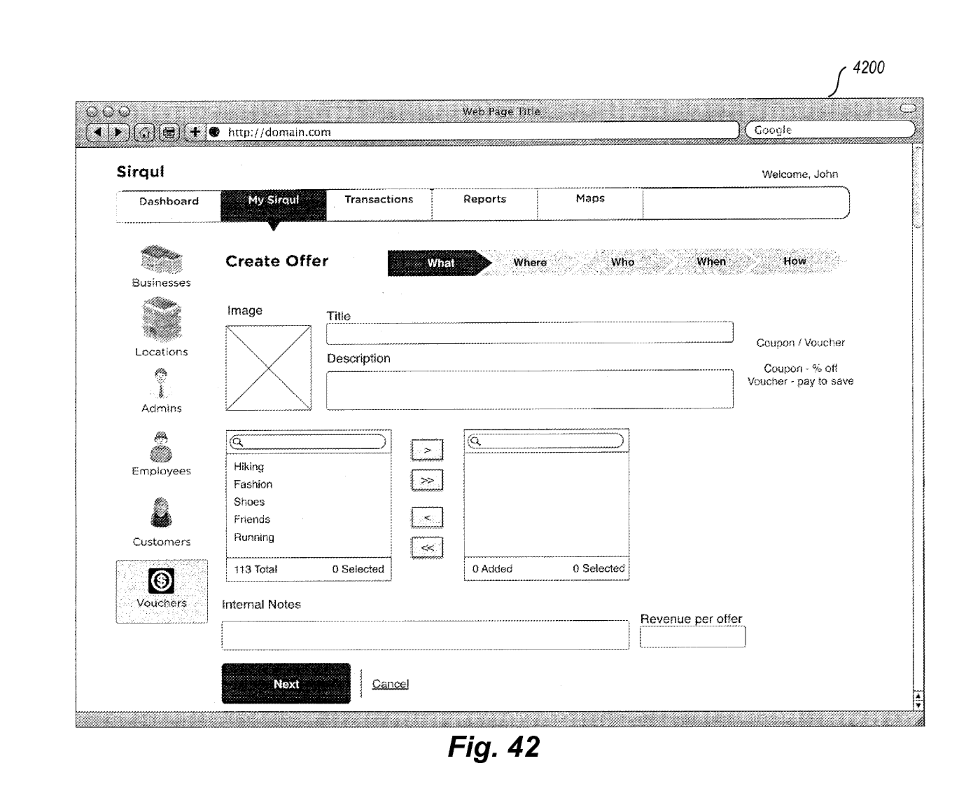

In particular, the illustrated example user interface screen 2000 of FIG. 20 includes a list of games specified for use by the vendor, and includes user-selectable controls to enable the vendor to add or modify game-related information. FIG. 21 includes an example user interface screen 2100 that corresponds to vendor selection of a control to create a new game within the LTG server system that corresponds to the vendor, and in this example includes information 2105 that includes a user-selectable dropdown list of types of games that may be configured by the vendor, as well as information 2110 via which the vendor may configure a selected type of game. In this example, the vendor has selected a quiz-type game via control 2105, and has specified various types of information about how the quiz is to be performed as part of information 2110. It will be appreciated that a quiz-type game may be configured to be played in a manner competitively to other users, such as by comparison of user scores, or in a manner that is non-competitive to other users (but optionally still trying to achieve a prize by, for example, reaching a minimum score). FIG. 22 includes an example user interface screen 2200 that continues the game creation activity of the vendor, and in particular enables the vendor to specify particular questions to be included as part of the quiz-type game being created, as well as to specify other game-related information. FIG. 23 includes an example user interface screen 2300 that continues the game creation activity of the vendor, and in particular enables the vendor to review information about the configured game before continuing. FIG. 24 illustrates an example user interface screen 2400 via which the vendor may finalize the creation of the game. While not illustrated here, the activities in creating the game or later enabling the game may include specifying various criteria about when the game will be available to users and under what conditions the game will be available (e.g., to particular users, in particular geographic areas, at particular times, etc.), such as in a manner analogous to specifying corresponding information for an offer being created in FIGS. 42-46.

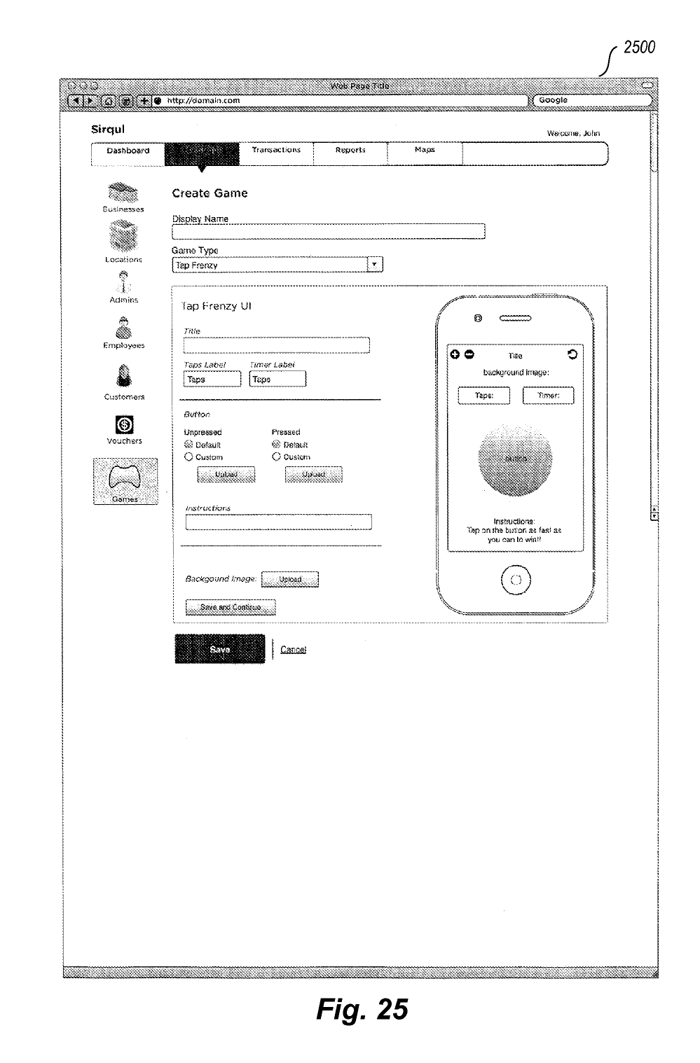

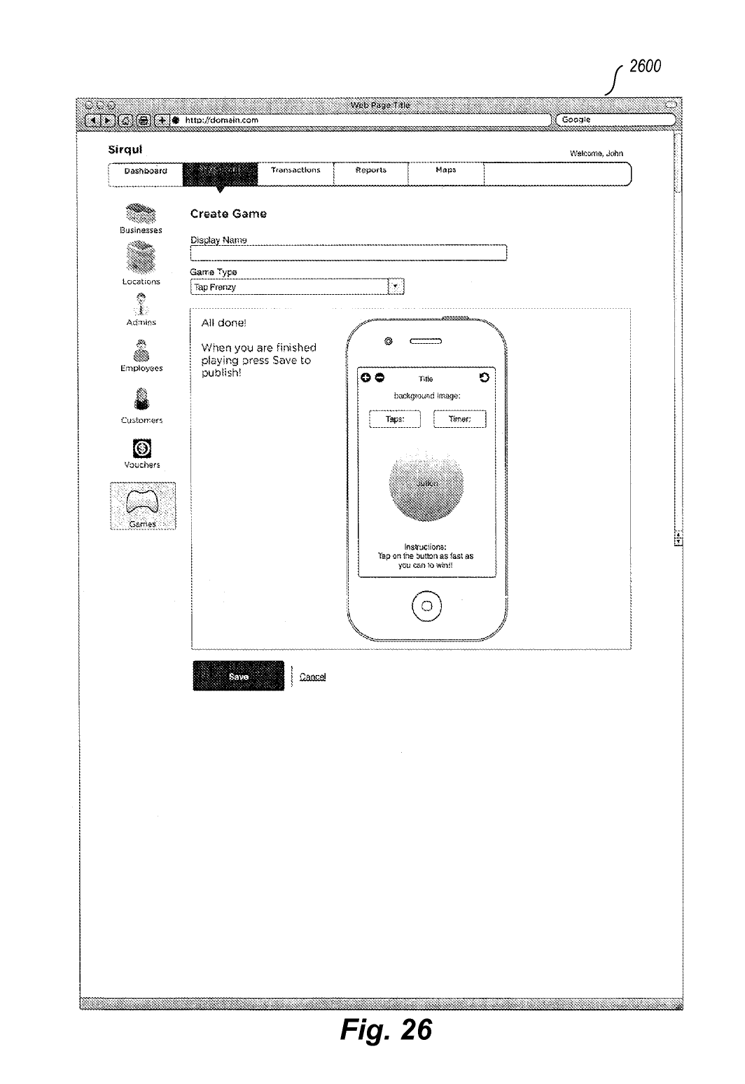

FIGS. 25 and 26 illustrate example user interface screens corresponding to creation of an alternative game by the vendor. In particular, the example user interface screen 2500 of FIG. 25 includes selection by the vendor of a type of game referred to as “Tap Frenzy,” which includes multiple users competing against each other to interact with their mobile devices by performing as many taps as possible within a specified period of time. The user interface screen 2500 further includes information to enable the vendor to configure the game being created, and example user interface screen 2600 of FIG. 26 provides a confirmation screen that allows the vendor to finalize creation of the game. While two example types of games have been illustrated here with respect to FIGS. 20-26, it will be appreciated that a wide variety of types of games may be available and used in various embodiments, with at least some embodiments including games that can be played quickly and optionally in competition with other customer users. In some embodiments, a predefined set of game types may be provided by the operator of the LTG server system and used by various vendors (and possibly other entities using the LTG server system), while in other embodiments, vendors or other entities may be able to further create new game types with the LTG server system (e.g., for their own use; for use by others, optionally in exchange for fees paid to the game creator; etc.), such as by developing and uploading software that supports a defined API (“application programming interface”) specified by the LTG server system.

The use of the illustrated types of game-related functionality within the LTG server system provides a variety of types of benefits to vendors and to end users. For example, a variety of vendors may be able to create a variety of games of one or more types within the LTG server system (and a single vendor may be able to create multiple games, such as different games for different business locations), and those games may be made available to end users of the LTG server system without those end users having to download different game applications for each vendor—such functionality may be provided by, for example, each end user executing a single client-side application for the LTG server system on a computing device of the end user that receives the various configuration information for the defined games and that presents particular games as selected by the end users and/or as determined by vendors or the LTG server system. In addition, in some embodiments and situations, a game or other activity specified by a vendor may be specific to the vendor in one or more manners (e.g., a quiz that is configured to ask questions related to the vendor, such as to identify names of redeemer employees of the vendor at one or more business locations; an end user task that involves visiting specified business locations of the vendor and optionally performing other related activities, such as to visit at least 5 of the vendor's business locations in this geographic area within a month and to optionally engage in a purchase transaction at each; etc). Moreover, a game or other activity specified by a vendor (or by the LTG server system) for end users may involve the end users supplying questions to later use as part of a quiz game, or specifying other information of a specified type (e.g., configuring a new game level for an existing game) to later use as part of games—such functionality enables end users to contribute to content with the LTG server system in a crowdsourcing manner.

In addition, the availability of offers and corresponding games may be triggered based at least in part on location of an end user, such that an end user that enters a new geographical location (e.g., goes on vacation or a business trip to a new city in a different part of the country) may automatically receive offers and the ability to play corresponding games that are specific to that location (as configured by vendors in that location, as defined by an operator of the LTG server system, etc.). Furthermore, in some embodiments and situations, the vendor configuration for a game may allow the vendor to require or allow end users that play the game to enable the game (as implemented by the LTG server system) to have access to one or more social networking site accounts of the end user, such as to enable updates to automatically be made to those account(s) by the LTG server system on the end user's behalf related to the end user's activities for the game (e.g., that the end user just beat one or more other non-identified users at the game, that the end user just beat one or more other users at the game who are identified by name or other social network account identifier for those other users, that the end user challenges one or more friends of the end user to a competition within the game, etc.).

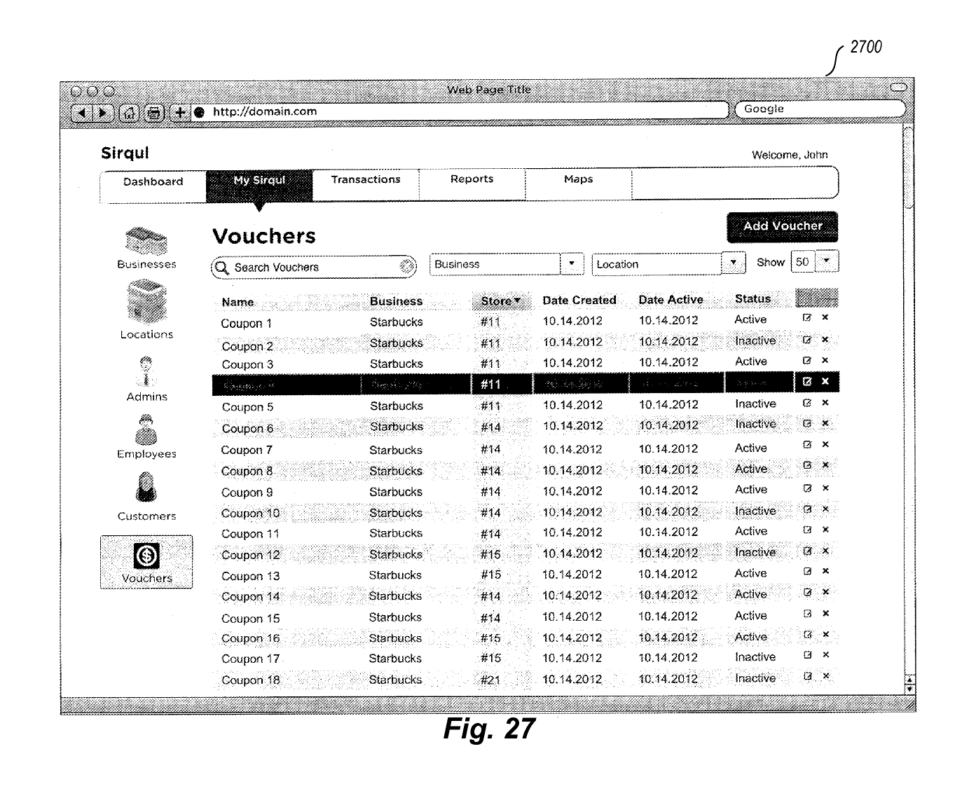

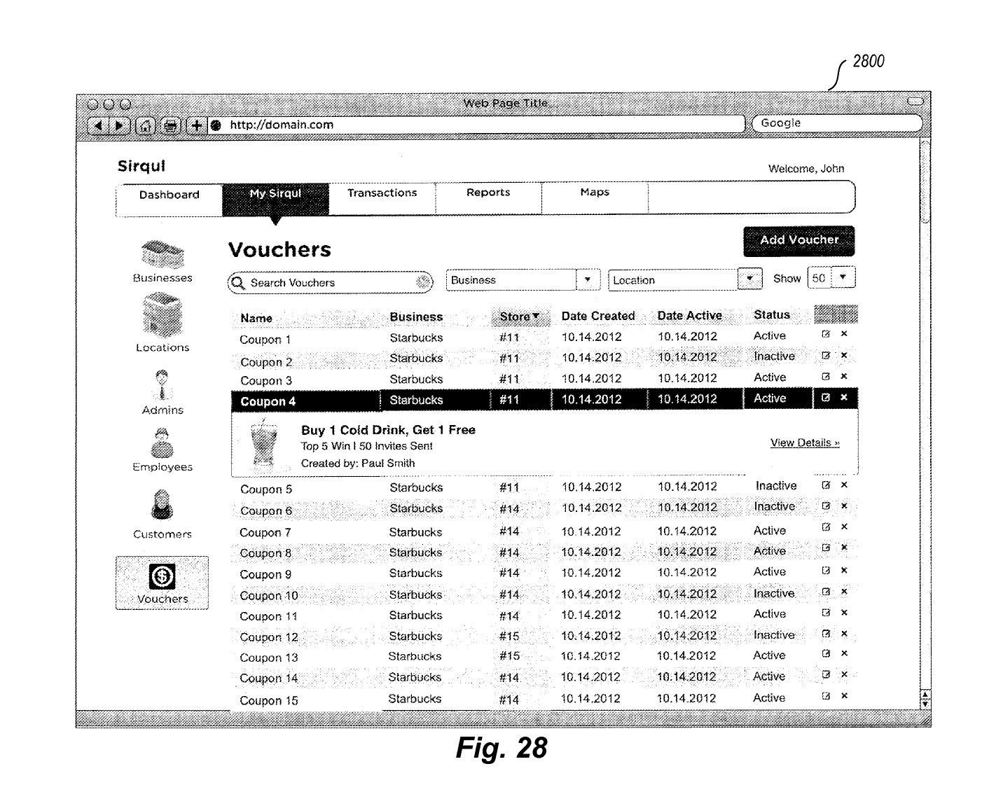

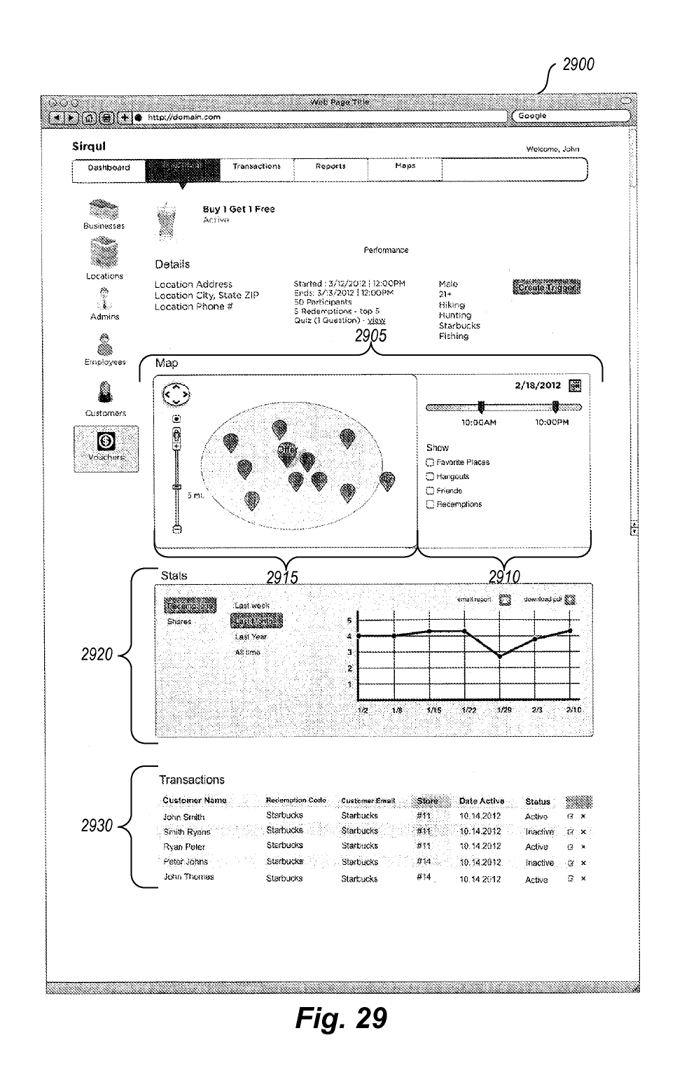

FIGS. 27-29 correspond to vendor selection of the Vouchers side tab 705, and enable the vendor to review and specify various information about vouchers within the LTG server system corresponding to the vendor. In some embodiments, the vendor may have separate side tabs or other functionality to access information about voucher offers separately from other types of offers, while in other embodiments, all types of offers may be grouped together under a single tab or other selection. In this example, the example user interface screen 2700 of FIG. 27 includes a list of offers for the vendor, and includes user-selectable controls to enable the vendor to add and modify offer-related information. The example user interface screen 2800 of FIG. 28 corresponds to selection of a particular offer by the vendor, with additional details about that offer being illustrated. FIG. 29 includes an example user interface screen 2900 that provides further detailed information about the selected offer. In particular, the example user interface screen 2900 includes map-related information 2905, 2910, and 2915 that is similar to that of corresponding map-related information 1905, 1910, and 1915 of FIG. 19, such as to enable the vendor to receive similar types of information as described with respect to FIG. 19 for end users that have received and/or redeemed the current offer. In addition, the example user interface screen 2900 includes information 2920 that provides information about results of the offer, and information 2930 corresponding to transactions involving the offer. As previously noted elsewhere, in some embodiments and situations, some types of information within the LTG server system may be available in one or more restricted types of manners to one or more types of entities, including information similar to that displayed with respect to FIG. 29.

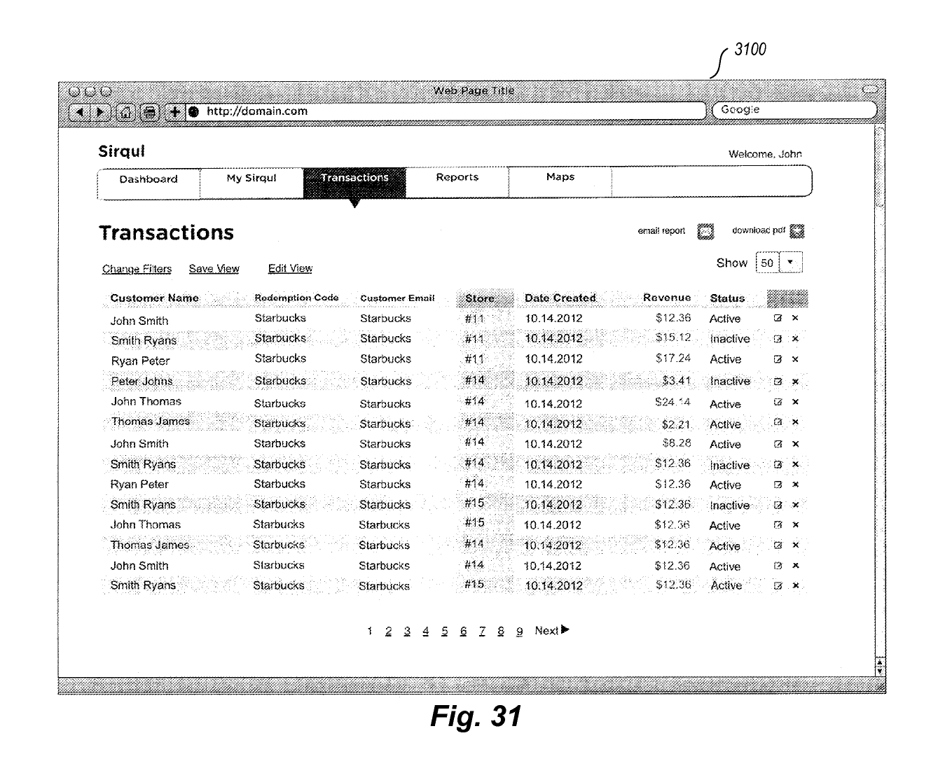

FIGS. 30 and 31 correspond to vendor selection of the “Transactions” tab 605. In particular, FIG. 30 illustrates an example user interface screen 3000 that provides information about various transactions that have occurred for the vendor, including various user-selectable controls to enable the vendor to specify filter criteria to identify the transactions of interest. FIG. 31 illustrates an example user interface screen 3100 that includes a list of transactions for the vendor, such as in accordance with vendor-specified filter criteria (not shown) from FIG. 30. As with other illustrated user interface screens, various user-selectable controls are available to enable the vendor to review and modify the view of transaction-related information.

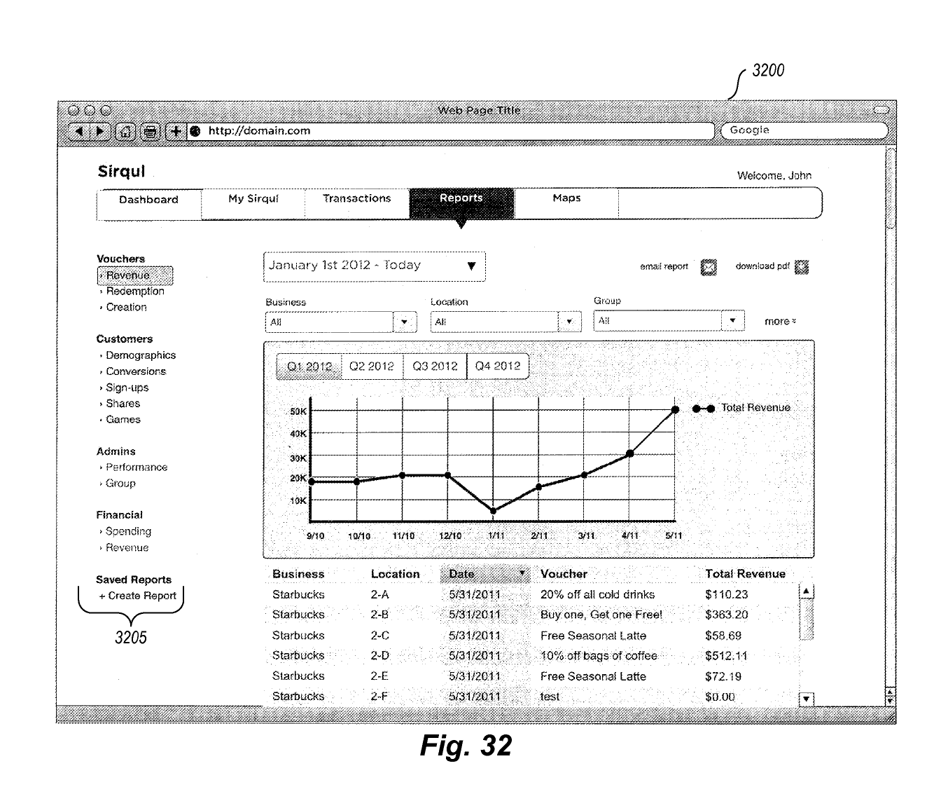

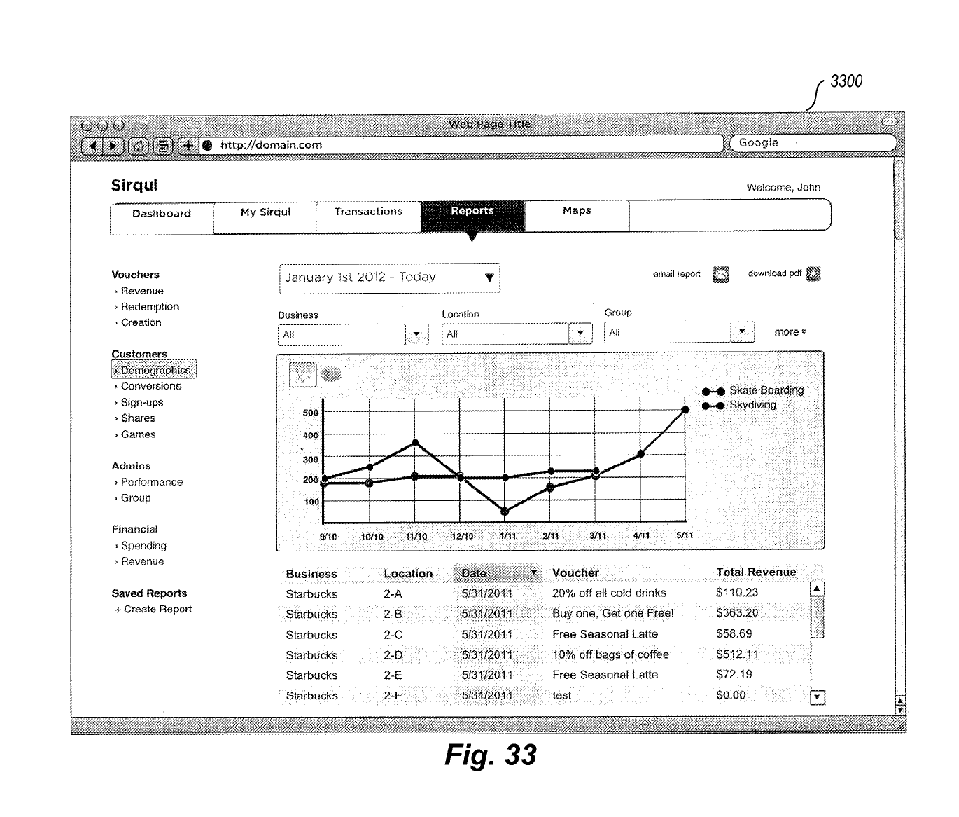

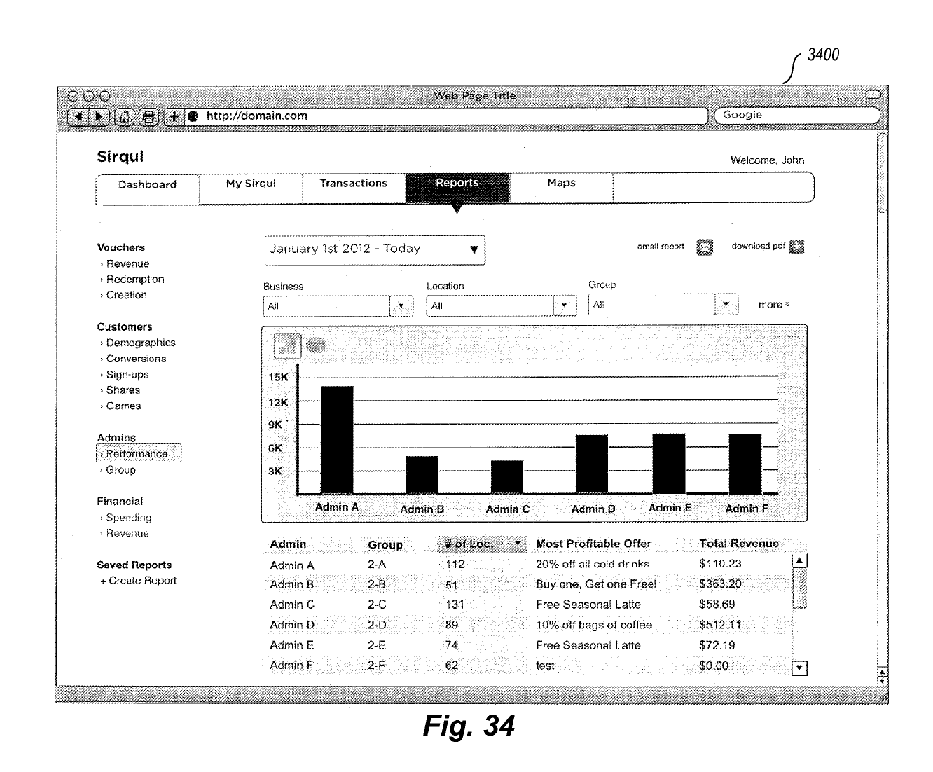

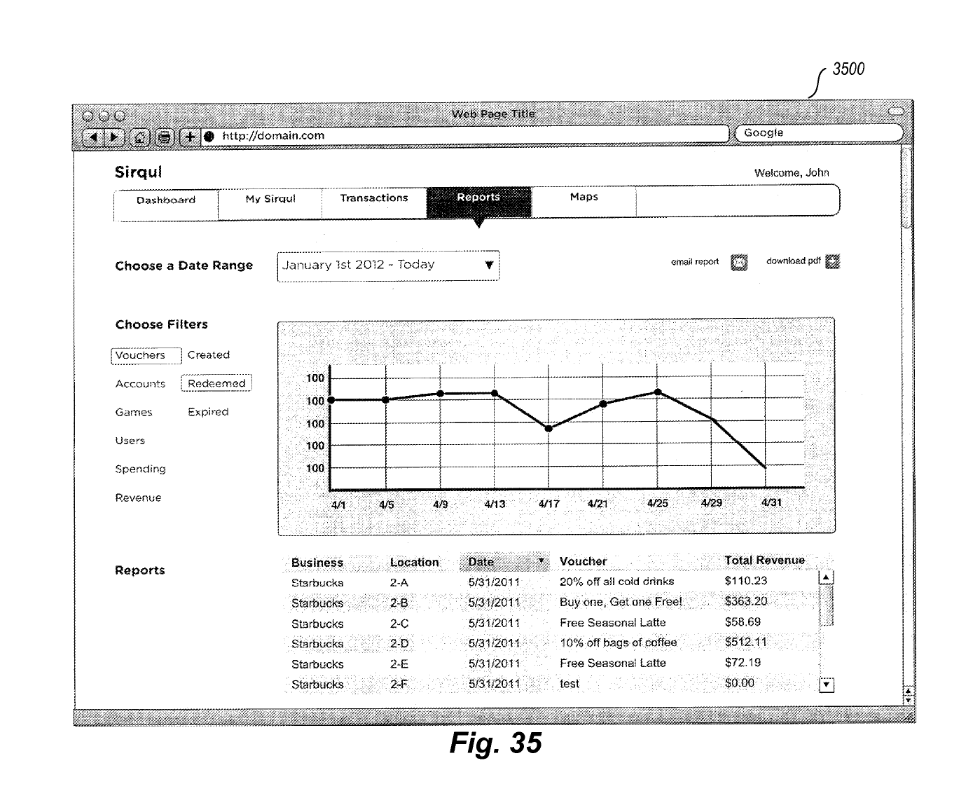

FIGS. 32-35 illustrate examples of information that corresponds to vendor selection of the “Reports” tab 605. In particular, FIG. 32 illustrates an example user interface screen 3200 that displays a graphical set of information and a tabular list of information corresponding to vendor-specified filter criteria using user-selectable controls of the user interface screen. Various types of functionality may be available to enable the vendor to create and save a particular type of report of interest, to specify defaults and other vendor preferences, to drill down to particular information of interest, etc. In the illustrated example of FIG. 32, the report information corresponds to revenue information, as selected via a “Revenue” side tab 3205. Conversely, FIG. 33 illustrates an example user interface screen 3300 that includes similar report-related information, but with the information being displayed to reflect demographics of customer users that engage in the transactions, as selected by the vendor via a corresponding “Demographics” side tab 3205. FIG. 34 illustrates an example user interface screen 3400 that continues the example and includes similar report-related information, but with the information being displayed corresponding to the performance of particular administrative users, as selected by the vendor via the corresponding “Performance” side tab 3205. FIG. 35 illustrates an example user interface screen 3500 via which the vendor may specify additional filters using displayed user-selectable controls to affect the information being displayed.

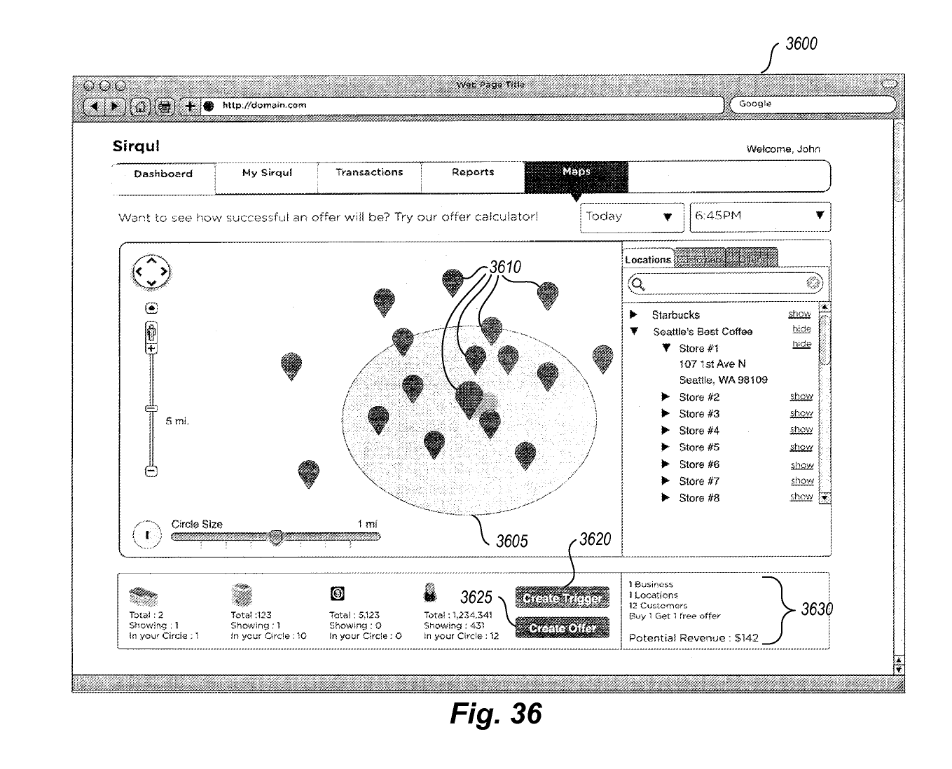

FIGS. 36-41 illustrate examples of functionality provided by the LTG server system corresponding to vendor selection of the “Maps” tab 605. In the illustrated example, this tab provides a map-based interface to enable a vendor to specify information about a possible candidate offer of interest, to interactively determine quantities of end users that may match particular vendor-specified filter attributes, to estimate the value of current and/or future revenue to the vendor from putting a candidate offer into use within the LTG server system, etc.

Such functionality provides a variety of benefits to the vendor, including to enable the vendor to focus on their monetary return from a candidate offer rather than on merely their advertising cost for creating and disseminating the offer. Furthermore, when using functionality of the LTG server system to estimate the value of current and/or future revenue to the vendor from putting a candidate offer into use, the LTG server system may in some embodiments employ a variety of types of user-specific information as part of calculating a revenue projection—such types of user-specific information may include, for example, a past history of actions of a particular end user (e.g., information about a historical offer usage rate of the end user, optionally tailored to particular factors such as location and/or time and/or offer type, such as to determine the likelihood that the end user will accept and/or redeem the candidate offer if made available to him/her; information about historical activities and proclivities of the end user to being a repeat customer to a business location to which the end user has accepted an offer, optionally tailored to particular factors such as location and/or time and/or offer type, such as to determine the likely future revenue stream or value of repeat business from the end user if the candidate offer is made available to him/her; etc.), a status of a particular end user as a new user to the LTG server system, etc.

In particular, FIG. 36 illustrates an example user interface screen 3600 via which a map-related interface is provided to the vendor to enable the vendor to specify example information corresponding to a candidate offer that the vendor may decide to include within the LTG server system, and with corresponding information being calculated by the LTG server system related to potential benefits to the vendor of including that offer within the LTG server system. In particular, in this example the vendor may specify via the map a geographic area 3605 to which the candidate offer will apply, and optionally other information (not shown) related to other criteria and conditions under which the candidate offer would be made available. The LTG server system illustrates examples of various potential customer users 3610 that may be within the specified geographic area 3605 of the candidate offer, and that optionally may further satisfy any other specified criteria or conditions for the candidate offer. The customer end user information may be gathered and displayed in various manners, such as corresponding to a current time, an average or aggregate over a prior period of time, a prediction of future activity (e.g., based on tracking patterns and activities of particular customer users), etc. The example user interface 3600 further includes various user-selectable controls, including a control 3625 to enable creation of the candidate offer within the LTG server system. The illustrated information further includes information 3630 related to potential results and benefits from creation of the candidate offer, including an estimate of potential revenue to the vendor from the candidate offer based on the estimate of a number of customer users to whom the offer will be provided and redeemed, information about a value to the vendor for each redeemed offer, etc.

Furthermore, in some embodiments, the vendor may further be provided functionality to request notification if a specified set of conditions become true at a future time and/or are projected at a first future time to become true at a second future time, such as via a trigger control 3620. When the vendor receives such a notification, the vendor is able to dynamically create one or more offers at that time, such as to target a group of users that correspond to criteria for the defined trigger. Alternatively, the vendor may specify conditions and criteria under which offer notifications are to be automatically sent to matching users, if those conditions and criteria are satisfied in the future. While various types of conditions and related criteria are displayed in greater detail with respect to other user interface screens, including for candidate offers, such conditions and criteria may similarly be specified for such notification triggers. For example, notification triggers may be based on a quantity of users (e.g., a specified minimum quantity of customer users if they are within the geographic area 3605 at the same time, or over a period of time of a specified length), an amount of potential revenue for the vendor from an offer may under the specified conditions (e.g., a minimum revenue threshold), current inventory levels of the vendor, etc.

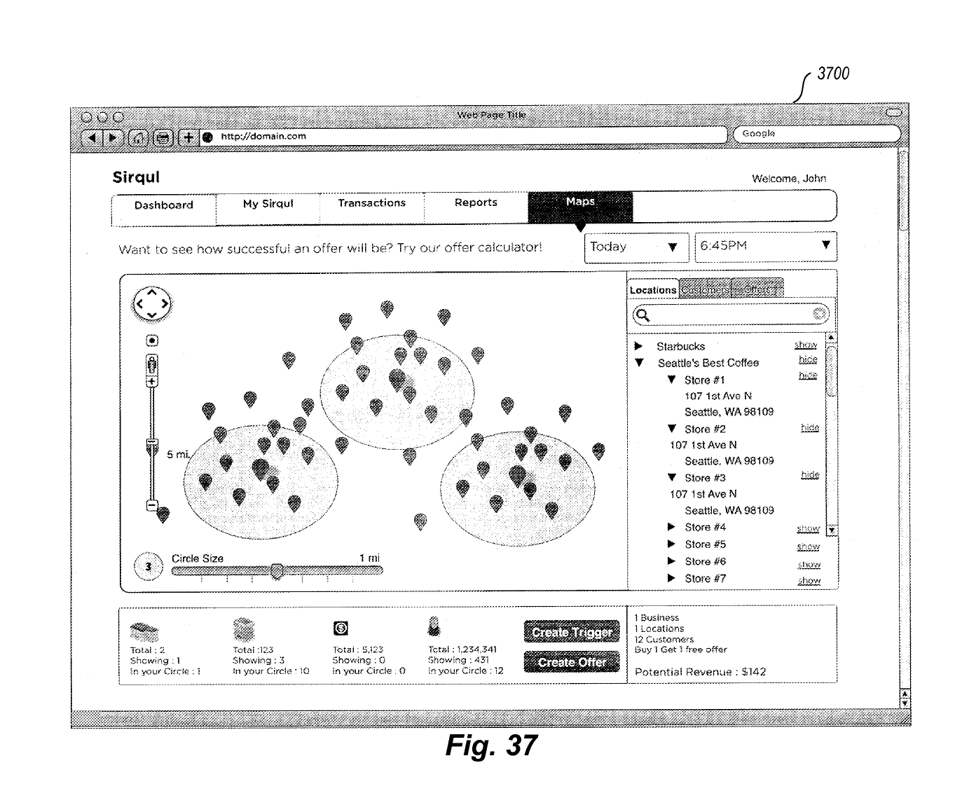

FIG. 37 illustrates an example user interface screen 3700 that is similar to that of FIG. 36, but in which the candidate offer being specified by the vendor includes multiple non-contiguous geographic areas (e.g., corresponding to the locations of multiple distinct business locations for the vendor, such as based on selection of a “Location” sub-tab). FIG. 38 illustrates an example user interface screen 3800 that includes information corresponding to candidate customer end users for the candidate offer, based on vendor selection of a corresponding sub-tab 3805. In this example, the information includes types of customer users to which the candidate offer would apply, such as to reflect mandatory filtering criteria that controls which end users are included in a corresponding matching user group for the candidate offer (or which matching end users are triggered to be notified), although in other embodiments the user-related criteria may be used in other manners. Thus, with respect to such functionality, the vendor can identify particular customer users who are within a specified geographic area at a current and/or future time, with those customer users having particular specified attributes used as filtering criteria—for example, in the current user interface screen, the information about users 3610 in the map area may be dynamically updated, as attribute filters are specified, to correspond to current end users of the LTG server system that match those specified attribute filters. When information is displayed about current matching users that is of sufficient interest to the vendor (e.g., that provides a desired amount of potential revenue), the vendor may opt to dynamically create an offer and provide it to those users, if so desired.

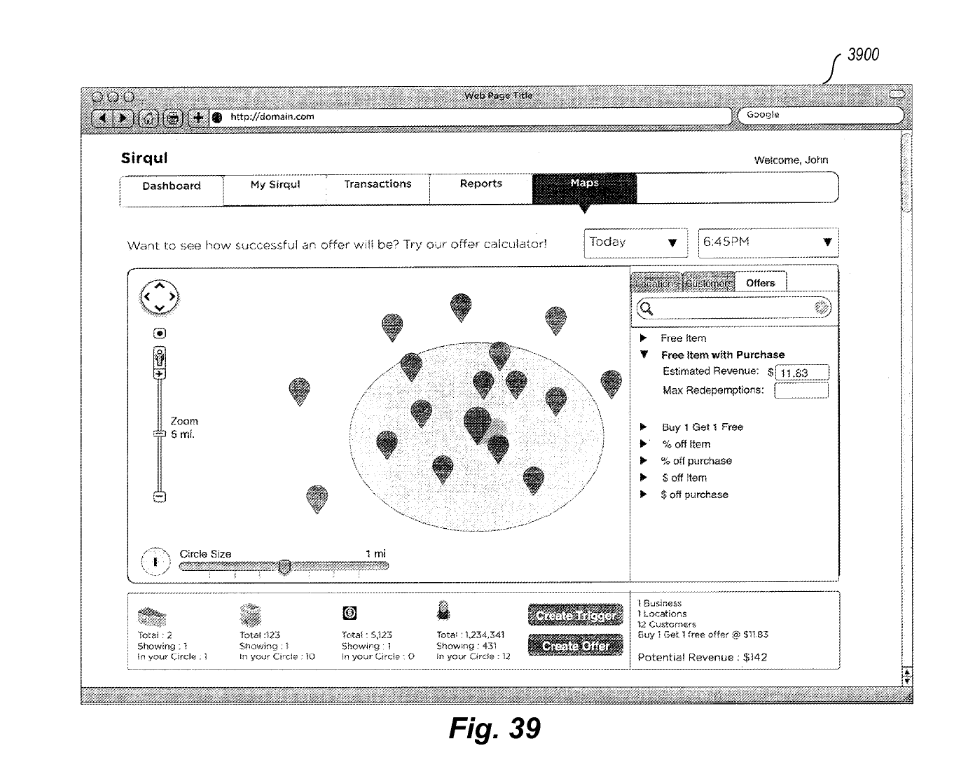

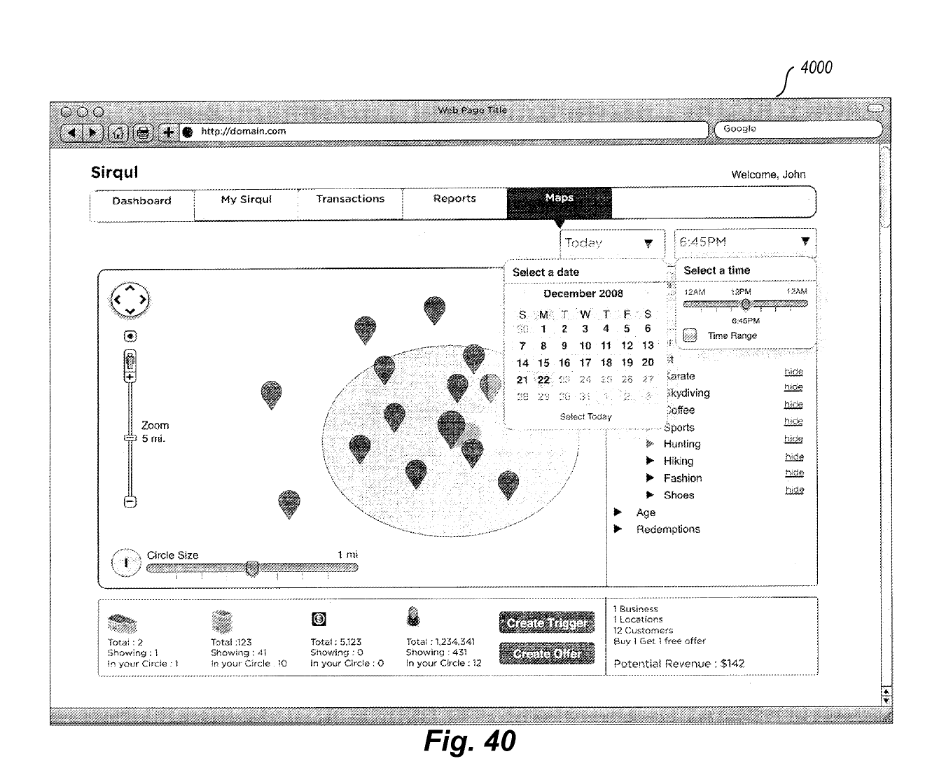

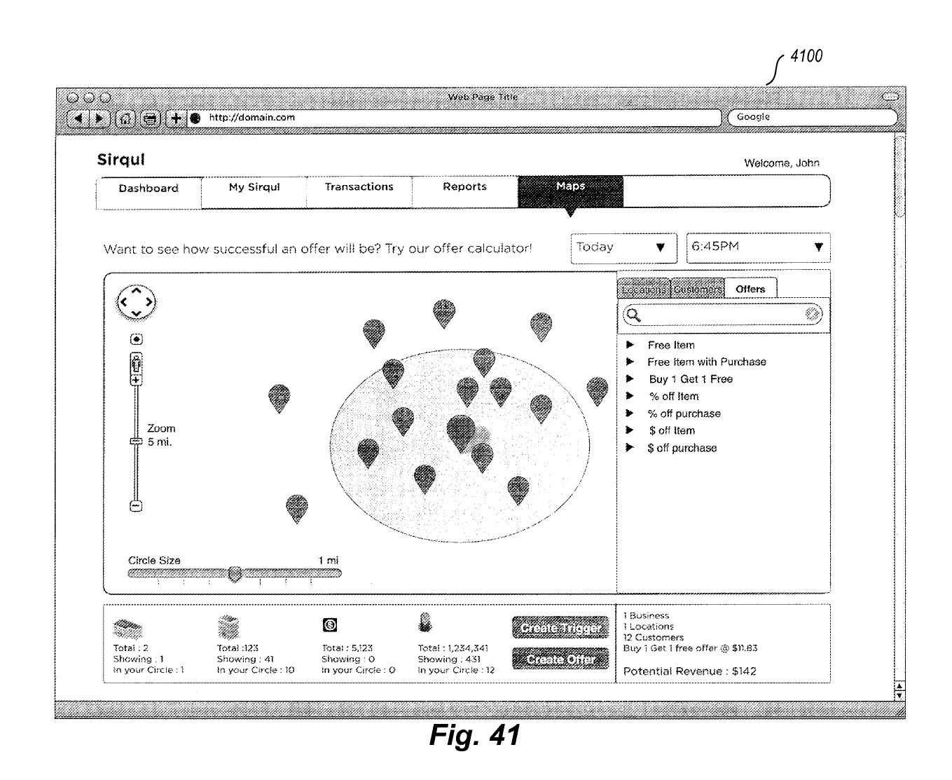

FIG. 39 illustrates an example user interface screen 3900 that includes additional information corresponding to the particular candidate offer, based on vendor selection of a corresponding “Offers” sub-tab. In particular, the illustrated information enables the vendor to specify details about the candidate offer, including an estimated revenue per offer redemption that is used as part of the determination of potential revenue for the vendor that would result from the candidate offer. FIG. 40 illustrates an example user interface screen 4000 via which the vendor may specify additional date-related and time-related information for the candidate offer, such as to specify the times at which the candidate offer will be available. FIG. 41 illustrates an example user interface screen 4100 that includes information similar to that of FIG. 39, but with different types of offer-related criteria being displayed.

Thus, with respect to the functionality of FIGS. 36-41, the vendor specifies various criteria and conditions of interest, such as with respect to one or more advertising campaigns of interest, and optionally creates offers and/or specifies notification triggers based on those specified criteria and conditions. In other embodiments, the LTG server system may perform at least some similar types of functionality automatically for at least some vendors, such as based on information specific to such a vendor. As one example, the LTG server system may use criteria and conditions that a vendor has previously specified and used, and automatically monitor to identify current end user conditions and/or expected future end user conditions that are similar to or match those previously specified criteria and conditions—if such current end user conditions and/or expected future end user conditions are identified, the LTG server system may, for example, automatically notify the vendor of those identified conditions (e.g., to enable the vendor to create or activate one or more corresponding offers), and/or may in some situations (e.g., based on prior configuration by the vendor) automatically create or activate one or more corresponding offers for the vendor. More generally, the LTG server system may monitor end user activity corresponding to business locations of a vendor, and similarly perform automated actions (e.g., to notify the vendor and/or automatically create one or more offers for the vendor) if patterns of possible interest are identified—for example, a specified quantity of end users may be identified that match a previously defined user group of the vendor or that otherwise share one or more attributes related to attributes of the vendor's business location(s), and that are currently near a business location of the vendor and/or repeatedly pass by the business location of the vendor. In this manner, the LTG server system may automatically perform various actions to assist vendors in creating and maintaining advertising campaigns to target customer end users that are of interest to or otherwise relevant to the vendor, including to identify lucrative situations of which the vendor would otherwise be unaware, based on leveraging a variety of types of historical and current information about end users and vendors.

FIGS. 42-47 illustrate examples of additional interactions by the vendor with the LTG server system to create a particular offer for the vendor, including to specify various conditions and criteria for the offer. While the information illustrated in these figures is shown for a particular offer, similar information may be specified for other situations as well (e.g., to define a notification trigger, to define a user group, etc.).

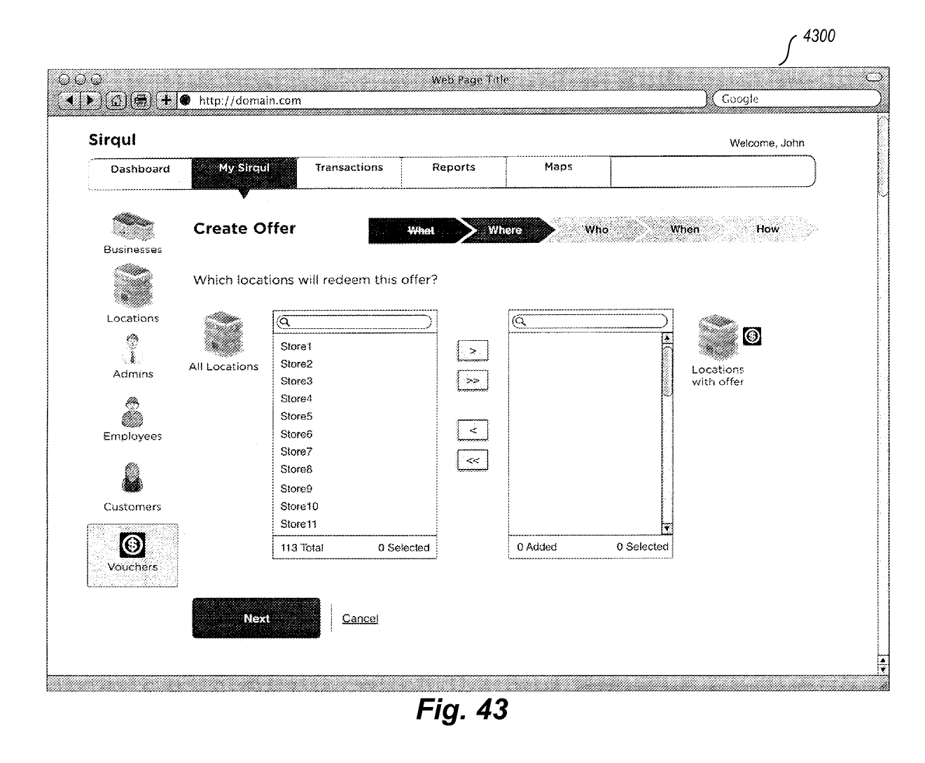

In particular, FIG. 42 illustrates an example user interface screen 4200 via which the vendor can specify “What” information for the offer being created, such as a title, description, image to be displayed to customer end users, category attributes for the offer (e.g., to enable users to search for offers of interest, to be used as criteria for which users the offer is made available to, etc.). FIG. 43 illustrates an example user interface screen 4300 that corresponds to the vendor specifying “Where” information for the offer, such as the one or more business locations with which the offer will be associated. FIG. 44 illustrates an example user interface screen 4400 that corresponds to the vendor specifying “Who” information for the offer, to enable the vendor to specify the criteria and conditions for which the offer will be made available to particular customer end users. The illustrated example user interface screen 4400 further includes map-related information about customers who currently match the specified criteria and conditions, including to enable the vendor to specify criteria related to the status of an end user as a customer of the vendor (e.g., a new customer; a repeat customer of one or more levels of types, such as based on a quantity and/or frequency of past visits, an average and/or cumulative amount spent by the customer with the vendor and/or earned by the vendor from the customer; a preferred customer, such as based on a loyalty program of the vendor, optionally with one or more tiers; etc.). As discussed elsewhere, such a user interface screen may in some embodiments allow the vendor to specify a predefined user group, and/or to create a new user group based on currently specified filter criteria, including to target new customers have specified attributes of interest.

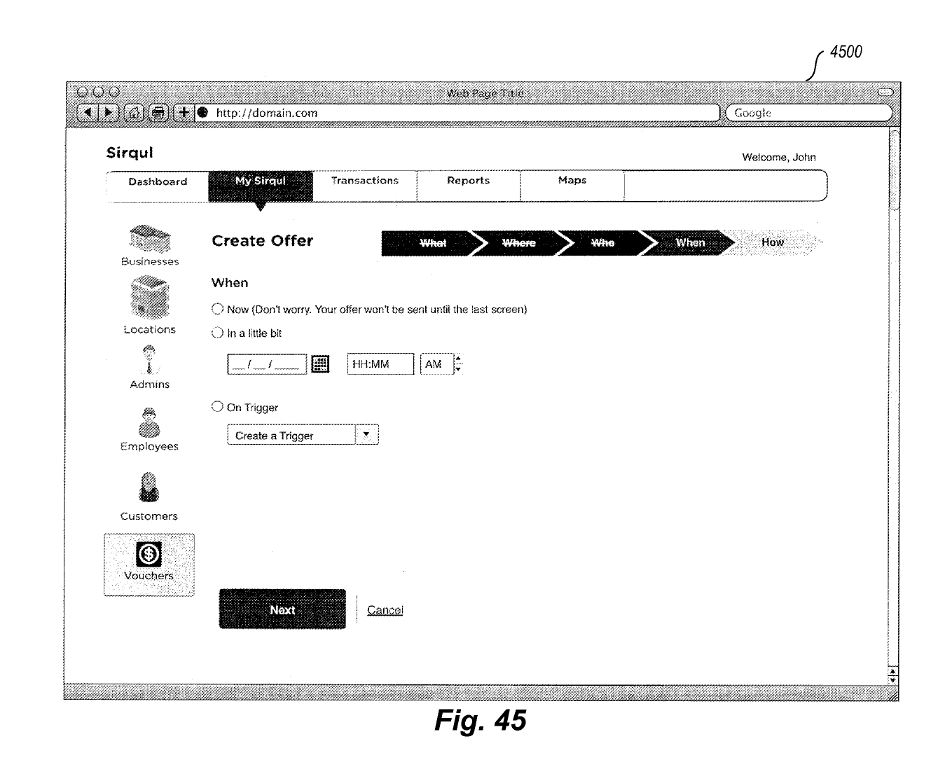

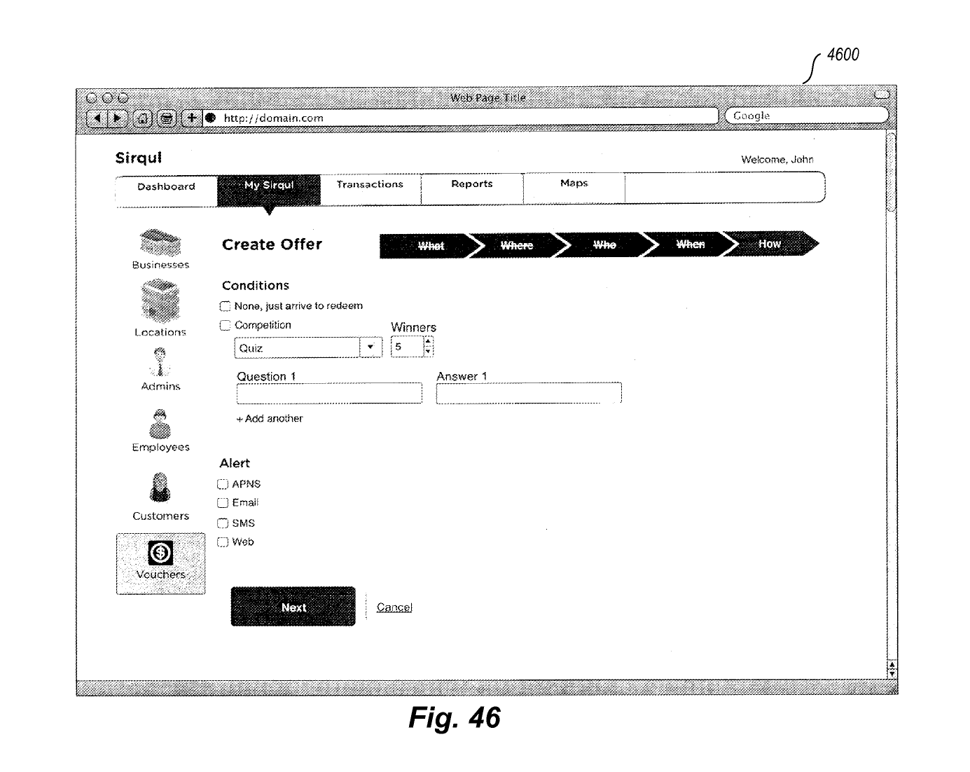

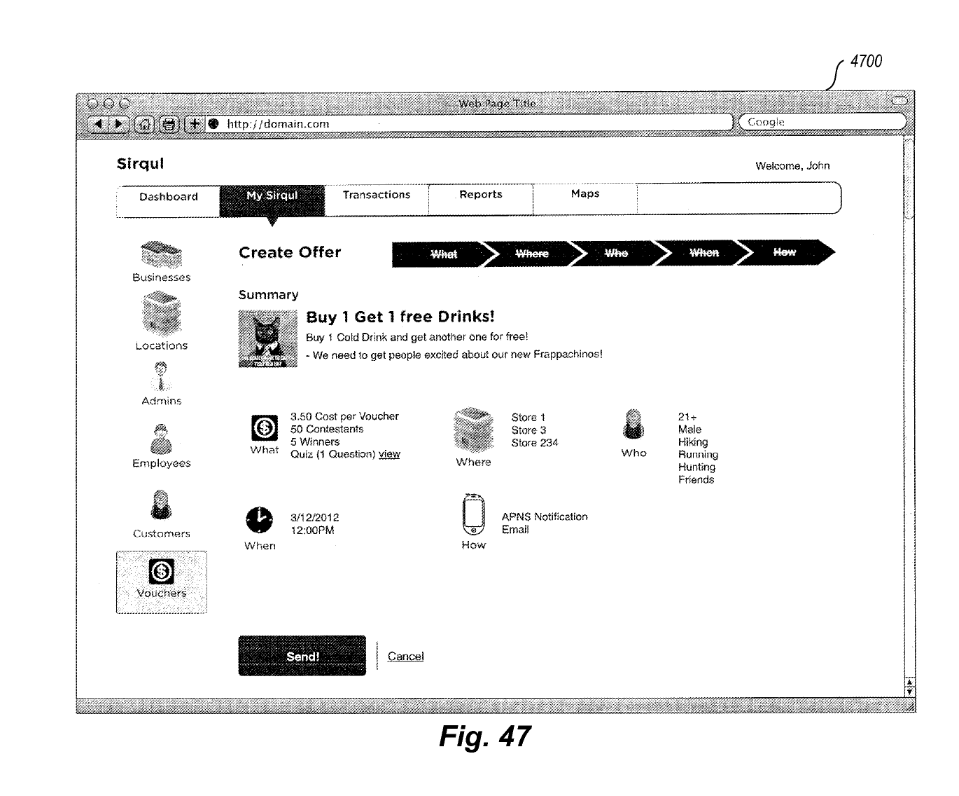

FIG. 45 illustrates an example user interface screen 4500 via which the vendor specifies “When” information for the offer being created, including whether the offer will be available immediately, at a specified future time, or upon satisfaction of specified trigger criteria. FIG. 46 illustrates an example user interface screen 4600 via which the vendor specifies “How” information for the offer being created, including a type of activity (if any) needed to receive the offer, such as no related activity, a non-competition game or other activity, a competitive game or other activity (in which multiple customer users compete against each other), etc. While not illustrated in FIG. 46, in other embodiments, this user interface screen may be modified or a similar user interface screen may be used to associate offers with other types of activities within the LTG server system, such as a defined event, a defined end user task (e.g., a mission or challenge), etc. FIG. 47 illustrates an example user interface screen 4700 that provides summary information for the vendor related to the offer that has been configured, and allows the vendor to finalize the offer within the LTG server system.

It will be appreciated that the details illustrated with respect to the user interface screens of FIGS. 6-47 are provided for illustrative purposes, and that some embodiments may include functionality and corresponding user interfaces that are not illustrated and/or may not include functionality and corresponding user interfaces that are illustrated. Accordingly, the inventive techniques described herein can be used in a wide variety of other situations.

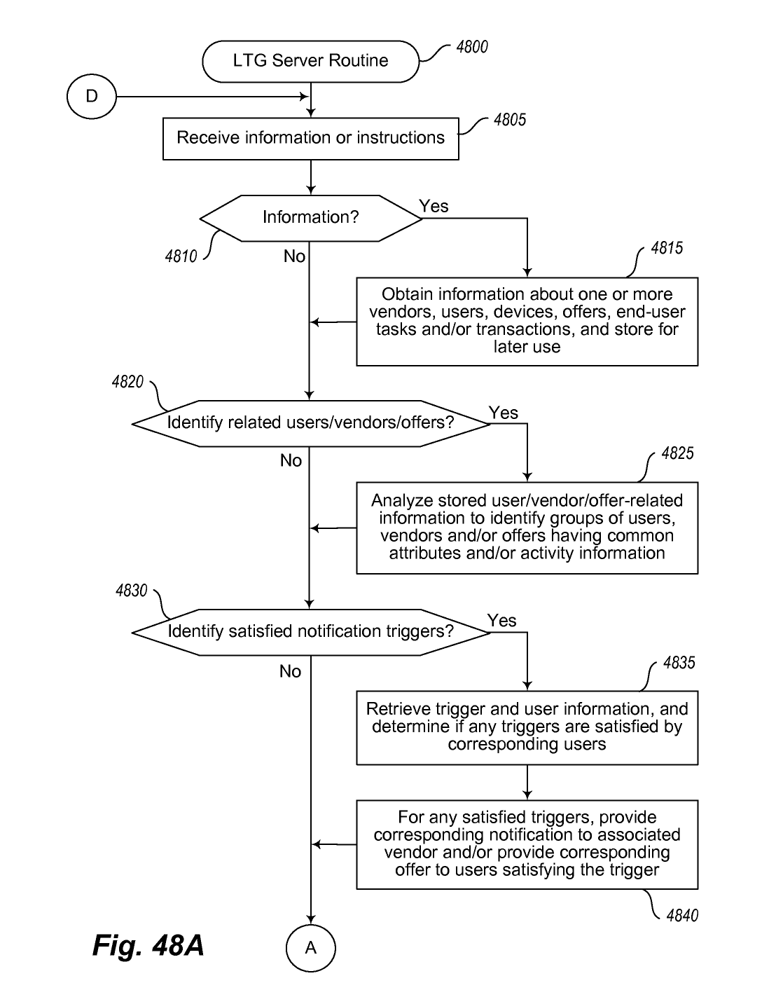

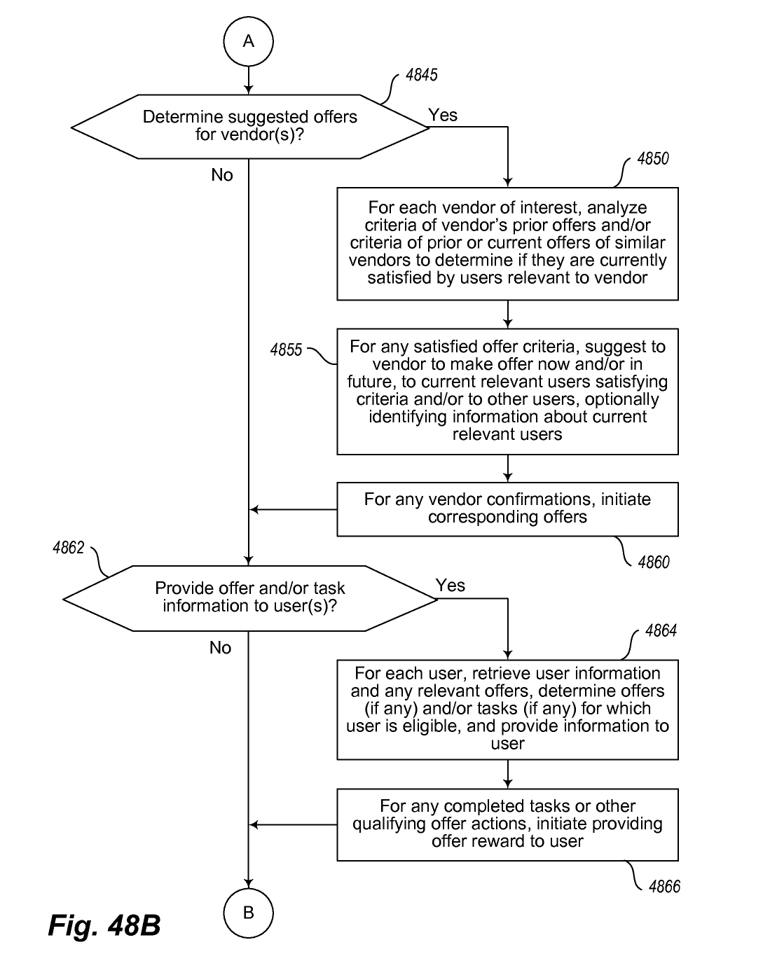

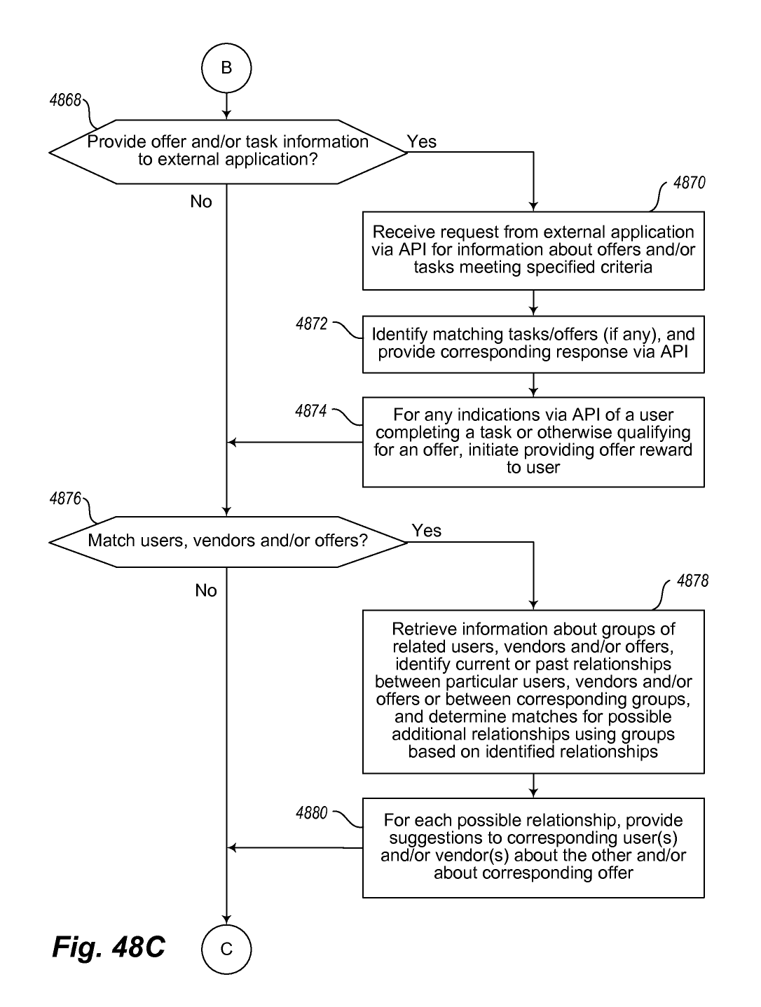

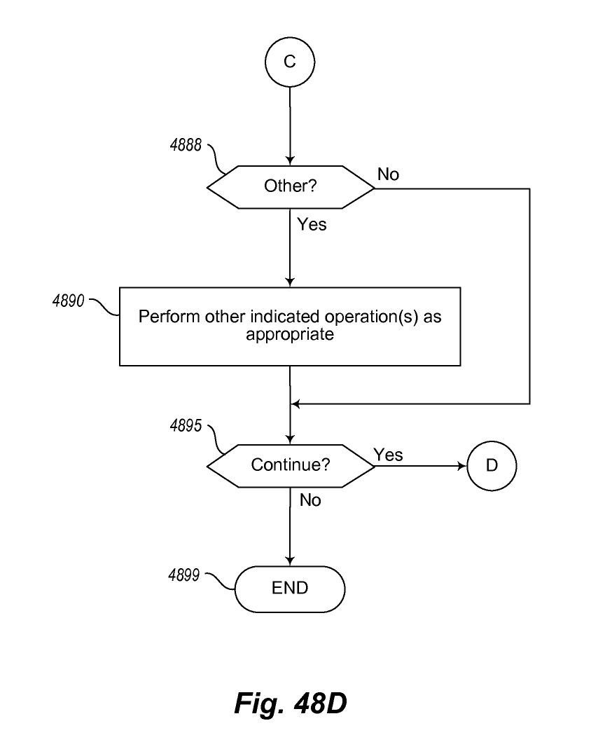

FIGS. 48A-48D are a flow diagram of an example embodiment of an LTG (“Location-based Task-Game”) Server routine 4800. The routine may be performed by, for example, the LTG Server system 240 of FIG. 2, the LTG Server systems 100 and/or 105 of FIG. 1, and/or the systems discussed with respect to some or all of FIGS. 3-47, such as to perform various activities related to providing promotional offers from vendors to users of mobile devices in accordance with information about the users and the mobile devices (e.g., information that includes location, about the users playing game tasks or otherwise performing other tasks associated with offers, etc.). The example embodiment of routine 4800 may, for example, be an alternative embodiment to that of routine 300 of FIG. 3, or instead routines 300 and 4800 may illustrate similar (and in some cases overlapping) functionality of a single embodiment of an LTG Server system.

The illustrated embodiment of the routine 4800 begins at block 4805, where information or instructions are received. It will be appreciated that such information or instructions, including to reflect a determination to perform a particular activity, may be received in various manners, such as based on periodic processing such as by the LTG Server system, based on a request from an end user, vendor user, and/or operator of the LTG Server system, based on other information received or other determinations made by the LTG Server system, etc. After block 4805, the routine continues to block 4810 to determine if information has been received that is based on actions of users or vendors or that is based on activities of the LTG Server system. If so, the routine continues to block 4815 to obtain corresponding information about one or more vendors, one or more users, one or more mobile devices, one or more offers, one or more end-user tasks, and/or one or more transactions that occur via the LTG Server system or otherwise involve the system, and store the information for later use. Transactions may be of various types, including the following: a transaction involving redemption of an offer by a user with a vendor; a transaction involving a user becoming qualified to receive one or more rewards associated with an offer, such as based on completing one or more associated tasks; a transaction involving a new offer being defined by a vendor within the LTG Server system or otherwise involving advertising specified by a vendor to be provided to one or more users, such as based on receipt of corresponding information in block 4805 from interactions of the vendor with the LTG Server system; etc. In other embodiments, other types of information may similarly be obtained and stored, and the types of information that are obtained and stored with respect to block 4815 may reflect various activities of vendors and/or users (e.g., including user movements to, from, and/or through particular geographical locations), occurrences of defined events, interactions of third-party applications with the LTG Server system (e.g., mobile applications developed by third-party entities that are distinct from an entity operating the LTG Server system, and that may optionally be affiliated with the LTG Server system and/or its providing entity in one or more manners, or instead may not be affiliated in any such manner), etc. The information obtained in block 4815 may be stored in various manners, including as discussed elsewhere herein, such as with respect to stored data 121-130 and database storage 260 illustrated in FIGS. 1 and 2.

After block 4815, or if it is instead determined in block 4810 that the information or instructions received in block 4805 do not include information to be stored, the routine continues to block 4820 to determine whether to currently identify any related users, related vendors, and/or related offers, including in some situations based on information just received with respect to block 4815, or instead in other embodiments based at least in part on information that was previously received and stored. If so, the routine continues to block 4825 to analyze stored information related to one or more users, vendors, and offers in order to identify groups of related users, related vendors, and/or related offers that have common attributes or otherwise have common associated information (e.g., with respect to activities performed by users or vendors). The determination of sufficient similarity between two or more users to be part of a related user group, between two or more vendors to be part of a related vendor group, and/or between two or more offers to be part of a related offer group may be performed in various manners in various embodiments. As one example, in some embodiments, an operator of an LTG Server system and/or one or more end users or vendor users of the system may specify one or more attributes to be used to identify such a related group, or otherwise define one or more criteria to be used in such identification.

In other embodiments, the LTG Server system may automatically identify some or all such related groups. As one example, for each of a plurality of defined attributes (e.g., any attribute, tag, or other information associated with any user, vendor, or offer in the LTG Server system), the system may create a hierarchy of related groups for each of users, vendors, and/or offers. In such a situation, for example, each attribute or other piece of information may initially be used as the basis for forming a related group, such as that all users, all vendors, or all offers that have that attribute are considered to be part of that related group, and with such related group formation activities being performed for each of the available attributes or other pieces of information. Similarly, each combination of two attributes or other pieces of information may be used to form an additional related group of users or of vendors or of offers, such as by grouping all such users/vendors/offers that include both of those two attributes or other pieces of information (or either of those two attributes or other pieces of information), and further performing such additional related group formation activities for each such combination of two attributes or other pieces of information. It will be appreciated that a related group formed for a combination of two particular attributes will be a subset of the related groups for each of those two attributes individually (unless all users/vendors/offers that have one of the two attributes also currently has that other attribute, in which case all three of those related groups will be co-extensive at the current time, but could differ later if other users/vendors/offers enter the system with only one of the two attributes, or if attribute information changes for one or more users/vendors/offers already in the system). Such creation of related groups may similarly continue with some or all combinations of three attributes or other pieces of information, four attributes or other pieces of information, five attributes or other pieces of information, etc., until a maximum number of attributes or other pieces of information (e.g., all of the plurality of attributes or other pieces of information) are reached. Information about such identified related groups may be stored for later use, with examples of such use being described later with respect to routine 4800. It will further be appreciated that existing related groups may be updated as new information becomes available to the routine 4800, including to add and/or remove users/vendors/offers from existing related groups as appropriate, as well as to create new related groups and/or to remove previously existing related groups (e.g., if no users/vendors/offers remain in the related group). In other embodiments, such related groups may further be defined and used for other types of information described herein, whether instead of or in addition to the related groups for users, vendors, and offers. In addition, in some embodiments, related groups may be formed that include two or more of users, vendors and offers that are determined to share particular attributes or other pieces of information for those related groups (e.g., to have location-based related groups that may each include users, vendors and offers associated with a particular geographical location).

After block 4825, or if it is instead determined in block 4820 that the information or instructions received in block 4805 are not to identify related users, vendors, and/or offers, the routine continues to block 4830 to determine whether the information or instructions received in block 4805 are to identify whether one or more defined notification triggers are satisfied, such as for any notification triggers previously defined by vendors (e.g., as discussed with respect to FIG. 36 and elsewhere herein). The determination of whether a notification trigger is satisfied may be based, for example, on information concurrently or previously received and stored with respect to block 4815, and in some situations with respect to related user groups defined or updated with respect to block 4825.

If the information or instructions received in block 4805 are to identify whether any defined notification triggers are satisfied, the routine continues to block 4835 to retrieve any such defined triggers (e.g., unless one or more particular notification triggers are indicated to be used), as well as information about users or other objects or activities that relate to any defined criteria with respect to those notification triggers. The routine further determines in block 4805 if any of the notified triggers are currently satisfied by corresponding users or other information. While the illustrated embodiment performs the determination in block 4835 with respect to current information, it will be appreciated that in some embodiments such a determination may be made with respect to predicted future information for users and/or objects and activities, whether instead of or in addition to determinations made based on current information. Similarly, in some embodiments and situations, past information may be analyzed to determine whether and when defined notification triggers were satisfied, including as part of automated activities of the LTG Server system in generating suggested offers to provide to vendors or for other types of automated systems by the LTG Server system, as described elsewhere herein—such analysis of past information (e.g., prior locations of users that are now in different locations, prior activities of users that are now completed, etc.) may be made instead of or in addition to determinations made based on current information and/or predicted information.

After block 4835, if any of the defined notification triggers are satisfied, the routine continues to perform one or more types of automated activities in block 4840, such as based on information associated with the defined triggers, preferences of corresponding vendors, and/or a configuration of the LTG Server system. Such automated activities may include, for example, providing a corresponding notification for a satisfied trigger to one or more vendors associated with the trigger (e.g., one or more vendors that define the trigger). In other embodiments, other vendors that did not define a trigger may nonetheless be notified of some or all of the same types of information as the trigger-defining vendors, such as for other vendors that are similar to those trigger-defining vendors (e.g., as may be determined based on the other vendors and the trigger-defining vendors being in one or more common related vendor groups). A vendor that is notified based on a defined trigger may, for example, receive functionality that enables the notified vendors to immediately take a corresponding action (which may optionally be suggested by the LTG Server system to those vendors), including to dynamically initiate a corresponding offer to users who are determined to satisfy the defined criteria for the trigger and/or to make such an offer to other users, whether instead of or in addition to those satisfying users. As another example, automated activities by the LTG Server system for a satisfied trigger may include the system proceeding to automatically initiate a corresponding offer for the defined trigger to one or more users, such as to users who were determined to satisfy the defined criteria for the trigger, or to other users, whether instead of or in addition to the identified satisfying users.

After block 4840, or if it is instead determined in block 4830 that the information or instructions received in block 4805 are not to identify satisfied notification triggers, the routine continues instead to block 4845 to determine whether the information or instructions received in block 4805 are to determine suggested offers to indicate to vendors, such as based on information concurrently or previously received with respect to block 4815, or in other manners. If so, the routine continues to block 4850 to, for each vendor of interest (e.g., one or more indicated vendors, all vendors, etc.), analyze defined criteria associated with one or more prior offers made by that vendor (such as expired prior offers and/or prior offers that are still active) and/or to analyze defined criteria associated with prior and/or current offers of other vendors similar to that vendor (e.g., based on common membership in one or more related vendor groups). Such an analysis of offer criteria may include determining if any such offer criteria are currently satisfied by users relevant to the vendor, such as users in the same or similar location as the vendor (e.g., for a vendor that has one or more location-based businesses). While not illustrated in this example embodiment, in other embodiments such a determination may similarly be made with respect to predicted future information about end users, whether instead of or in addition to using current information about such end users (e.g., based on predicted future locations of end users).

After block 4850, the routine continues to block 4855 to, for some or all such offer criteria that are determined to be satisfied, suggest to the vendor to make a corresponding offer now and/or in the future, such as to the current relevant users who satisfy the criteria, to other users similar to those satisfying users (e.g., based on common membership in one or more related user groups), etc. In doing so, the routine may optionally in some embodiments provide information to the vendor that identifies information about the relevant users who satisfy the criteria (e.g., demographic information, locations, etc.), and in some cases may further identify particular such users to the vendor (e.g., if such identity-based notifications are approved by such users based on previously or concurrently provided user instructions or indications). After block 4855, if any such vendor who has been notified with a suggested offer confirms to proceed with the offer (such as currently and/or in the future), the routine in block 4860 initiates the creation of a corresponding offer within the LTG Server system with appropriate information about when the offer is available. It will be appreciated that such confirmations in block 4860 may occur at a time substantially after a notification is made in block 4855, and that at least some embodiments of the routine continue to perform other types of operations in an asynchronous manner while waiting for any such vendor confirmations to be received.

After block 4860, or if it was instead determined in block 4845 that the information or instructions received in block 4805 are not to determine suggested offers for vendors, the routine continues instead to block 4862 to determine whether the information or instructions received in block 4805 are to provide offer and/or task information to users. Such a determination may be made, for example, in response to a request from a user (e.g., based on the user displaying a GUI of a client-side application executing on a mobile device or other computing device of the user, such as an application provided by the LTG Server system or an affiliated game application, an external third-party application, etc.), or based on an automated determination of an offer and/or task being relevant for the user (e.g., based on previously expressed interests of the user, a current determination of a match between a user and an offer and/or task, etc.). If it is determined in block 4862 that the information or instructions received in block 4805 are to provide offer and/or task information to users, the routine continues to block 4864 to retrieve information about any relevant offers or other tasks and, for each such user (e.g., one or more indicated users, every end user, etc.), retrieve corresponding user information. The routine then determine offers (if any) for which the user is eligible and/or tasks (if any) for which the user may have an interest, including for offers and/or tasks automatically matched to the user, and provides corresponding information to the user (e.g., by initiating a display of corresponding information within a LTG Server system application GUI).

After block 4864, the routine continues to block 4866 to optionally receive information about one or more such tasks that are completed by one or more such users or other activities performed by one or more such users to qualify for one or more such offers, and if so, to initiate providing offer rewards or other benefits to the user based on those activities, as discussed in greater detail elsewhere herein. It will be appreciated that the indication of task performance or other offer qualification actions by users may occur at a time substantially later after activities performed with respect to block 4864, and that at least some embodiments of the routine continue to perform other types of operations in an asynchronous manner while waiting for any such indications of offer qualification actions by users to be received.

After block 4866, or if it is instead determined in block 4862 that the information or instructions received in block 4805 are not to provide offer and/or task information to users, the routine continues instead to block 4868 to determine whether the information or instructions received in block 4805 are to provide offer and/or task information to an external application, such as based on a received request from the external application or other automated determination by the LTG Server system to perform such information providing activities at this time (e.g., for a periodic or other scheduled activity). If so, the routine continues to block 4870, where in the illustrated embodiment a request has been received from the external application via an API provided by the LTG Server system, with the API in this example embodiment allowing external applications to request various types of information from the LTG Server system and/or to provide various types of information to the LTG Server system. In this situation, the received request is for information about offers and/or tasks defined within the LTG Server system that meet one or more specified criteria, such as based on a type of task, a type of offer, being currently available, etc. As one example, the external application may provide game functionality to its end users or otherwise enable its end users to perform particular types of tasks, and may retrieve corresponding task information from the LTG Server system—the external application may then enable its end users to perform such tasks (e.g., play particular mini-games) within the external application, such as to allow the end users to qualify for corresponding offers within the LTG Server system based on those activities within that external application. Such end users of the external application may, for example, also be end users of the LTG Server system, or instead some or all such end users of the external application may not be end users of the LTG Server system at a time of task performance (but may be allowed to register as users of the LTG Server system in order to receive corresponding benefits, such as to receive an offer reward after such an end user qualifies for an offer based on activities that occur via the external application). In addition, the external application may in some embodiments be affiliated with the LTG Server system before the request is received, while in other embodiments the API may allow any external application to request and obtain such information.

After block 4870, the routine continues to block 4872 to determine tasks and/or offers (if any) within the LTG Server system that correspond to the received request, and to provide corresponding response information to the external application via the API. In block 4874, if the routine later receives any indications or other confirmations via the API from the external application of an end user of the external application completing a task or otherwise qualifying for an offer, the routine may further take actions to initiate providing offer rewards for that offer to the user, including to optionally register the end user within the LTG Server system as appropriate. It will be appreciated that the indication of task performance or other offer qualification actions by end users of an external application may occur at a time substantially later after activities performed with respect to block 4872, and that at least some embodiments of the routine continue to perform other types of operations in an asynchronous manner while waiting for any such indications of task completion or other offer qualification actions by users to be received.

After block 4874, or if it is instead determined in block 4868 that the information or instructions received in block 4805 are not to provide offer and/or task information to an external application, the routine continues to block 4876 to determine whether the information or instructions received in block 4805 are to match users, vendors, and/or offers with each other, such as to match users and corresponding offers, users and corresponding vendors, vendors and corresponding offers, etc. If so, the routine continues to block 4878, where it retrieves information about groups of related users, vendors, and/or offers, such as those defined with respect to block 4825, and then analyzes such information to enable the matchmaking activities to be performed. Such matchmaking activities may include identifying current or past relationships between particular users, vendors, and/or offers in one or more manners, such as to include one or more of the following: based on users and vendors that have previously interacted; based on users that match criteria defined by vendors for offers or otherwise; based on vendors that match requests or other information specified by users; based on users that have been or are currently eligible to receive particular offers and/or that have qualified for particular offers; based on users that have redeemed such offers; based on vendors that have made such offers (and optionally further based on corresponding benefits received by the vendors, such as to identify commercially successful offers); etc. Such identification of current or past relationships may further be performed with respect to similar users, vendors, and/or offers by using corresponding identified related groups.

After current and/or past relationships are identified, matchmaking activities may be performed in block 4878 for additional possible relationships that could be managed by the LTG Server system, such as based at least in part on identified related groups. As one example, if a user and a vendor are identified as having a past or current relationship, a possible additional relationship may be determined for that user and one or more other vendors who are similar to that vendor (e.g., other vendors who are in a common related vendor group with that vendor), may be determined for that vendor and other similar users (e.g., other users who are in a common related user group with that user), and/or may be identified for both other similar users (who are related to that user) and other similar vendors (who are related to that vendor). When one or more such other similar users and one or more such other similar vendors are both identified for a particular possible relationship, it will be appreciated that users and vendors that have previously had no interactions or otherwise have not previously been identified as being related may be determined to be a good match for a new relationship based on current and/or predicted future information, thus enabling such users to receive useful information about vendors that may be of interest to the user, and enabling such vendors to obtain information about (or business from) users that may be of interest to the vendor and have interest in the vendor's product items and/or service items.

As one non-limiting example, if a user lives in a first geographical area and likes to interact with one or more types of businesses of a given type in that geographical area, but the user is currently in a second geographical area or plans to be in that second geographical area, related businesses in that second geographical area that are in a related vendor group with those businesses in the first geographical area may be of interest to that user. Thus, if a first user in a first geographical area has previous activities or other preferences for interacting with first businesses in that first geographical area (such as to establish relationships between the first user and the first businesses), an identified similar second user in a second geographical area may be interested in interacting with second businesses in the second geographical area that are similar to those first businesses, even if the first and second users have not had any interactions or associations with each other (other than being identified as being related by the LTG Server system, such as in a common related user group), and/or even if the first and second businesses have not had any prior associations or interactions with each other (other than being identified as being related by the LTG Server system, such as in a common related vendor group). In this manner, relevant information for both vendors and users may be identified, with corresponding benefits provided to both.

After block 4878, the routine continues to block 4880 to, for one or more such possible additional relationships that are identified, provide suggestions to corresponding users and/or to corresponding vendors about the other, and/or to provide suggestions to corresponding users and/or corresponding vendors about a corresponding offer. Thus, if a current or past relationship is identified between a particular vendor and a particular offer, such as based on that vendor previously making that offer and receiving beneficial commercial results, additional possible relationships may be identified between that vendor and other related offers, between that offer and other related vendors, and/or between both other similar offers (based on a common related offer group) and other similar vendors, in a manner similar to the example described with respect to users and vendors. Similarly, if an existing or current relationship is identified between a particular user and a particular offer (such as based on prior or current user eligibility for the offer, prior user satisfaction of requirements for the offer, and/or prior user redemption of the offer), additional possible relationships can be identified for that user and other similar offers, for that offer and other similar users, and/or for both similar users and similar offers, such as in a manner similar to that previously described with respect to users and vendors.

After block 4880, or if it is instead determined in block 4876 that the information or instructions received in block 4805 are not to match users, vendors, and/or offers, the routine continues instead to block 4888 to determine whether one or more other requests or indications are received in block 4805. If so, the routine continues to block 4890 to perform one or more other indicated operations as appropriate. For example, such other indicated operations may include any other actions or activities described herein, including other actions and activities by the LTG Server system to support or enable other activities described with respect to routine 4800, or more generally described with respect to any of FIGS. 1-47. A non-exclusive example of such other indicated operations includes obtaining fees from end users and/or vendor users for particular activities that are performed by the LTG Server system, such as for embodiments in which the LTG Server system is a fee-based system for some or all types of activities that it performs.

After block 4890, or if it is instead determined in block 4888 that other indications or instructions are not received, the routine continues to 4895 to determine whether to continue, such as until an explicit indication to terminate is received. If it is determined to continue, the routine returns to block 4805, and otherwise continues to block 4899 and ends.

It will also be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. It will similarly be appreciated that data structures discussed above may be structured in different manners, including for databases or user interface screens/pages or other types of data structures, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

Non-exclusive example embodiments described herein are further described in the following clauses.

A configured system comprising:

one or more hardware processors of one or more computing systems; and

one or more modules that are configured to, when executed by at least one of the one or more hardware processors, perform the method of any of claims 1-38.

A non-transitory computer-readable medium having stored contents that, when executed, configure a computing system to perform the method of any of claims 1-38.

From the foregoing it will be appreciated that, although specific embodiments have been described herein for purposes of illustration, various modifications may be made without deviating from the spirit and scope of the invention. Accordingly, the invention is not limited by the exemplary details. In addition, while certain aspects of the invention may be now or later presented in certain claim forms, the inventors contemplate the various aspects of the invention in any available claim form. For example, while only some aspects of the invention may be initially recited as being embodied in a computer-readable medium, other aspects may likewise be so embodied.

What is claimed is:

1. A computer-implemented method comprising:
receiving, by one or more configured computing systems of a location-based task-game server system, information about a plurality of promotional offers available via the location-based task-game server system, wherein each of the promotional offers has an associated retailer that is one of a plurality of retailer clients of the location-based task-game server system and has one or more associated eligibility criteria that include one or more specified eligible user locations and has an associated reward corresponding to one or more products sold by the associated retailer, and wherein a first offer of the plurality of promotional offers having an associated first retailer further has an associated defined notification trigger with instructions related to an action to take when the eligibility criteria for the first offer are satisfied by at least one matching end user of the location-based task-game server system;
determining, by the one or more configured computing systems, that one or more first users of the location-based task-game server system satisfy the eligibility criteria for the first promotional offer based at least in part on one or more geographical locations of the first users that match the one or more specified eligible user locations for the first promotional offer, the first users being a subset of a plurality of end users of the location-based task-game server system;
determining, by the one or more configured computing systems and based at least in part on the instructions for the associated defined notification trigger of the first offer, to perform the action in association with the first users;
providing, by the one or more configured computing systems, information to one or more mobile client devices of the first users that identifies a task to be completed by the first users in order to obtain the reward associated with the first promotional offer;
receiving, by the one or more configured computing systems, an indication of completion of the task by the first users; and
initiating, by the one or more configured computing systems, providing the reward associated with the first promotional offer to the first users based at least in part on the completion of the task.

2. The method of claim 1 wherein the action includes notifying the associated first retailer with information about the at least one matching end user, and wherein the method further comprises:
notifying, by the one or more configured computing systems, the associated first retailer that the first users satisfy the eligibility criteria for the first promotional offer, the notifying including making information specific to the first users available to the associated first retailer; and
in response to the notifying, receiving, by the one or more configured computing systems, an indication from the associated first retailer to proceed with making the first promotional offer available to the first users,
and wherein the providing of the information to the one or more mobile client devices of the first users is performed in response to the indication from the associated first retailer to proceed.

3. The method of claim 1 wherein the action includes making the first promotional offer to the at least one matching end user without further confirmation from the associated first retailer, and wherein the providing of the information to the one or more mobile client devices of the first users is performed in response to the determining to perform the action.

4. The method of claim 1 further comprising:
retrieving, by the one or more configured computing systems, information about multiple prior promotional offers that were previously made by the plurality of retailer clients to the plurality of end users, each of the prior promotional offers having an associated reward and having one or more associated eligibility criteria for end users eligible to obtain the associated reward;
identifying, by the one or more configured computing systems, that multiple second users of the plurality of end users currently satisfy the eligibility criteria for a second promotional offer of the prior promotional offers;
determining, by the one or more configured computing systems, and in response to the identifying, a suggested offer for at least one of the plurality of retailer clients to currently make to the second users, the suggested offer being based on the second promotional offer; and
notifying, by the one or more configured computing systems, and in response to the determining the suggested offer, the at least one retailer client about the suggested offer, to enable the at least one retailer client to indicate to currently make the suggested offer to the second users.

5. The method of claim 4 wherein the notifying of the at least one retailer client about the suggested offer includes providing information to the at least one retailer client about the second users.

6. The method of claim 5 wherein the location-based task-game server system is provided by a first entity, wherein the first promotional offer is associated with at least one of multiple task types defined within the location-based task-game server system, and wherein the method further comprises:
providing, by the one or more configured computing systems, a programmatic interface of the location-based task-game server system;
receiving, by the one or more configured computing systems, a request from an executing application via the programmatic interface for information about promotional offers having associated tasks of one or more indicated task types that include the at least one task type, the application being provided by a second entity distinct from the first entity and having a plurality of additional end users; and
providing, by the one or more configured computing systems, information about the first promotional offer to the application in response to the request, to enable one or more of the additional end users of the application to complete tasks of the at least one defined task type in order to obtain the reward associated with the first promotional offer.

7. A computer-implemented method comprising:
receiving, by one or more configured computing systems, information about a promotional offer for a vendor, the promotional offer having one or more associated eligibility criteria and having an associated reward corresponding to one or more items commercially available from the vendor;
determining, by the one or more configured computing systems, that one or more users satisfy the eligibility criteria based at least in part on one or more geographical locations of the users;
providing, by the one or more configured computing systems, information to one or more client devices of the users that identifies a task to be completed by the one or more users in order to obtain the reward associated with the promotional offer;
receiving, by the one or more configured computing systems, an indication of completion of the task by the one or more users; and
initiating, by the one or more configured computing systems, providing the reward associated with the promotional offer to the users based at least in part on the completion of the task.

8. The method of claim 7 wherein the one or more configured computing systems are part of a location-based task-game server system, and wherein the vendor is one of multiple vendor clients of the location-based task-game server system that each provide fees to the location-based task-game server system for activities of the location-based task-game server system that include providing information to eligible users about promotional offers.

9. The method of claim 8 wherein the one or more users are a subset of a plurality of users of the location-based task-game server system that each execute a software application from the location-based task-game server system on a mobile client device of the user, and wherein the providing of the information to the one or more client devices of the one or more users includes providing that information via the software application that is executing on each of the one or more client devices.

10. The method of claim 9 further comprising monitoring, by the one or more configured computing systems, information about geographic locations of the plurality of users based at least in part on information from the software application, and wherein the determining that one or more users satisfy the eligibility criteria is based at least in part on the monitored information.

11. The method of claim 8 wherein the location-based task-game server system is provided by a first entity, wherein the promotional offer is associated with at least one of multiple task types defined within the location-based task-game server system, and wherein the method further comprises:
providing, by the one or more configured computing systems, a programmatic interface of the location-based task-game server system;
receiving, by the one or more configured computing systems, a request from an executing application via the programmatic interface for information about promotional offers having associated tasks of one or more indicated task types that include the at least one task type, the application being provided by a second entity distinct from the first entity and having a plurality of additional users; and
providing, by the one or more configured computing systems, information about the promotional offer to the application in response to the request, to enable one or more of the additional users of the application to complete tasks of the at least one defined task type in order to obtain the reward associated with the promotional offer.

12. The method of claim 7 wherein the received information is from the vendor and includes information about a defined notification trigger of the vendor, and wherein the method further comprises, after the determining that one or more users satisfy the eligibility criteria and before the providing of the information to the one or more client devices of the users:
notifying, by the one or more configured computing systems, the vendor that one or more users are determined to satisfy the eligibility criteria; and
in response to the notifying, receiving, by the one or more configured computing systems, an indication from the vendor to proceed with making the promotional offer available to the one or more users,
and wherein the providing of the information to the one or more client devices of the users is performed in response to the indication from the vendor to proceed.

13. The method of claim 12 wherein the determining that one or more users satisfy the eligibility criteria includes identifying the one or more users, and wherein the notifying of the vendor includes providing information specific to the one or more users to the vendor.

14. The method of claim 7 further comprising, before the receiving of the information about the promotional offer for the vender:
receiving, by the one or more configured computing systems, information about a plurality of prior promotional offers that were previously made to multiple users, each of the prior promotional offers having an associated reward corresponding to one or more commercially available items and having one or more associated eligibility criteria for use in identifying users eligible to obtain the associated reward;
identifying, by the one or more configured computing systems, at least one user that currently satisfies the eligibility criteria for one of the prior promotional offers;
determining, by the one or more configured computing systems, and in response to the identifying, a suggested offer for the vendor to currently make to users that include the identified at least one user, the suggested offer being based on the one prior promotional offer; and
notifying, by the one or more configured computing systems, and in response to the determining, the vendor about the suggested offer, and
wherein the receiving of the information about the promotional offer for the vender includes receiving an indication from the vendor to proceed with the suggested offer based at least in part on the notifying.

15. The method of claim 14 wherein the notifying of the vendor about the suggested offer includes providing information specific to the at least one user to the vendor, and wherein the one or more users include the at least one user.

16. A non-transitory computer-readable medium having stored contents that configure a computing system to perform a method, the method comprising:
receiving, by the configured computing system, information about a promotional offer for a vendor, the promotional offer having an associated reward corresponding to one or more items commercially available from the vendor;
participating, by the configured computing system, in performance of an identified task by an eligible user based at least in part on one or more interactions of the eligible user with a mobile device in one or more specified locations, wherein completion of the identified task by the eligible user qualifies the eligible user to obtain the reward associated with the promotional offer; and
after the completion of the identified task by the eligible user, initiating, by the configured computing system, providing the reward associated with the promotional offer to the eligible user based at least in part on the completion of the identified task.

17. The non-transitory computer-readable medium of claim 16 wherein the configured computing system is part of a location-based task-game server remote from the mobile device of the eligible user, wherein the promotional offer further has one or more associated eligibility criteria that include the one or more specified locations, and wherein the participating in the performance of the identified task by the eligible user includes:
determining, by the configured computing system, that one or more users satisfy eligibility criteria for the promotional offer based at least in part on one or more geographical locations of the users that match the one or more specified locations, wherein the one or more users include the eligible user;
providing, by the configured computing system, information to the mobile device of the eligible user about the identified task; and
receiving, by the configured computing system, an indication from the mobile device of the completion of the identified task by the eligible user.

18. The non-transitory computer-readable medium of claim 16 wherein the configured computing system is the mobile device of the eligible user, wherein the promotional offer further has one or more associated eligibility criteria that include the one or more specified locations, and wherein the participating in the performance of the identified task by the eligible user includes:
presenting, by the configured computing system, information to the eligible user via the mobile device that enables the eligible user to perform at least one of the one or more interactions of the eligible user with the mobile device;
receiving, by the configured computing system, information from the eligible user as part of the one or more interactions of the eligible user with the mobile device; and
sending, by the configured computing system, information to a remote location-based task-game server that includes the received information from the one or more interactions of the eligible user with the mobile device.

19. The non-transitory computer-readable medium of claim 18 wherein the method further comprises, before the receiving of the information from the eligible user:
presenting, by the configured computing system, information to the eligible user via the mobile device about the identified task; and
receiving, by the configured computing system, an indication from the eligible user to proceed with the performance of the identified task.

20. The non-transitory computer-readable medium of claim 16 wherein the computer-readable medium is a memory of the configured computing system, and wherein the contents are instructions that when executed program the configured computing system to perform the method.

21. A computer-implemented method comprising:
receiving, by one or more configured computing systems of a location-based task-game server system provided by a first entity, information about a plurality of promotional offers, each of the promotional offers having an associated reward corresponding to one or more items commercially available from at least one vendor and having one or more associated tasks to be completed by a user in order to obtain the associated reward;
providing, by the one or more configured computing systems, a programmatic interface of the location-based task-game server system to enable access to information about at least some of the plurality of promotional offers;
receiving, by the one or more configured computing systems, a request from an application via the programmatic interface for information about promotional offers having associated tasks of one or more indicated task types, the application being provided by a second entity distinct from the first entity;
determining, by the one or more configured computing systems, a subset of the plurality of promotional offers having associated tasks of the one or more indicated task types; and
providing, by the one or more configured computing systems, information about the promotional offers of the determined subset to the application in response to the request, to enable users of the application to complete the tasks associated with the promotional offers of the determined subset and to obtain the rewards associated with the promotional offers of the determined subset.

22. The method of claim 21 wherein the method further comprises, after the providing of the information about the promotional offers of the determined subset to the application:
receiving, by the one or more configured computing systems, additional information from the application via the programmatic interface that indicates a specified user has completed a task associated with one of the promotional offers of the determined subset; and
initiating, by the one or more configured computing systems, providing the reward associated with the one promotional offer to the specified user based at least in part on the received additional information.

23. A non-transitory computer-readable medium having stored contents that configure a computing system to perform a method, the method comprising:
sending, by an application executing on the configured computing system, a request to a programmatic interface provided by a location-based task-game server system operated by a first entity, the request being for information about promotional offers available via the location-based task-game server system that have associated tasks of one or more indicated task types, the application being provided by a second entity distinct from the first entity;
receiving, by the executing application, information in response to the sent request, the received information indicating one or more promotional offers that each have an associated reward corresponding to one or more items commercially available from at least one vendor and each have one or more associated tasks of the one or more indicated task types to be completed by a user in order to obtain the associated reward;
participating, by the executing application, in performance by an eligible user of one of the one or more associated tasks for one of the indicated one or more promotional offers, the performance by the eligible user including one or more interactions of the eligible user with a mobile device; and
after the performance by the eligible user of the one associated task, initiating, by the executing application, providing the reward associated with the one indicated promotional offer to the eligible user based at least in part on the performance of the one associated task.

24. The non-transitory computer-readable medium of claim 23 wherein the configured computing system is part of a game server system remote from the mobile device of the eligible user and from the location-based task-game server system, and wherein the participating in the performance by the eligible user of the associated task includes:
determining, by the executing application, that one or more end users of the application satisfy eligibility criteria for the one indicated promotional offer based at least in part on one or more geographical locations of the one or more end users, wherein the one or more end users include the eligible user;
providing, by the executing application, information to the mobile device of the eligible user about the one associated task; and
receiving, by the executing application, an indication from the mobile device of the performance by the eligible user of the one associated task.

25. The non-transitory computer-readable medium of claim 23 wherein the configured computing system is the mobile device of the eligible user, and wherein the participating in the performance by the eligible user of the associated task includes:
presenting, by the configured computing system, information to the eligible user via the mobile device that enables the eligible user to perform at least one of the one or more interactions of the eligible user with the mobile device;
receiving, by the configured computing system, information from the eligible user as part of the one or more interactions of the eligible user with the mobile device; and
sending, by the configured computing system, information to the location-based task-game server system that includes the received information from the one or more interactions of the eligible user with the mobile device.

26. The non-transitory computer-readable medium of claim 25 wherein the method further comprises, before the receiving of the information from the eligible user:
presenting, by the configured computing system, information to the eligible user via the mobile device about the one associated task; and
receiving, by the configured computing system, an indication from the eligible user to proceed with the performance of the one associated task.

27. The non-transitory computer-readable medium of claim 23 wherein the computer-readable medium is a memory of the configured computing system, and wherein the contents are instructions that when executed program the configured computing system to perform the method.

28. A computer-implemented method comprising:
receiving, by one or more configured computing systems, information about a plurality of prior promotional offers that were previously made by multiple vendors to multiple users, each of the prior promotional offers having an associated reward corresponding to one or more items commercially available from at least one vendor and having one or more associated eligibility criteria for use in identifying users eligible to obtain the associated reward;
identifying, by the one or more configured computing systems, one or more users that currently satisfy the eligibility criteria for one of the prior promotional offers;
determining, by the one or more configured computing systems, and in response to the identifying, a suggested offer for at least one of the multiple vendors to currently make to the identified one or more users, the suggested offer being based on the one prior promotional offer; and
notifying, by the one or more configured computing systems, and in response to the determining, the at least one vendor about the suggested offer, to enable the at least one vendor to indicate to currently make the suggested offer to the identified one or more users.

29. The method of claim 28 wherein the notifying of the at least one vendor about the suggested offer includes providing information specific to the identified one or more users to the at least one vendor.

30. The method of claim 28 further comprising:
receiving, by the one or more configured computing systems, an indication from the at least one vendor to proceed with the suggested offer based at least in part on the notifying;
providing, by the one or more configured computing systems, information to one or more client devices of the identified one or more users that identifies a task to be completed by the identified one or more users in order to obtain a reward associated with the suggested offer; and
after receiving an indication that one of the identified users has completed the identified task, initiating, by the one or more configured computing systems, providing the reward associated with the suggested offer to the one identified user.

31. A non-transitory computer-readable medium having stored contents that configure a computing system to perform a method, the method comprising:
providing, by the configured computing system, information about one or more promotional offers to a location-based task-game server system operated by a first entity, wherein the location-based task-game server system makes a plurality of offers available to a plurality of end users of the location-based task-game server system, wherein the configured computing system is operated by a vendor distinct from the first entity, and wherein the one or more promotional offers each has an associated reward corresponding to one or more items commercially available from the vendor and has one or more associated eligibility criteria for use in identifying users eligible to obtain the associated reward;
during a first period of time, providing, by the vendor, the associated rewards for the one or more promotional offers to multiple end users of the location-based task-game server system based on the location-based task-game server system determining that the multiple end users are eligible in accordance with the associated eligibility criteria for the one or more promotional offers;
at a time after the first period of time when the one or more promotional offers are no longer valid, receiving, by the configured computing system, a notification from the location-based task-game server system of a suggested new offer to make to one or more additional end users of the location-based task-game server system, the suggested new offer being automatically determined by the location-based task-game server system based at least in part on comparing current information about the plurality of end users to the associated eligibility criteria for the one or more promotional offers that are no longer valid; and
in response to the notification of the suggested new offer, sending, by the configured computing system, a response to the location-based task-game server system that indicates to currently make the suggested new offer to the identified one or more users.

32. The non-transitory computer-readable medium of claim 31 wherein the method further comprises:
providing, by the configured computing system, information to the location-based task-game server system about a defined notification trigger for use with one or more additional promotional offers, wherein the notification trigger has multiple associated trigger criteria for use in identifying matching users, the trigger criteria including an indication of one or more geographical locations and including information about one or more types of users; and
receiving, by the configured computing system and a time after the providing of the information about the defined notification trigger, a further notification from the location-based task-game server system that indicates that the defined notification trigger has been automatically determined by the location-based task-game server system to be satisfied by one or more identified end users of the location-based task-game server system, to enable the vendor to dynamically determine to make at least one of the one or more additional promotional offers to the identified one or more users.

33. The non-transitory computer-readable medium of claim 32 wherein the further notification includes information specific to the identified one or more users, and wherein the method further comprises sending, by the configured computing system, a response to the location-based task-game server system that indicates for the location-based task-game server system to make the at least one additional promotional offer to the identified one or more users.

34. The non-transitory computer-readable medium of claim 32 wherein the further notification includes information about a projected monetary profit to the vendor from making the at least one additional promotional offer to the identified one or more users, the projected monetary profit being determined at least in part by the location-based task-game server system, and wherein the method further comprises sending, by the configured computing system, a response to the location-based task-game server system that indicates for the location-based task-game server system to make the at least one additional promotional offer to the identified one or more users.

35. The non-transitory computer-readable medium of claim 31 wherein the computer-readable medium is a memory of the configured computing system, and wherein the contents are instructions that when executed program the configured computing system to perform the method.

36. A computer-implemented method comprising:
receiving, by one or more configured computing systems, information about a notification trigger defined by a vendor for use with one or more promotional offers, the notification trigger having multiple associated eligibility criteria for use in identifying matching users, the eligibility criteria including an indication of one or more geographical locations and including information about one or more types of users;
obtaining, by the one or more configured computing systems, information about monitored locations of a plurality of users;
identifying, by the one or more configured computing systems, one or more users of the plurality of users who currently satisfy the eligibility criteria for the defined trigger, the identifying being based in part on the obtained information about the monitored locations; and
notifying, by the one or more configured computing systems, and in response to the identifying, the vendor about the identified one or more users, to enable the vendor to dynamically determine to make at least one of the one or more promotional offers to the identified one or more users.

37. The method of claim 36 further comprising:
determining, by the one or more configured computing systems, a projected monetary profit to the vendor from making an indicated promotional offer to the identified one or more users; and
determining, by the one or more configured computing systems, to perform the notifying of the vendor in response to the determining of the projected monetary profit.

38. The method of claim 37 wherein the notifying of the vendor includes suggesting to the vendor to make the indicated promotional offer to users that include the identified one or more users, and includes indicating the determined projected monetary profit to the vendor.
